(19) United States
(12) Patent Application Publication
(10) Pub. No.: US 2013/0238461 A1
(43) Pub. Date: Sep. 12, 2013

(54) METHODS AND SYSTEMS FOR MATCHING CONSUMERS WITH PROVIDERS

(71) Applicants: Richard Theodore Tieken, Queen Creek, AZ (US); Erica Beth Zidel, Belmont, MA (US)

(72) Inventors: Richard Theodore Tieken, Queen Creek, AZ (US); Erica Beth Zidel, Belmont, MA (US)

(21) Appl. No.: 13/784,395

(22) Filed: Mar. 4, 2013

Related U.S. Application Data
(60) Provisional application No. 61/607,421, filed on Mar. 6, 2012.

(51) Int. Cl. G06Q 30/06

(52) U.S. Cl. CPC G06Q 30/0605
USPC 705/26.2

(57) ABSTRACT

The present disclosure is directed towards methods and systems for matching consumers with providers such as childcare providers. One implementation may include a web interface or application for a consumer, such as a parent, to build a network of providers that the consumer can draw upon. In one aspect, the consumer can leverage on existing relationships to build his/her own network of trusted sitters. Examples of existing relationships may include friends, family and social networks. The consumer's network may extend to a plurality of parents sharing a plurality of sitters. The consumer may leverage on cooperatives or other types of membership or affiliations to a group or other organization. For example, groups of parents may trade babysitting help amongst themselves within a cooperative or coop. In such a case, a parent can be a consumer or provider in relation to another member.

### CROSS-REFERENCE TO RELATED APPLICATIONS

This patent application claims the benefit of and priority to U.S. Provisional Patent Application No. 61/607,421, filed on Mar. 6, 2012 and entitled “Methods and Systems for Matching Consumers With Providers”, which is incorporated herein by reference in its entirety for all purposes.

### FIELD OF THE DISCLOSURE

The present disclosure relates to consumer and provider networks, and more specifically, to systems and methods for matching consumers with providers.

### BACKGROUND

Conventional avenues for matching consumers to providers such as babysitters, are fraught with inefficiencies and friction. One example is high associated search costs. Some parents may often have to find and vet sitters independent of other parents they know. Doing so can increase the search costs significantly, whether through time (e.g., going through classifieds) or money (e.g., paid to sitter search sites). Another aspect is high scheduling costs. Parents may have to try to match their irregular needs against an irregular schedule of a sitter. A common result is scheduling failure and inability to find a back up solution for the parents. Some parents may simply have to repeat the matching process without having a backup solution or any plans in place.

Yet another aspect includes high turnover of providers. For example, there can be sitter turnover of over 30% each year. For example, some sitters may enter college, move away, no longer need the extra income, or have some other reason to leave the sitter market. Still another aspect is the hoarding of sitters. In many cases, current models for sitter arrangements may provide incentives for parent to hoard sitters. Parents may not be willing to share their sitters for fear of losing a scarce and/or trusted resource. In arranging for a babysitter, a typical parent may go through a rather frustrating process, similar to the following: the parent may call a sitter he/she found on Craigslist, and may take 15 minutes to 45 minutes to reach the sitter if there is an extended game of phone tag. The parent may be constantly worried that the sitter will not be available and that he/she may be left without a backup. The parent may feel pressure to “use or lose” a sitter, for example, the first sitter she contacted, or a sitter that the parent has previously used. The parent may be forced to postpone other plans until he/she has confirmed plans with a sitter.

### SUMMARY

In certain aspects, described herein are methods and systems for matching consumers with providers such as childcare providers. These methods and systems may include or implement a web interface or application for a consumer, such as a parent, to build a network of providers that the consumer can draw upon. In one aspect, the consumer can leverage on existing relationships to build his/her own network of trusted sitters. Examples of existing relationships may include friends, family and social networks. The consumer's network may extend to a plurality of parents sharing a plurality of sitters, for example. In another aspect, a consumer may leverage on cooperatives or other types of membership or affiliations to a group or other organization. For example, groups of parents may trade babysitting help amongst themselves within a cooperative or coop. In such a case, a parent can be a consumer or provider in relation to another member.

In one aspect, the disclosure describes a system and an associated method for matching consumers with providers using a network. The method may remove friction arising from trying to locate a provider from a service market, for example, by helping to reduce search costs, reduce scheduling costs, abstract away the effect of turnover, and/or remove a need for hoarding. The method may reduce complexity in the babysitting process for parents at various critical steps. For example, during the provider search or finding process, the system may provide a database that can be searched for free or at low cost to identify providers (e.g., sitters or groups of sitters) in their area. The system may provide automatic discovery of sitters trusted by other parents in their network. During the vetting process, the system may integrate or interface with a consumer's existing social graph. For example, parents may see how they are connected to each sitter, who their friends use for a sitter, etc. The system may provide reviews and allow sitters to run background checks on themselves or by parents (where permitted), e.g., at no cost to either parent or sitter. With regards to the scheduling process, parents may create one request and send this to multiple sitters. The system may not require communication with and/or coordination across every sitter. This may dramatically increase the chance of finding an available sitter. The system may facilitate sharing between consumers. In some embodiments, the more people a consumer is connected to, the more value the consumer may receive from sharing within a network of consumers and/or providers. Thus, the system can provide an incentive for a consumer to share in a network for the benefits to self and others.

In another aspect, the disclosure describes a system and an associated method for matching consumers with providers using a cooperative (hereafter sometimes referred to as a “coop”). The method may enable consumers or parents to leverage on their connections in order to trade free or low-cost, high-quality or trusted babysitting with friends or members. The system and method can provide tools to start, grow, and manage babysitting cooperatives. The method may reduce complexity for parents at various critical steps. For example, during the search or finding process, the system may provide a database that can be searched, e.g., for free or at low cost to find coops in their community. Coop members can proactively invite others into the coop. The vetting process may be simplified, since members typically know each other beforehand and are referred into the coop. A moderator may act as a membership gatekeeper. Consumers or parents can run background checks on themselves or on each other, where permitted, e.g., at no cost. With regards to the scheduling process, a consumer can create a single request and send it to his/her entire coop. The system may not require communication and/or coordination with every potential sitter. This may dramatically increase the chance of finding an available sitter. The system may facilitate sharing between consumers. For example, the more families there are in a consumer's coop, the more value the consumer can potentially receive. Every additional member can translate to an additional potential provider.

In yet another aspect, a method and system for identifying a service provider via a trusted consumer network that includes one or more service providers is provided. A server acting as an intermediary between a plurality of consumers and one or more service providers maintains a trusted network of one or more service providers for each consumer of a plurality of consumers. Each trusted network includes a relationship between each consumer and at least one service provider designated as trusted by the consumer based on at least one trust attribute. The server receives, from a consumer, a request for availability of any service provider in the consumer's trusted network to provide a service. The server then determines one or more service providers in the consumer's trusted network that are available to provide the requested service. In some implementations, the server identifies one or more service providers that are within the consumer's trusted network. The server sends to each of the service providers capable of providing the service requested by the consumer, a request to determine availability of the service provider to provide the service. The server also receives a response from one or more available service providers indicating the service provider is available. The server then identifies the identity of the one or more service providers available to provide the requested service to the consumer responsive to the determination.

In some implementations, the service for which a request was received can be any one of a babysitting service, a housekeeping service, a home improvement service, a maintenance service, a medical care service, a child care service, a coaching service, an educational tutoring service or other inhouse service. In some implementations, the server identifies the availability of each of the service providers capable of providing the service in the consumer's trusted network responsive to a schedule of the service provider indicating the service provider is one of available or possibly available.

In some implementations, the server receives from one or more of the service providers, an offer to perform the service responsive to receiving a request for availability. The server then provides the received offer and an identity of the service provider from whom the offer was received to the consumer requesting the service. In some implementations, the server receives an acceptance of the offer from the consumer and provides a notification to the service provider that the offer has been accepted by the consumer.

In some implementations, the server identifies one or more additional service providers to be included within the consumer's trusted network based on a second trust attribute. The second trust attribute corresponds to identifying service providers that are within a trusted network of another consumer. In some implementations, the server identifies one or more reviews provided by other consumers designated as trusted by the consumer based on one or more trust attributes to the consumer

In some implementations, the server identifies the identity of at least one consumer having a trusted network to which one or more of the identified service providers belong. The server determines that the identified consumer is a social network connection of the consumer requesting availability of any service provider. The server then identifies that a service provider of the one or more service providers available to provide the requested service belongs to a trusted network of the identified consumer and identifies that the identified consumer is a social network connection of the consumer.

In some implementations, the server identifies a social network account of one of the identified service providers and identifies at least one social network connection that is connected to the identified service provider and the consumer requesting availability of service providers. The server then identifies to the consumer, the identity of the at least one social network connection and that the identified service provider is a social network connection of the identified social network connection.

### BRIEF DESCRIPTION OF THE DRAWINGS

The following figures depict certain illustrative embodiments of the methods and systems described herein, where like reference numerals refer to like elements. Each depicted embodiment is illustrative of these methods and systems and not limiting.

FIG. 1A is a block diagram illustrative of an embodiment of a networked environment with a client machine that communicates with a server;

FIGS. 1B and 1C are block diagrams illustrative of embodiments of computing machines for practicing the methods and systems described herein;

FIG. 2A depicts a system overview of one embodiment of a system for matching consumers to providers in a marketplace;

FIG. 2B depicts one embodiment of a system for matching consumers to providers across one or more processes of finding, scheduling, paying and sharing a provider;

FIG. 2C depicts one embodiment of a system for providing automatic discovery of sitters trusted by other parents in their network;

FIG. 2D provides an illustration of time that may be saved in arranging a sitter service using an embodiment of the marketplace system;

FIG. 2E illustrates embodiments of features and/or benefits of the system to consumers and providers;

FIG. 2F illustrates possible outlets provided by one embodiment of the system in response to a request for a provider;

FIG. 3A depicts one embodiment of the marketplace system;

FIG. 3B depicts another embodiment of the marketplace system;

FIG. 4A illustrates some ways in which trust passing may occur;

FIG. 4B depicts one embodiment of how the system may present trust information of a consumer;

FIG. 5 depicts one embodiment of a marketplace system for matching a consumer with a provider;

FIGS. 6A-6G depict embodiments of process flows supported by certain embodiments of the system;

FIGS. 7A-7F depict embodiments of screenshots of an interface provided by the system to request or search for a babysitter;

FIG. 8 depicts one embodiment of a method for matching a consumer to a provider;

FIGS. 9A-9WW depict a number of screenshots of embodiments of a web interface provided by the marketplace system; and

FIG. 10 depicts one embodiment of a method for matching a consumer to a provider.

### DETAILED DESCRIPTION

For purposes of reading the description of the various embodiments below, the following enumeration of the sections of the specification and their respective contents may be helpful:
Section A describes a network and computing environment which may be useful for practicing embodiments described herein; and
Section B describes embodiments of systems and methods for matching consumers with providers.

### A. Network and Computing Environment

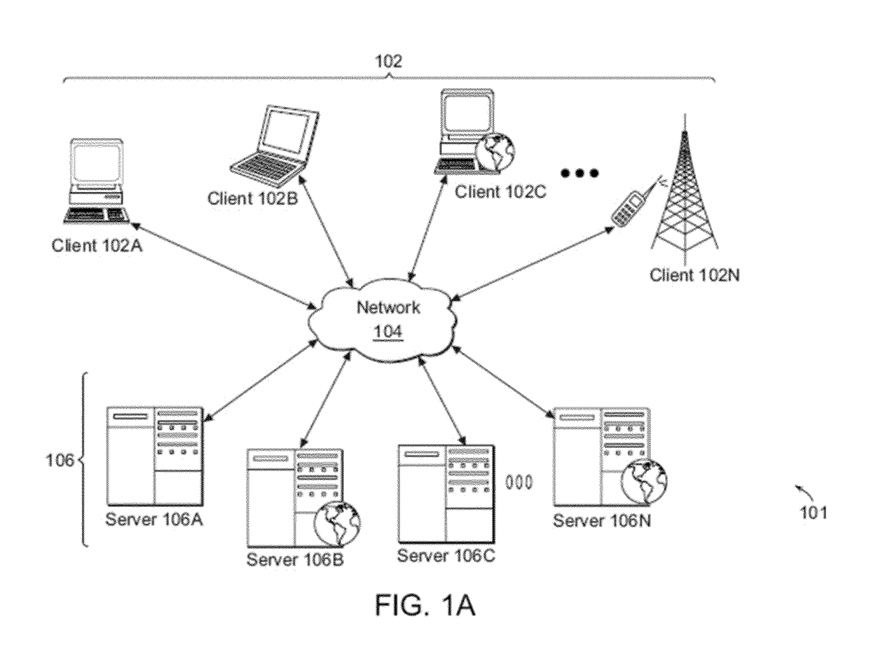

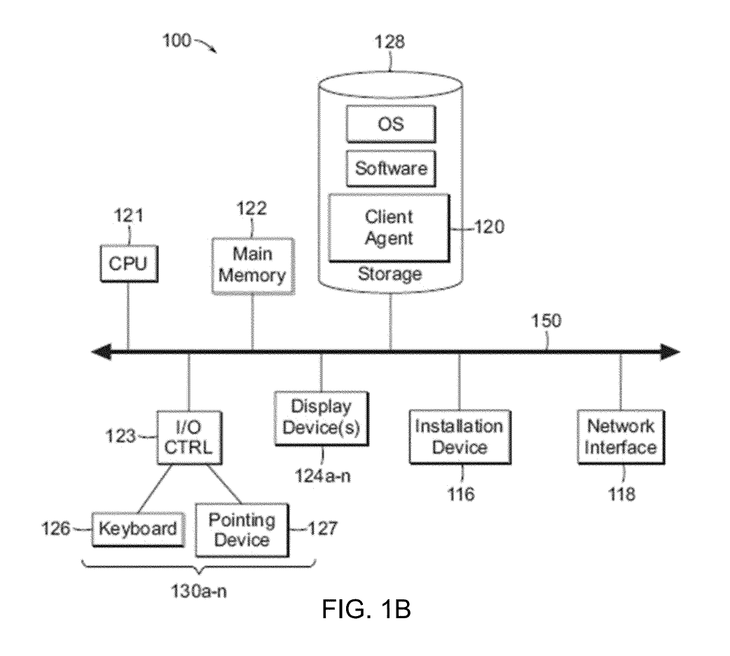

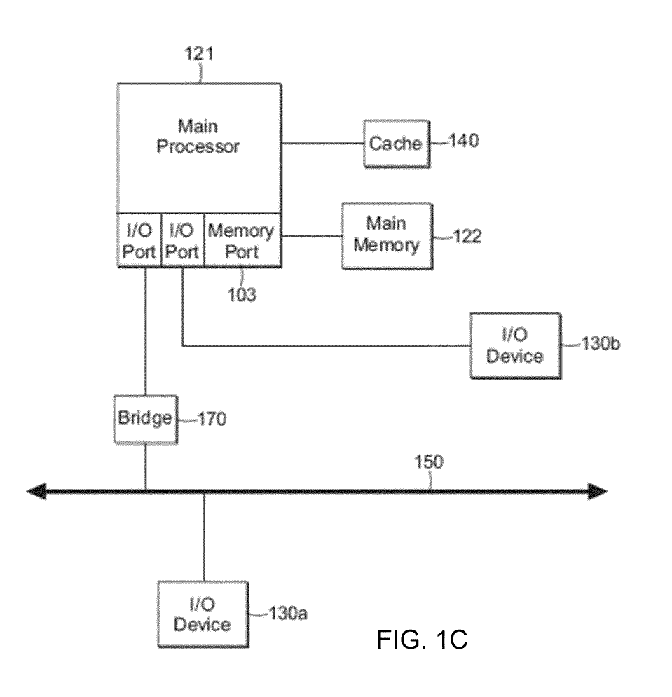

Prior to discussing the specifics of embodiments of the systems and methods, it may be helpful to discuss the network and computing environments in which such embodiments may be deployed, including a description of components and features suitable for use in the present systems and methods. FIG. 1A illustrates one embodiment of a computing environment 101 that includes one or more client machines 102A-102N (generally referred to herein as “client machine(s) 102”) in communication with one or more servers 106A-106N (generally referred to herein as “server(s) 106”). Installed in between the client machine(s) 102 and server(s) 106 is a network.

In one embodiment, the computing environment 101 can include an appliance installed between the server(s) 106 and client machine(s) 102. This appliance can mange client/server connections, and in some cases can load balance client connections amongst a plurality of backend servers. The client machine(s) 102 can in some embodiment be referred to as a single client machine 102 or a single group of client machines 102, while server(s) 106 may be referred to as a single server 106 or a single group of servers 106. In one embodiment a single client machine 102 communicates with more than one server 106, while in another embodiment a single server 106 communicates with more than one client machine 102. In yet another embodiment, a single client machine 102 communicates with a single server 106.

A client machine 102 can, in some embodiments, be referenced by any one of the following terms: client machine(s) 102; client(s); client computer(s); client device(s); client computing device(s); local machine; remote machine; client node(s); endpoint(s); endpoint node(s); or a second machine. The server 106, in some embodiments, may be referenced by any one of the following terms: server(s), local machine; remote machine; server farm(s), host computing device(s), or a first machine(s).

The client machine 102 can in some embodiments execute, operate or otherwise provide an application that can be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions. Still other embodiments include a client device 102 that displays application output generated by an application remotely executing on a server 106 or other remotely located machine. In these embodiments, the client device 102 can display the application output in an application window, a browser, or other output window. In one embodiment, the application is a desktop, while in other embodiments the application is an application that generates a desktop.

The computing environment 101 can include more than one server 106A-106N such that the servers 106A-106N are logically grouped together into a server farm 106. The server farm 106 can include servers 106 that are geographically dispersed and logically grouped together in a server farm 106, or servers 106 that are located proximate to each other and logically grouped together in a server farm 106. Geographically dispersed servers 106A-106N within a server farm 106 can, in some embodiments, communicate using a WAN, MAN, or LAN, where different geographic regions can be characterized as: different continents; different regions of a continent; different countries; different states; different cities; different campuses; different rooms; or any combination of the preceding geographical locations. In some embodiments the server farm 106 may be administered as a single entity, while in other embodiments the server farm 106 can include multiple server farms 106.

In some embodiments, a server farm 106 can include servers 106 that execute a substantially similar type of operating system platform (e.g., WINDOWS NT, manufactured by Microsoft Corp. of Redmond, Wash., UNIX, LINUX, or SNOW LEOPARD.) In other embodiments, the server farm 106 can include a first group of servers 106 that execute a first type of operating system platform, and a second group of servers 106 that execute a second type of operating system platform. The server farm 106, in other embodiments, can include servers 106 that execute different types of operating system platforms.

The server 106, in some embodiments, can be any server type. In other embodiments, the server 106 can be any of the following server types: a file server; an application server; a web server; a proxy server; an appliance; a network appliance; a gateway; an application gateway; a gateway server; a virtualization server; a deployment server; a SSL VPN server; a firewall; a web server; an application server or as a master application server; a server 106 executing an active directory; or a server 106 executing an application acceleration program that provides firewall functionality, application functionality, or load balancing functionality. In some embodiments, a server 106 may be a RADIUS server that includes a remote authentication dial-in user service. Some embodiments include a first server 106A that receives requests from a client machine 102, forwards the request to a second server 106B, and responds to the request generated by the client machine 102 with a response from the second server 106B. The first server 106A can acquire an enumeration of applications available to the client machine 102 and well as address information associated with an application server 106 hosting an application identified within the enumeration of applications. The first server 106A can then present a response to the client's request using a web interface, and communicate directly with the client 102 to provide the client 102 with access to an identified application.

Client machines 102 can, in some embodiments, be a client node that seeks access to resources provided by a server 106. In other embodiments, the server 106 may provide clients 102 or client nodes with access to hosted resources. The server 106, in some embodiments, functions as a master node such that it communicates with one or more clients 102 or servers 106. In some embodiments, the master node can identify and provide address information associated with a server 106 hosting a requested application, to one or more clients 102 or servers 106. In still other embodiments, the master node can be a server farm 106, a client 102, a cluster of client nodes 102, or an appliance.

One or more clients 102 and/or one or more servers 106 can transmit data over a network 104 installed between machines and appliances within the computing environment 101. The network 104 can comprise one or more sub-networks, and can be installed between any combination of the clients 102, servers 106, computing machines and appliances included within the computing environment 101. In some embodiments, the network 104 can be: a local-area network (LAN); a metropolitan area network (MAN); a wide area network (WAN); a primary network 104 comprised of multiple sub-networks 104 located between the client machines 102 and the servers 106; a primary public network 104 with a private sub-network 104; a primary private network 104 with a public sub-network 104; or a primary private network 104 with a private sub-network 104. Still further embodiments include a network 104 that can be any of the following network types: a point to point network; a broadcast network; a telecommunications network; a data communication network; a computer network; an ATM (Asynchronous Transfer Mode) network; a SONET (Synchronous Optical Network) network; a SDH (Synchronous Digital Hierarchy) network; a wireless network; a wireline network; or a network 104 that includes a wireless link where the wireless link can be an infrared channel or satellite band. The network topology of the network 104 can differ within different embodiments, possible network topologies include: a bus network topology; a star network topology; a ring network topology; a repeater-based network topology; or a tiered-star network topology. Additional embodiments may include a network 104 of mobile telephone networks that use a protocol to communicate among mobile devices, where the protocol can be any one of the following: AMPS; TDMA; CDMA; GSM; GPRS UMTS; 3G; 4G; or any other protocol able to transmit data among mobile devices.

Illustrated in FIG. 1B is an embodiment of a computing device 100, where the client machine 102 and server 106 illustrated in FIG. 1A can be deployed as and/or executed on any embodiment of the computing device 100 illustrated and described herein. Included within the computing device 100 is a system bus 150 that communicates with the following components: a central processing unit 121; a main memory 122; storage memory 128; an input/output (I/O) controller 123; display devices 124A-124N; an installation device 116; and a network interface 118. In one embodiment, the storage memory 128 includes: an operating system, software routines, and a client agent 120. The I/O controller 123, in some embodiments, is further connected to a key board 126, and a pointing device 127. Other embodiments may include an I/O controller 123 connected to more than one input/output device 130A-130N.

FIG. 1C illustrates one embodiment of a computing device 100, where the client machine 102 and server 106 illustrated in FIG. 1A can be deployed as and/or executed on any embodiment of the computing device 100 illustrated and described herein. Included within the computing device 100 is a system bus 150 that communicates with the following components: a bridge 170, and a first I/O device 130A. In another embodiment, the bridge 170 is in further communication with the main central processing unit 121, where the central processing unit 121 can further communicate with a second I/O device 130B, a main memory 122, and a cache memory 140. Included within the central processing unit 121, are I/O ports, a memory port 103, and a main processor.

Embodiments of the computing machine 100 can include a central processing unit 121 characterized by any one of the following component configurations: logic circuits that respond to and process instructions fetched from the main memory unit 122; a microprocessor unit, such as: those manufactured by Intel Corporation; those manufactured by Motorola Corporation; those manufactured by Transmeta Corporation of Santa Clara, Calif.; the RS/6000 processor such as those manufactured by International Business Machines; a processor such as those manufactured by Advanced Micro Devices; or any other combination of logic circuits. Still other embodiments of the central processing unit 122 may include any combination of the following: a microprocessor, a microcontroller, a central processing unit with a single processing core, a central processing unit with two processing cores, or a central processing unit with more than one processing core.

While FIG. 1C illustrates a computing device 100 that includes a single central processing unit 121, in some embodiments the computing device 100 can include one or more processing units 121. In these embodiments, the computing device 100 may store and execute firmware or other executable instructions that, when executed, direct the one or more processing units 121 to simultaneously execute instructions or to simultaneously execute instructions on a single piece of data. In other embodiments, the computing device 100 may store and execute firmware or other executable instructions that, when executed, direct the one or more processing units to each execute a section of a group of instructions. For example, each processing unit 121 may be instructed to execute a portion of a program or a particular module within a program.

In some embodiments, the processing unit 121 can include one or more processing cores. For example, the processing unit 121 may have two cores, four cores, eight cores, etc. In one embodiment, the processing unit 121 may comprise one or more parallel processing cores. The processing cores of the processing unit 121 may in some embodiments access available memory as a global address space, or in other embodiments, memory within the computing device 100 can be segmented and assigned to a particular core within the processing unit 121. In one embodiment, the one or more processing cores or processors in the computing device 100 can each access local memory. In still another embodiment, memory within the computing device 100 can be shared amongst one or more processors or processing cores, while other memory can be accessed by particular processors or subsets of processors. In embodiments where the computing device 100 includes more than one processing unit, the multiple processing units can be included in a single integrated circuit (IC). These multiple processors, in some embodiments, can be linked together by an internal high speed bus, which may be referred to as an element interconnect bus.

In embodiments where the computing device 100 includes one or more processing units 121, or a processing unit 121 including one or more processing cores, the processors can execute a single instruction simultaneously on multiple pieces of data (SIMD), or in other embodiments can execute multiple instructions simultaneously on multiple pieces of data (MIMD). In some embodiments, the computing device 100 can include any number of SIMD and MIMD processors.

The computing device 100, in some embodiments, can include an image processor, a graphics processor or a graphics processing unit. The graphics processing unit can include any combination of software and hardware, and can further input graphics data and graphics instructions, render a graphic from the inputted data and instructions, and output the rendered graphic. In some embodiments, the graphics processing unit can be included within the processing unit 121. In other embodiments, the computing device 100 can include one or more processing units 121, where at least one processing unit 121 is dedicated to processing and rendering graphics.

One embodiment of the computing machine 100 includes a central processing unit 121 that communicates with cache memory 140 via a secondary bus also known as a backside bus, while another embodiment of the computing machine 100 includes a central processing unit 121 that communicates with cache memory via the system bus 150. The local system bus 150 can, in some embodiments, also be used by the central processing unit to communicate with more than one type of I/O device 130A-130N. In some embodiments, the local system bus 150 can be any one of the following types of buses: a VESA VL bus; an ISA bus; an EISA bus; a MicroChannel Architecture (MCA) bus; a PCI bus; a PCI-X bus; a PCI-Express bus; or a NuBus. Other embodiments of the computing machine 100 include an I/O device 130A-130N that is a video display 124 that communicates with the central processing unit 121. Still other versions of the computing machine 100 include a processor 121 connected to an I/O device 130A-130N via any one of the following connections: HyperTransport, Rapid I/O, or InfiniBand. Further embodiments of the computing machine 100 include a processor 121 that communicates with one I/O device 130A using a local interconnect bus and a second I/O device 130B using a direct connection.

The computing device 100, in some embodiments, includes a main memory unit 122 and cache memory 140. The cache memory 140 can be any memory type, and in some embodiments can be any one of the following types of memory: SRAM; BSRAM; or EDRAM. Other embodiments include cache memory 140 and a main memory unit 122 that can be any one of the following types of memory: Static random access memory (SRAM), Burst SRAM or SynchBurst SRAM (BSRAM); Dynamic random access memory (DRAM); Fast Page Mode DRAM (FPM DRAM); Enhanced DRAM (EDRAM), Extended Data Output RAM (EDO RAM); Extended Data Output DRAM (EDO DRAM); Burst Extended Data Output DRAM (BEDO DRAM); Enhanced DRAM (EDRAM); synchronous DRAM (SDRAM); JEDEC SRAM; PC100 SDRAM; Double Data Rate SDRAM (DDR SDRAM); Enhanced SDRAM (ESDRAM); SyncLink DRAM (SLDRAM); Direct Rambus DRAM (DRDRAM); Ferroelectric RAM (FRAM); or any other type of memory. Further embodiments include a central processing unit 121 that can access the main memory 122 via: a system bus 150; a memory port 103; or any other connection, bus or port that allows the processor 121 to access memory 122.

One embodiment of the computing device 100 provides support for any one of the following installation devices 116: a CD-ROM drive, a CD-R/RW drive, a DVD-ROM drive, tape drives of various formats, USB device, a bootable medium, a bootable CD, a bootable CD for GNU/Linux distribution such as KNOPPIX®, a hard-drive or any other device suitable for installing applications or software. Applications can in some embodiments include a client agent 120, or any portion of a client agent 120. The computing device 100 may further include a storage device 128 that can be either one or more hard disk drives, or one or more redundant arrays of independent disks; where the storage device is configured to store an operating system, software, programs applications, or at least a portion of the client agent 120. A further embodiment of the computing device 100 includes an installation device 116 that is used as the storage device 128.

The computing device 100 may further include a network interface 118 to interface to a Local Area Network (LAN), Wide Area Network (WAN) or the Internet through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can also be established using a variety of communication protocols (e.g., TCP/IP, IPX, SPX, NetBIOS, Ethernet, ARCNET, SONET, SDH, Fiber Distributed Data Interface (FDDI), RS232, RS485, IEEE 802.11, IEEE 802.11a, IEEE 802.11b, IEEE 802.11g, CDMA, GSM, WiMax and direct asynchronous connections). One version of the computing device 100 includes a network interface 118 able to communicate with additional computing devices 100′ via any type and/or form of gateway or tunneling protocol such as Secure Socket Layer (SSL) or Transport Layer Security (TLS), or the Citrix Gateway Protocol manufactured by Citrix Systems, Inc. Versions of the network interface 118 can comprise any one of: a built-in network adapter; a network interface card; a PCMCIA network card; a card bus network adapter; a wireless network adapter; a USB network adapter; a modem; or any other device suitable for interfacing the computing device 100 to a network capable of communicating and performing the methods and systems described herein.

Embodiments of the computing device 100 include any one of the following I/O devices 130A-130N: a keyboard 126; a pointing device 127; mice; trackpads; an optical pen; trackballs; microphones; drawing tablets; video displays; speakers; inkjet printers; laser printers; and dye-sublimation printers; or any other input/output device able to perform the methods and systems described herein. An I/O controller 123 may in some embodiments connect to multiple I/O devices 103A-130N to control the one or more I/O devices. Some embodiments of the I/O devices 130A-130N may be configured to provide storage or an installation medium 116, while others may provide a universal serial bus (USB) interface for receiving USB storage devices such as the USB Flash Drive line of devices manufactured by Twintech Industry, Inc. Still other embodiments include an I/O device 130 that may be a bridge between the system bus 150 and an external communication bus, such as: a USB bus; an Apple Desktop Bus; an RS-232 serial connection; a SCSI bus; a FireWire bus; a FireWire 800 bus; an Ethernet bus; an AppleTalk bus; a Gigabit Ethernet bus; an Asynchronous Transfer Mode bus; a HIPPI bus; a Super HIPPI bus; a SerialPlus bus; a SCI/LAMP bus; a FibreChannel bus; or a Serial Attached small computer system interface bus.

In some embodiments, the computing machine 100 can execute any operating system, while in other embodiments the computing machine 100 can execute any of the following operating systems: versions of the MICROSOFT WINDOWS operating systems; the different releases of the Unix and Linux operating systems; any version of the MAC OS manufactured by Apple Computer; OS/2, manufactured by International Business Machines; Android by Google; any embedded operating system; any real-time operating system; any open source operating system; any proprietary operating system; any operating systems for mobile computing devices; or any other operating system. In still another embodiment, the computing machine 100 can execute multiple operating systems. For example, the computing machine 100 can execute PARALLELS or another virtualization platform that can execute or manage a virtual machine executing a first operating system, while the computing machine 100 executes a second operating system different from the first operating system.

The computing machine 100 can be embodied in any one of the following computing devices: a computing workstation; a desktop computer; a laptop or notebook computer; a server; a handheld computer; a mobile telephone; a portable telecommunication device; a media playing device; a gaming system; a mobile computing device; a netbook, a tablet; a device of the IPOD or IPAD family of devices manufactured by Apple Computer; any one of the PLAYSTATION family of devices manufactured by the Sony Corporation; any one of the Nintendo family of devices manufactured by Nintendo Co; any one of the XBOX family of devices manufactured by the Microsoft Corporation; or any other type and/or form of computing, telecommunications or media device that is capable of communication and that has sufficient processor power and memory capacity to perform the methods and systems described herein. In other embodiments the computing machine 100 can be a mobile device such as any one of the following mobile devices: a JAVA-enabled cellular telephone or personal digital assistant (PDA); any computing device that has different processors, operating systems, and input devices consistent with the device; or any other mobile computing device capable of performing the methods and systems described herein. In still other embodiments, the computing device 100 can be any one of the following mobile computing devices: any one series of Blackberry, or other handheld device manufactured by Research In Motion Limited; the iPhone manufactured by Apple Computer; Palm Pre; a Pocket PC; a Pocket PC Phone; an Android phone; or any other handheld mobile device. Having described certain system components and features that may be suitable for use in the present systems and methods, further aspects are addressed below.

B. Matching Consumers with Childcare Providers

In some aspects, the methods and systems disclosed herein may provide a web interface or application to consumers and/or providers for matching consumers with providers. A consumer may be any person looking for a service provider, such as a parent or guardian of a person or child needing care. A provider may be a provider of any one or more types of related or unrelated services, such as childcare services, eldercare services, pet-sitting/pet-walking services, tuition or coaching services, gardening services, housekeeping/cleaning services, and repair, handyman and/or maintenance services. The present methods and systems can provide a consumer-provider transaction network for any type of services, not limited to childcare or any single inhouse service. A consumer may be able to access or provide reviews on a provider through the system, from or for people in the transaction network, which may include people that the consumer knows. A consumer can send a service request to many providers and/or channels via the transaction network, to locate a match for the request.

The methods and systems disclosed herein can help reduce friction and improve the outcome in finding a service provider. The present methods and systems may implement a web interface (e.g., via a website) or an application that helps a consumer build and/or manage a network of providers that the consumer can draw upon. A consumer may access the website or application via one or more computing devices, such as computing devices 100, 102 described above in connection with FIGS. 1A-1C. The website may be provided by or hosted on one or more servers 106 across one or more networks 104. A network of providers may be maintained in a database/directory, for example, stored on a server 106 or distributed across a plurality of computing devices 102, 106 over one or more networks 104. Although this disclosure may at times describe embodiments of the systems and methods with respect to parents, childcare providers and childcare/sitter services, these are only for illustrative purposes and not intended to be limiting in any way. As such, a consumer may hereafter be sometimes referred to as a parent, a provider may sometimes be referred to as a sitter, and a service may sometimes be referred to as a babysitting/sitter/childcare service.

The present systems and methods may allow a consumer to leverage on existing relationships to build his/her own network of trusted sitters or providers. Examples of existing relationships may include friends, family and other trusted circles, linked for example through social networks. Embodiments of the present systems may integrate with social network channels, or include a social network overlay to a consumer/provider transaction. For example, a consumer may leverage on the fact that he/she knows a person through Facebook for example, to trust a provider trusted or recommended by that person. Some embodiments of the present systems may integrate or port any existing social graph of a consumer to a consumer-provider transactional network, to build relationships and/or trust.

Thus, a consumer's trusted network of providers may be expanded via relationships with a plurality of parents, to share a group of trusted sitters, for example. In some embodiments, a consumer may leverage on cooperatives or other types of membership or affiliation to a group or other type of organization. For example, groups of parents may trade babysitting assistance amongst themselves. In such a case, a parent can be a consumer or provider in relation to another member under different contexts. The system can partner with or leverage on coops established or being established across the US and/or internationally. Many coops can be innately viral. As such, where there are more members in a coop, it can potentially translate to more value for each member.

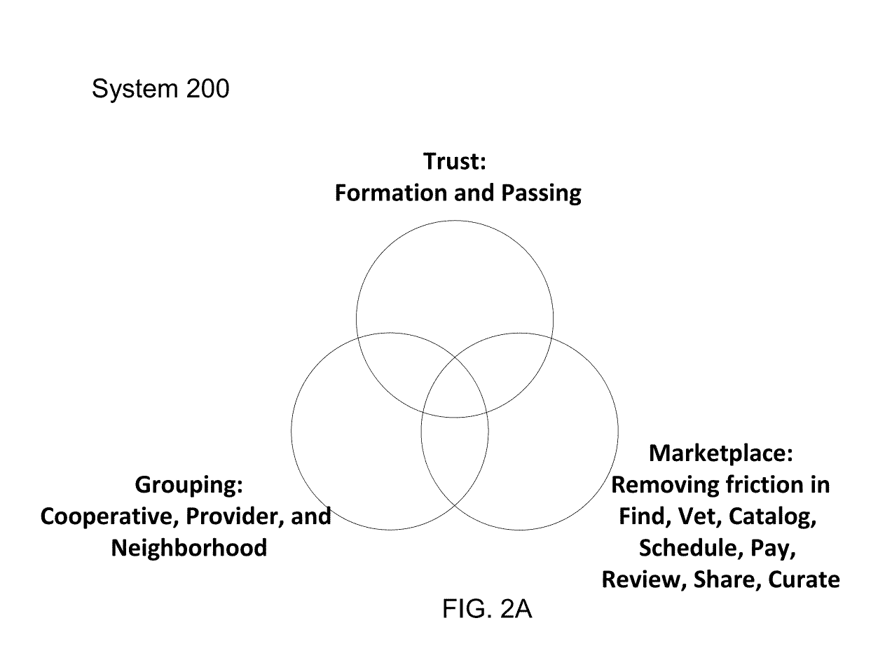

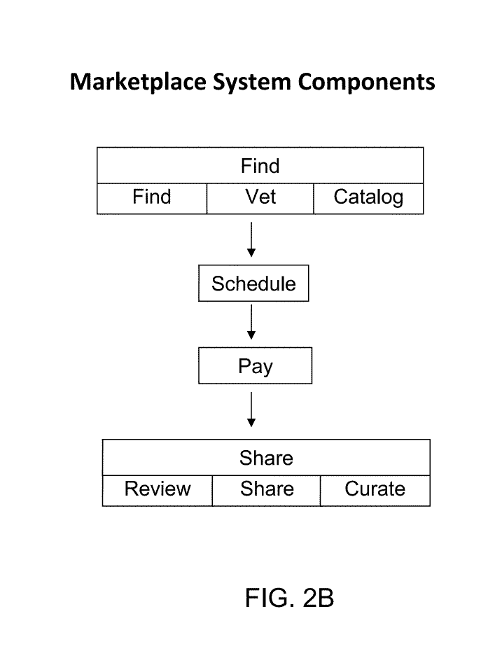

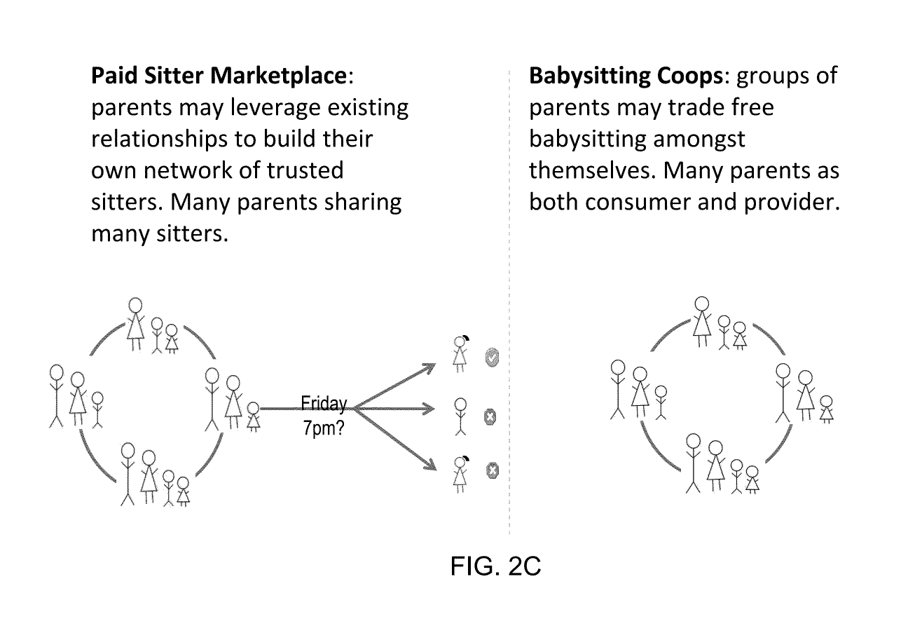

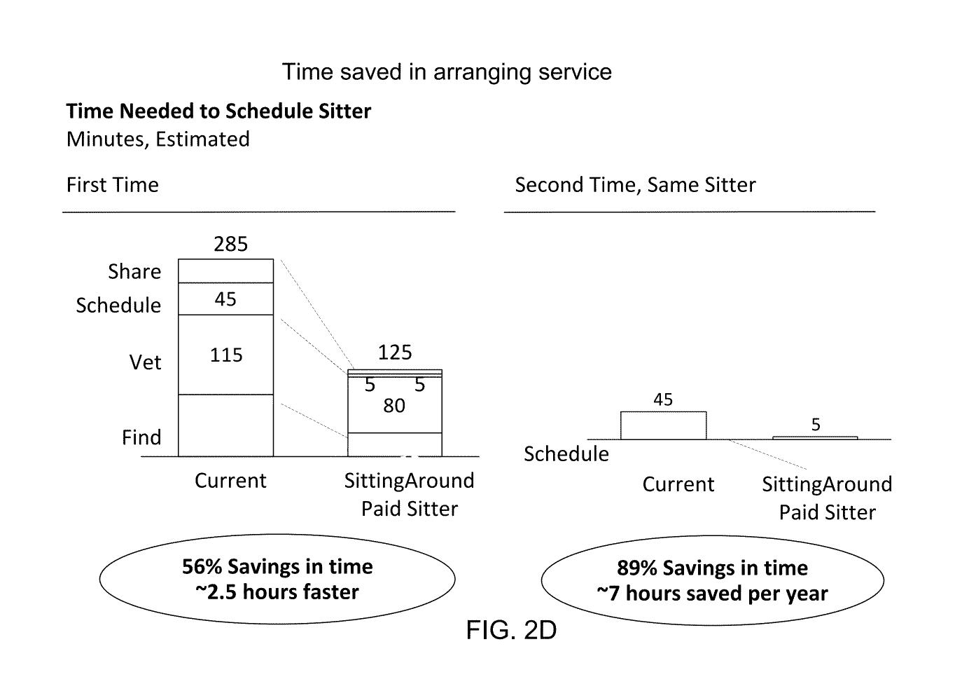

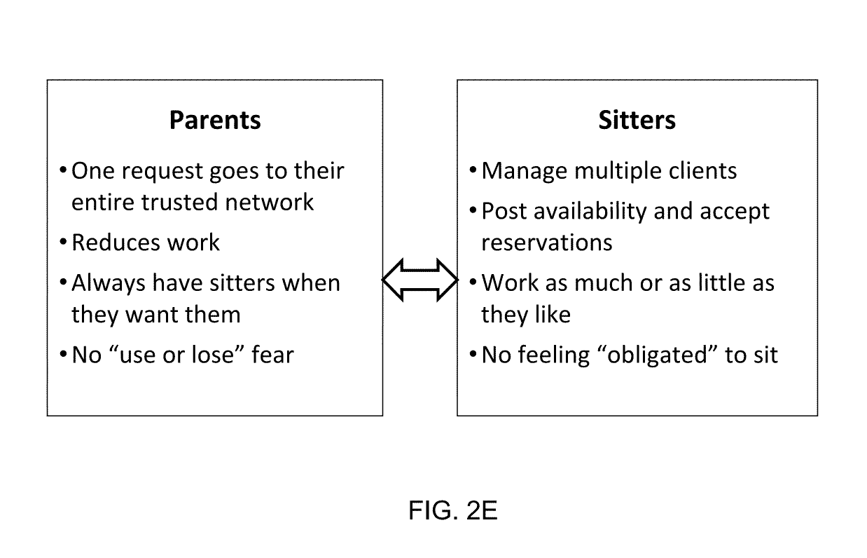

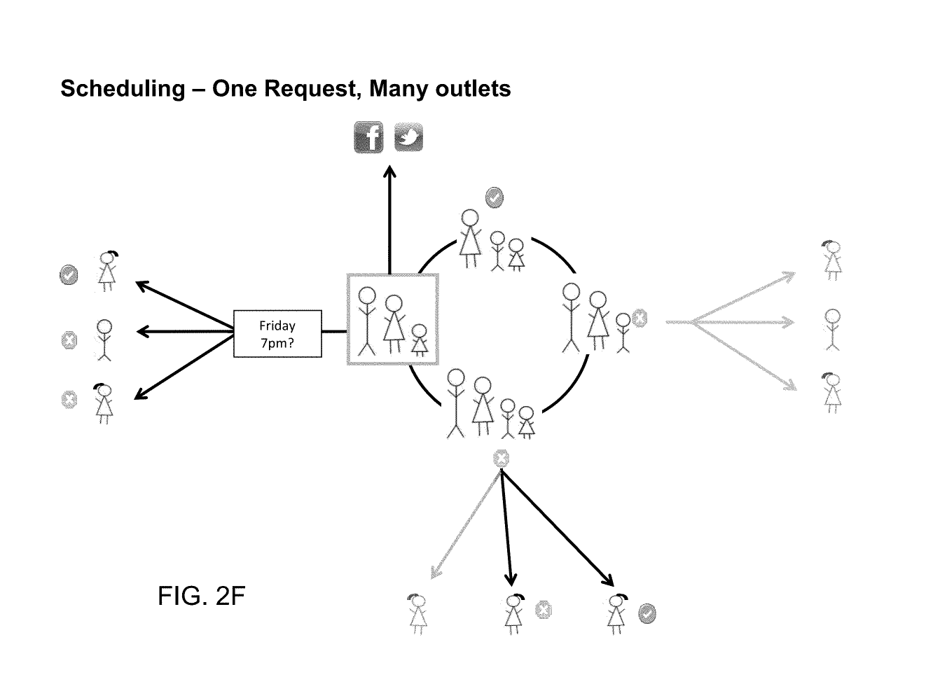

FIG. 2A depicts a system overview of one embodiment of a system for matching consumers to providers in a marketplace. In some embodiments, the present solution, comprising systems and/or methods described herein, may establish and/or facilitate a person-to-person labor market for tasks/jobs/gigs that may comprise some level of trust, skill or knowledge in a craft, timeliness and/or geographic proximity. For example, the system may apply to babysitting services. FIG. 2B depicts one embodiment of a system for matching consumers to providers across one or more processes of finding, scheduling, paying and sharing a provider. The system in FIGS. 2A and/or 2B may remove friction arising from tapping into a provider or babysitting market, for example, by helping to reduce search costs, reduce scheduling costs, abstract away the effect of turnover, and/or remove need for hoarding. The solution may reduce the complexity in the babysitting arrangement process for parents at various critical steps. In some embodiments, the solution may be referred to as a consumer-provider linking system, a marketplace system, or simply referred to as the “system”. In some embodiments, the system reduces the cost and/or friction of matching consumers with providers.

In certain embodiments, during the search or finding process, the marketplace system may provide a database that can be searched, e.g., for free or at low cost, to find providers (e.g., sitters or groups of sitters) in their area. For example, a consumer may enter the consumer's zip code into the system's search tool. The consumer can filter sitters based on a variety of qualities or attributes, including: proximity, availability, background check, and rate. The system can indicate how a consumer is connected to sitters, e.g., via social network or coop connections. A consumer may, for example, use his/her Facebook connections and existing networks (e.g., kids' schools, sports teams, parent groups, etc.) to see which sitters are trusted by the people that the consumer trust or know. In some embodiments, within the marketplace system, each sitter may maintain their own calendar that displays when they are or are not available to work. This can permit a consumer to see who is most likely to be around when the consumer needs them and can allow the consumer to better target his/her sitter search. A consumer and a sitter may send messages back and forth to each other each other via the system, e.g., conduct a sort of “virtual interview” prior to initiating a trust relationship and/or a booking.

In some embodiments, the system may provide a mechanism for an open-interview request where a consumer may post a message to the system asking for providers to initiate an interview themselves, thereby self-identify as candidates for trust. This open-interview request may contain criteria that the parent asks the sitters to use to self select, including but not limited to geographic proximity, background checks, certifications, etc. Outside of open-interview requests, providers may not be able to initiate interviews.

When a consumer identifies a sitter he/she trusts, the consumer can add the sitter to the consumer's trusted sitter list (e.g., by clicking a button on her/his profile). The system can maintain such this list, which may serve as a quick mechanism to direct a service request out to all trusted sitters at the same time. In some embodiments, this list may contain sublists. In some embodiments, a consumer may create multiple lists. Consumers, providers, and groups (such as, but not limited to, coops and sitter clubs) may all create and maintain lists which may or may not be made available to other users. A sitter can respond directly to the consumer if the sitter is available. When a consumer has filled out a sit request form, the consumer can indicate which sitters to send the request to. A consumer may allow potential sitters to contact the consumer by posting a sit request on a Sitter Job Board, for example. The Sitter Job Board can be a place where a sitter can browse for open sit requests, and contact a consumer if the sitter is available.

The system may provide automatic discovery of sitters trusted by other parents in their network, for example, as depicted in FIG. 2F. During the vetting process, the system may integrate or interface with a consumer's social graph. For example, parents may see how they are connected to each sitter, who their friends use, etc. The system may provide reviews and allow sitters to run background checks on themselves or by parents (where permitted), e.g., at no cost to either parent or sitter. With regards to the scheduling process, parents may create one request and send this to multiple sitters, as depicted in FIG. 2C. The system may not require communication with and/or coordination with every sitter. This can dramatically increase the chance of finding an available sitter. The system may facilitate sharing between consumers. In some embodiments, the more people you are connected to, the more value you may receive from sharing within a network of consumers and/or providers. Thus, the system can provide an incentive for a consumer to share providers in a network for the benefit of self and others.

In another aspect, the system may match consumers with providers using a coop. The system may enable consumers or parents to leverage their connections in order to trade free or low-cost, high-quality or trusted babysitting with friends or members, for example, as depicted in FIG. 2C. In some embodiments, babysitting cooperatives (or coops) are community-based groups of parents who swap childcare services with one another. Instead of exchanging cash, members may exchange sitting for sitting. Some coops may make sure everything nets out equitably by tracking points. In some embodiments, the points system allows consumers to go negative. In some embodiments, the points system is explicitly constrained to have a system-wide sum of zero points with the coop carrying the net negative/positive balance after all user points are accounted for. By managing negative points balances (sometimes including maximum negatives) and/or enforcing a net sum of zero, the coop can reduce the amount of effort necessary to maintain a healthy micro-economy (e.g., eliminates or reduces the incentive to hoard). The marketplace system can provide tools for establishing, running and/or managing a coop. A consumer can get points when he/she sits for someone else, and the consumer can transfer points to others when others are sitting for the consumer. In some embodiments, a coop may provide a mechanism for trading services that are not of the same type or nature (e.g. one consumer provides yard work services and receives babysitting services in exchange). Since the consumer is part of a group, the consumer may not have to worry about reciprocating directly with those sitting for the consumer. A consumer may request to join a coop (or start a coop) through the system after creating an account with the marketplace system. The system can provide an interface for a consumer, e.g., a search form, to find a coop near the consumer. A consumer may complete a Join Request form accessed via a coop's page or the marketplace system.

The system may provide tools to start, grow, and manage babysitting coops. The system may reduce complexity for parents at various critical steps in the babysitting arrangement process. For example, during the search or finding process, the system may provide a database that can be searched, e.g., for free or at low cost to find coops in their community. Coop members can proactively invite others into the coop. The vetting process may be simplified, since members typically know each other beforehand and are referred in to the coop. A moderator may act as a membership gatekeeper. Consumers or parents can run background checks on themselves or on each other, where permitted. With regards to the scheduling process, a consumer can create a single request and send it to his/her entire coop. The system may not require communication with and/or coordination with every coop member. This may dramatically increase the chance of finding an available coop sitter. The system may facilitate sharing between consumers. For example, the more families there are in a consumer's coop, the more value the consumer can potentially receive or benefit from. Every additional member may translate into a potential provider.

In some embodiments, when members of a consumer's coop need a sitter, the consumer can opt to receive notification according to the consumer's preferences, to view the request. To respond to the request, the consumer may simply log in to the marketplace system and click a “Make Offer” button. The consumer's offer may be sent to the requesting member and the consumer may be notified if they accept the offer to sit. Each time the consumer provides childcare for another coop member, the consumer may receive points. Each coop can set its own rules for how points are calculated, typically based on number of children and number of hours. Coops can award additional points for situations like sitting late at night (or early in the morning) or serving meals during a sit. Using the marketplace system, a consumer may not have to worry about stockpiling points. The marketplace system's points system can allow a consumer's point total to go negative, e.g., borrowing points to be made up in the future. Some coops may start new members off with a certain number of points.

The marketplace system may provide a management module for transferring coop points. In some embodiments, once the date for a scheduled coop-based sit has passed, the requesting member may receive an email prompt from the system to transfer the appropriate number of points to the sitter. By clicking on the prompt in the email, the requesting member may be taken to a points transfer form of the system. This form may be pre-populated with the amount of points to be transferred, as calculated from the initial request. If the amount of points is accurate, the requesting member may click “transfer” and the process may be complete. A consumer may be assigned a moderator of a coop via the marketplace system. The Moderator may receive notification of join requests from prospective members. The Moderator may answer questions a prospect may have as well as vet the prospect according to coop rules. The Moderator may admit a prospect into the coop. While some coops may have offline processes to vote and admit members, it may be the Moderator who handles the site approval.

Referring now to FIG. 2D, an illustration of time that may be saved in arranging a sitter service using an embodiment of the marketplace system is depicted. For example, a parent or user may take two minutes to fill out a form on the system's website (e.g., SittingAround.com). The user's request may reach ten trusted sitters in her network. The user's request may also reach other members of her/his coop, potentially leading to a no-cost sit. The user may receive email notifications of offers. From there, it may be a few clicks from having a sitter scheduled. With the service provided by the marketplace system, a consumer may be so confident of finding a sitter that she/he can confirm her/his plans before requesting for a sitter. The consumer may invite/introduce his/her friends to the marketplace service or network, further extending the network of consumers and/or providers. FIG. 2E illustrates some of the features and/or benefits of the system to consumers and providers. FIG. 2F illustrates the potentially many outlets provided by one embodiment of the system, in response to a request for a provider.

In some embodiments, the system may allow a plurality of users to register or enroll, for example, through a website or interface of the system. A user may be a consumer and/or a provider of some service. The system may provide each user with a user account. A user account may comprise information such as email address, name, password, and login and/or registration dates. Such information may be maintained by the system for users to subsequently login or access services and tools provided by the system. A user can register for multiple roles in our system: e.g., Parent (consumer or sometimes referred to as “User”) and Sitter (provider or “Provider”). The system may represent Trust (e.g., between a provider and a consumer) by an object linking two consumer/provider objects (e.g., consumer group or coop). A user can be both a consumer and a provider. A user can have multiple provider roles, e.g., sitter, nanny, dog walker, gardener. A primary trust relationship may be formed from a consumer to a provider role. A user who trusts a provider in a different role may see the provider as part of their “network of trust” for the other role.

In some embodiments, the system may use numerical values to rate, order and/or filter trust based on type of connections, graph distance, or other factors. For example, a first degree connection may have a value of 100 while a third degree connection may have a value of 25. A Facebook connection may have a value of 80 while a coop connection may have a value of 95. In some embodiments, these numerical values may be shown to users, in others they may not. These numerical values may be combined mathematically through simple combination functions (e.g. add, multiply, max) and/or more complicated combination functions. A consumer and/or the system may triage trust linkages based on such numeral values or scores.

The system may provide the marketplace services to a user and reduce cost to the user by using a number of pricing models, adapted based on use, features and/or service category, such as a periodic fee for an account (e.g., membership fee), a periodic fee to have an active provider profile (e.g., listing fee), a periodic fee to have a premium provider profile, a one-time fee to consumers to send requests (e.g., potentially only if matched), a one-time fee to provider to respond to request (e.g., potentially only if accepted), and a percentage fee when the system processes a payment. By keeping the pricing and system highly modular, the system can move revenue/pricing to various points in each service vertical, and can maximize total value to users and/or total revenue.

In some embodiments, the marketplace system may establish multiple sites targeted at specific service verticals (e.g., babysitting, pet-sitting, or gardening services). A vertical site may provide for substantially more targeted search engine optimization, and the ability to customize and/or abbreviate processes. In other embodiments, the marketplace system may establish a macro-site with all or multiple verticals. For example, the macro-site may service a set of affiliated vertically targeted sites. The system may leverage on a macro-site to establish extended trust networks and other effects.

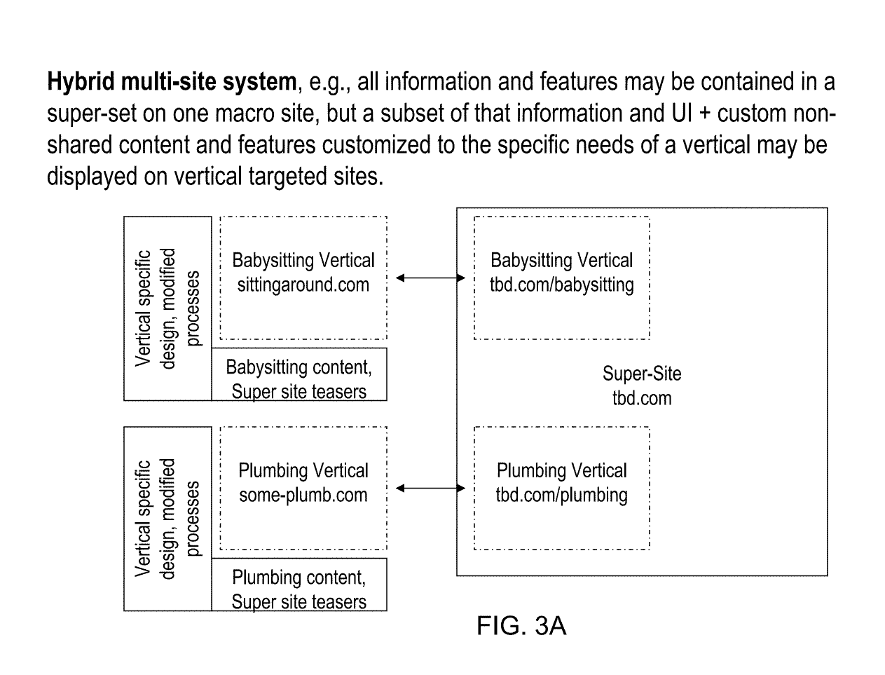

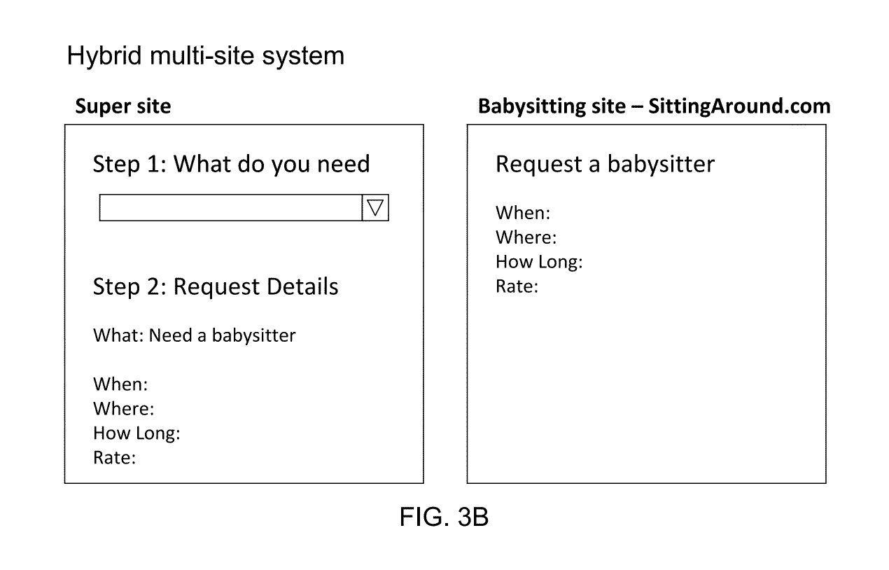

In some embodiments, and as depicted in FIG. 3A, the marketplace system may comprise a hybrid system where all or some information and features (e.g., common features, consumer/provider network database) are contained in a super-set on one macro site. A subset of that information and/or vertical-specific features (e.g., user interface and custom non-shared content and features customized to the specific needs of a vertical) may be displayed or maintained on each vertical's targeted sites. For example, the system may have the core data as part of the super site and served to the individual vertical sites, e.g., user accounts, profile descriptions, geo data. The system may maintain non core content (e.g., lead-generator content such as blog posts or (search engine optimized (SEO)) seo-optimized articles) as part of a sub-site. FIG. 3B depicts one embodiment of how a sub-site may be linked to a super/macro-site, with an abbreviated process accessing to the same core data for example, to present to a consumer.

In some embodiments, the marketplace system can provide network links within and/or between one or more of the following types of groups:

(i) Cooperative exchange groups—where consumer/parents may be members—such a group can act as a node/network for passing trust, a mechanism for the reciprocal consumer provision of one or more services (e.g., trading free babysitting), and a hub for one-to-many service scheduling. Membership may be limited to 1 per user.

(ii) Neighborhood groups—in some embodiments, any kind of user may be a member—such a group may act as a node/network for passing trust and curating lists of trusted/recommended providers. There may be no trading aspect. Users may be members of multiple groups.

(iii) Provider groups (e.g. babysitter clubs or babysitting agencies)—in some embodiments, providers/sitters may be members—such a group may act as a node/network for passing trust, a curating function for the providers admitted, as well as making available another form of one-to-many requesting or scheduling. There may be no membership limits in certain embodiments.

Some or all of these groups may have one or more of the following features: (i) maintaining a list of current members, (ii) a system for inviting and vetting potential new members, (iii) members may gain access to additional profile information of other members, (iv) group messaging, (v) limited public information sharing, (vi) private information sharing, and (vii) an ability to change the amount of information that is shown to the public, (viii) group blogging, and (ix) group email lists.

The system may provide an interface for users to establish or create a set of trusted providers, e.g., including importing or creating one or more lists of providers. Such lists may allow a user to create cataloged groups of sitters for the user's own personal use, or curated lists of sitters that are listed publicly or shared with a group. In some embodiments, initially, sitters trusted by members of a coop may be added to a coop's semi-curated list of “sitters trusted by coop.” A curated list may be established, for example, by a real estate agent keeping a list of trusted providers for clients, an apartment or coop manager maintaining a list of trusted providers for residents, and a daycare maintaining a list of sitters for parents of children in the school.

In some embodiments, the system is configured and/or built to track or manage availability of a provider in a ternary state of “Usually available,” “Not Available,” and “unknown.” In certain embodiments, the ternary state may sometimes be referenced as “Maybe”, “No” and “Yes”. In some embodiments, the system may track or manage availability using other states, such as “Available”, “Tentative”, “Maybe”, etc. The system may also track or manage availability of a provider using any combination and number of states, and may customize this based on a provider, for example. In some embodiments, the use of a ternary state, for example, attempts to optimize a tradeoff between input work, information going stale, fault tolerance, and/or accuracy of information for a consumer. In certain embodiments, ternary availability information can be further optimized by pairing with regular occurrence information. The system may allow users to indicate and store their availability state on an occurrence timeframe to further optimize a tradeoff between work and information value. In some embodiments, providing only one occurrence timeframe frame (e.g. weekly) is advantageous. Further, as there can be additional states that are not “yes/available,” consumers may be more likely to send a request to a provider (e.g., to a “usually available” or “maybe”) than in a binary system (e.g., “available” and “not available”).

In some embodiments, the system may support an indication of explicit availability (e.g., “available on Friday the 17th of May, 20xx from 7 to midnight” vs. “usually available on Fridays from 7 to midnight”). The system may allow a consumer to directly book a slot through one or more commitment processes. In certain embodiments, the system may include information such as availability, booking request and completed reservation, and other time information into an integrated calendar. The system may make this calendar available for syndication, e.g., to third party calendar hosts like Google Calendar or Microsoft Outlook.

The system may be configured or built to support one or more commitment process between a consumer and a provider. A commitment process may be referred to as a mechanism for scheduling service with a provider. In some embodiments, the system supports a “Request->offer->accept” process. By way of illustration, a consumer may request a service for a time and location. This request may be sent by the consumer to a selected group of providers (e.g., including a cooperative group if the customer is a member and selects it). The request may be potentially made open to the network, such that one or more providers in the network can respond or make an offer through the system. The consumer may select an offer through the system and the request matched. Such a process may remove or alleviate negativity associated with a rejection by either a consumer or a provider. For example, a provider may not have to deal with each rejection from a consumer on a one-to-one basis. The provider may deal with a bunch of offers from multiple consumers through the marketplace system which provides a higher probability of success. A consumer may deal with a bunch of offers from multiple providers which has a higher probability of success. The system returns a match without providing “negative” details about rejections or mismatches.

In other embodiments, the system may support and/or implement a commitment in which a request is sent and service is scheduled with a first offer from a provider (e.g., trusted provider). For example, a consumer may request a service for a time and location. This request may be sent by the consumer via the system to a selected group of providers (e.g., including a cooperative group if the customer is a member and selects it). The request may be potentially made open to the network. A first offer from a provider may be automatically accepted and the request matched.

In one embodiment, a consumer may send a booking request based on a providers' availability and the request may be (e.g., automatically) accepted by the provider and/or consumer. A provider may, for example, list times the provider is available (e.g., with rate information). One or more consumers may request for a booking. The provider may accept a request that the provider prefers.

In another embodiment, based on a provider's availability, a first booking from a consumer that matches an available time slot is confirmed or accepted (e.g., by the system). The system may allow the provider to store a maximum distance which the system will use to exclude work too far away from the provider to be reasonably serviced, for example. For example, a provider may list times the provider is available (e.g., with rate information). The system may identify the first consumer to request a booking for an available slot. The system may automatically accept the booking and the time is booked.

In some embodiments, the system may use aggregation, syndication, and other out-of-system activities to provide sub-scale relevance to early users of the marketplace or augmented outcomes for later users of the marketplace. Aggregation of job or work listings from various web sources (e.g., Oodle, SimplyHired, TaskRabbit) may be parsed to match the data models of the system and delivered to providers either directly as a value added service or via a searchable directory. Syndication to other websites or services of requests for service or open-interview job listings may allow early consumers to get relevant outcomes before a critical mass of providers exists in their area.

The system may support various flexibilities in scheduling a service, e.g., scheduling babysitting which has a definite (or approximate) start time, approximate but indefinite (or fixed) duration, non-finite or flexible (or finite, specific) tasks, and hourly (or lump sum) pay. The system may support variations or specific differences for different service industries. For example, some services may require slightly different time types:

House Cleaning may be characterized by a finite duration, acceptable windows of time, non-finite task, and/or hourly pay. House Cleaning may feature regular recurrence of some or all of these characteristics after a first service occurrence. In some cases, House Cleaning may be characterized by a finite task, indefinite duration, acceptable windows of time, and/or hourly or task-based payment. In some embodiments, Plumbing may be characterized by a finite task, indefinite duration, acceptable windows of time, and/or task-based payment. In other embodiments, Plumbing may be characterized by a finite task, indefinite duration, urgent need, and/or hourly or task-based payment. In certain embodiments, Carpentry, for example, may be characterized by a task of high/significant complexity requiring consultation. The system can be configured or adapted to schedule a consultation associated with such tasks. In some embodiments, a Nanny service may be characterized by a finite duration and/or regular recurrence which the system can be configured to manage and/or schedule. In certain embodiments, a Tutoring service may be characterized by a finite duration, regular or irregular recurrence, semi-finite task, and/or hourly pay. By incorporating a modular scheduling system in the marketplace system, an administrator can customize the scheduling system to match specific scheduling needs of each service industry.

The system may, regardless of the scheduling mechanism selected, send notifications (e.g., of a service request, acceptance, etc) via one or more delivery mechanisms. One delivery mechanism may include delivery via email and/or an indication through the website. Other delivery mechanisms may include text message, voice message generation, notification via interfaces with social networking websites, etc. In some embodiments, the system sends a request to selected providers immediately at the time of the request. On the day of a request, if the request is made open to a network of the consumer, the system may send a list of open requests to providers based on provider's geography, for example. The system may send status changes, for example, when offers are received, changed, commented upon, when the request is matched, and/or if the request is changed or cancelled. On a day prior to a request, the system may schedule a reminder notification to be sent to the consumer and/or provider. At the time of service, the system may send a payment reminder to the corresponding consumer. Within some predetermined period after a service, the system may send a review request (e.g., if review not yet completed) to the corresponding consumer and/or provider.

In some embodiments, the system may be configured or built to support a negotiation/bidding process. Although in certain embodiments, only certain information about prior offers may be displayed to prospective providers in a situation where multiple consumers may be arranging for the same service, in other embodiments, additional information about competitive bids may be provided.

The system may enlist a combination of humans and intelligent computer programs to act as agents to proactively match consumers with providers at multiple points in the system (e.g., during the find and schedule phases). The system may provide access to third party agents, and may access third party data directly. The system may include mechanisms for paying agents when they facilitate a match and market clearing. As an example, in the babysitter market, a “sitter agency” is one type of a matching agent. An agent and/or the system may, for example, take into account a consumer's home address, time of request, providers' external and internal calendar, home address, providers' available means of transportation. The agent and/or the system may find mutual times for the consumer and provider, calculate travel time, factor in cost of travel, and proactively attempt to match the consumer and provider.

In various embodiments, the marketplace system leverages on trust within the marketplace. Trust may be uniquely established by each individual. A consumer may create and/or maintain a trust network for the consumer. The system can provide users with multiple tools to help build (or reject) trust. The system provides trust configurability to a consumer through the use of one or more of such tools. A consumer may select an entity (e.g. provider, another consumer, a coop, a person from the consumer's social network, etc) to designate as a trusted entity, using any one or more of such tools. The system allows trust building to be established by extending any of these methods offline. Referring to Table 1, one embodiment of tools available for trust building is described.

TABLE 1
Trust Building Tools

| Trust Tool | Information |
|---|---|
| Geographic | Public geo searches may be done at zip/postal code |
| Proximity | level |
| | Users may share address in vetting/scheduling. |
| Group | Coops can form trust-passing groups for parents. |
| Membership | Sitter Groups and affiliations may be added. |
| Ratings and | Examples of such features include 5 star ratings, |
| Reviews | on time %, recommend % and text reviews. May be |
| | included as an established, known method of |
| | vetting. |
| Background | While sometimes imperfect, this can provide a |
| Checks | useful screen that weeds out and/or scares away |
| | bad actors before they ever sign up. |
| Friends of | May import social graph from Facebook and/or other |
| Friends | social networks. |
| | This allows mechanical passing of trust - e.g., a |
| | computerized version of word of mouth. |

In one aspect, the system allows a consumer/provider to build trust using geographic proximity as a factor. Geographic proximity can be important for finding providers/clients, building trust based on accessibility and/or timeliness, and/or for assessing travel costs in providing services. In using geographic information, the system can balance between Privacy, Time/Cost to input the information, and Accuracy of the information. In some embodiments, the system organizes, maintains and/or manages geographic information, for example, in the following illustrative way. The system may align or arrange objects (e.g., consumers, providers, coops, etc) with a geographic hierarchy. A geographically enabled object may include a Country and Zip Code attribute. If the country and zip code attribute match records in a master table (e.g., with geographic, postal code and/or other information), the object may get a reference to the master table. An object having an unknown or unresolved zip codes may be allowed in the system, but a country selection/indication may be required and may be highly restricted to one or more choices. Objects with an unknown or unresolved zip code may not be able to be mapped, and may be shown as part of a “location unknown” category in their respective country. For example, by associating or tying objects with zip codes, the system can obtain or identify locations within a reasonable bound, at a low cost. The locations can also be automatically mapped (e.g., by the system) to a geographic hierarchy (e.g., for user navigation and search engine optimization). The system can also enable a user to select a point on a map for an object to indicate the object's location. The system may provide a process to fine-tune the location, e.g., enable the user to select an appropriate geographic division from a list of the nearest geographic divisions.

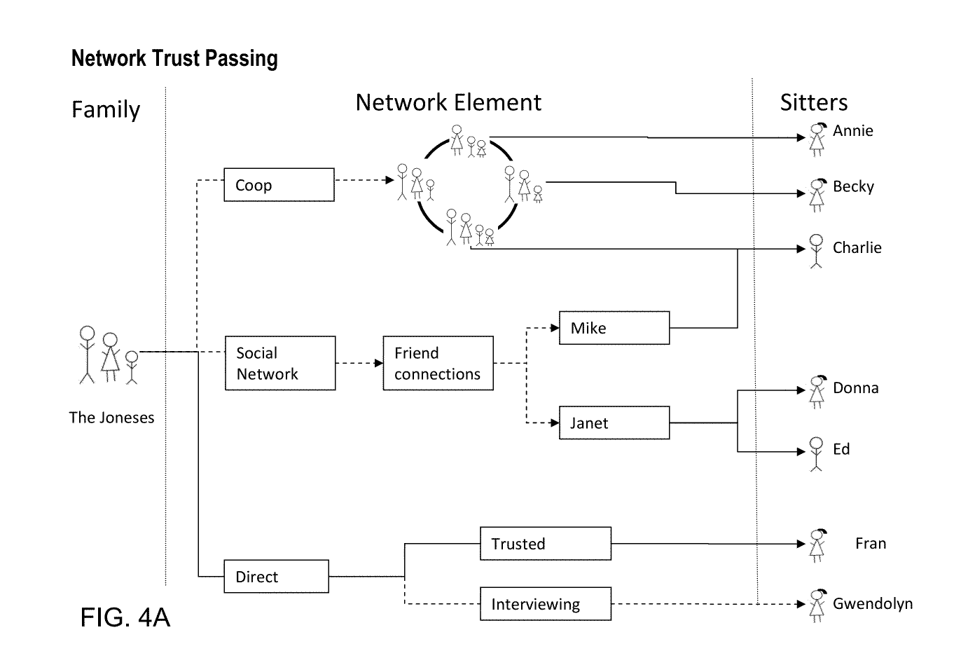

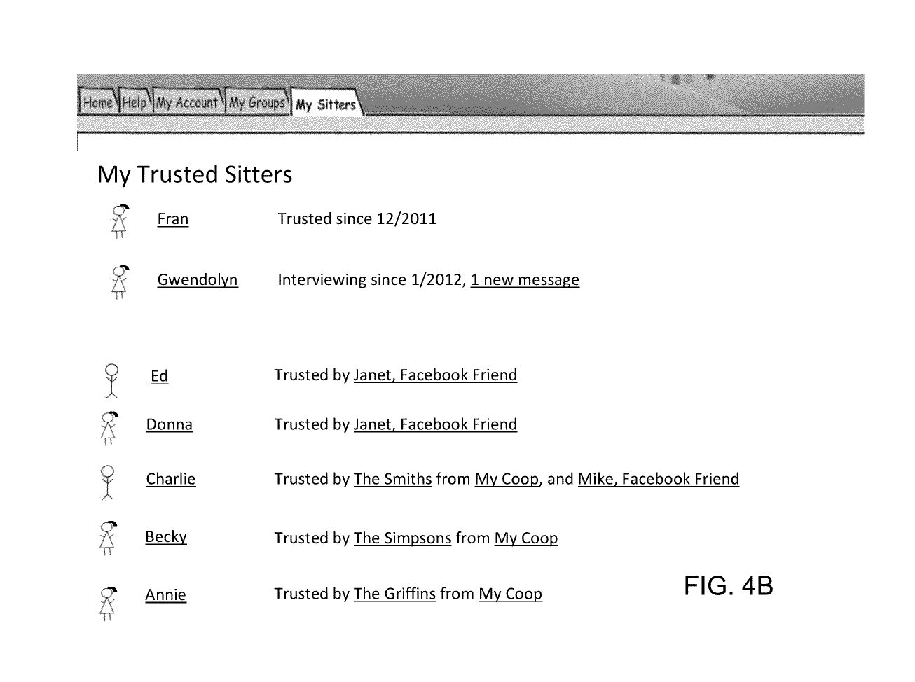

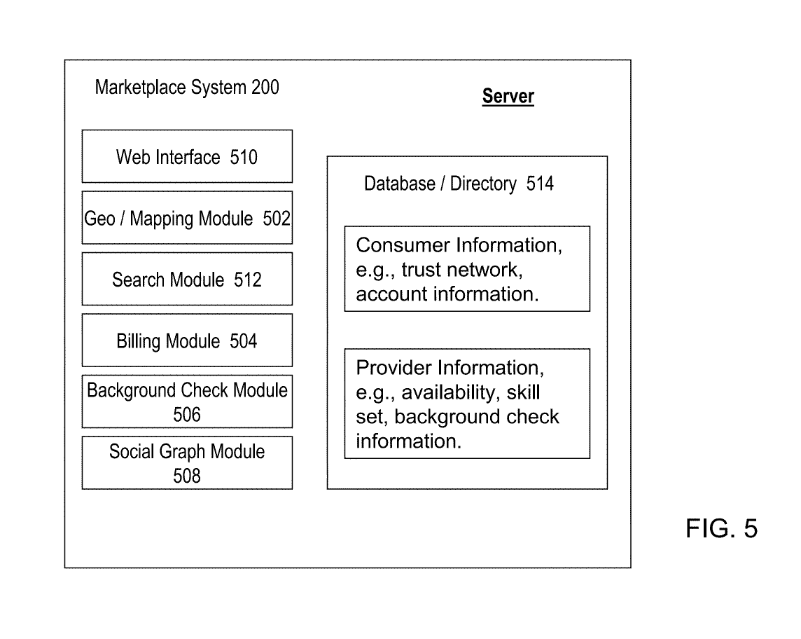

In some embodiments, a consumer may share a trust network, or a portion thereof, with another consumer. In one embodiment, the consumer may pass network trust to another consumer. FIG. 4A illustrates some ways in which trust passing may occur. For example, a consumer may leverage on a social network (e.g., Facebook, LinkedIn), which can include a professional network, to pass trust to another consumer and/or acquire trust from another consumer. In some embodiments, the consumer may acquire trust for a provider through a direct, existing relationship within a social network. The system may provide an application (e.g., Facebook app), API or link into a social networking site, where a consumer may share trust information and/or establish a trust relationship with another member of the social networking site.

The consumer may specify a number of trust attributes for each existing trust relationship or pathway with a provider. The system can track and maintain these attributes, so that other consumers may decide on whether to establish a trust relationship or pathway with the provider. For example, such attributes may include the level of trust, the length of the relationship, the role of the provider, how the trust relationship was established or adopted (e.g., through referrals, by reviewing ratings, by interviews), any other relationship between the consumer and provider (e.g., part of the same social network, coop, or are relatives, alumni, neighbors, etc). For example, the consumer may specify a rank or indication of the trust level, which may be adjusted from time to time, e.g., based on the provider's performance, or the number of transactions. In some embodiments, the system may make some or all of these attributes available to another consumer, which may depend on whether the latter is related to the originating consumer (e.g., via a social network). In certain embodiments, the system may calculate or generate a score based on some or all of the attributes, and may provide this score to another consumer. In some embodiments, the system or the consumer may assign or provide similar attributes for a trust relationship/pathway with another consumer or entity (e.g., coop). In some of these embodiments, a consumer may consider such attributes when considering a provider trusted by this other consumer or entity.

In some embodiments, a consumer may use reviews and/or ratings from a marketplace, website, service listing, community, social network or other source, to decide on whether to include or invite a provider or other entity into the consumer's trust network. In certain embodiments, a consumer may initiate or rely on a background check to decide whether to add a provider to the consumer's trust network. The consumer may initiate a background check on a provider via the marketplace site provided by the system. The consumer may request a background check report from a provider (e.g., performed by an independent and/or reliable party). The consumer may request a provider for testimonials and/or recommendation letters from other consumers. The consumer may request a provider to provide references. Any of these information may be stored, updated and/or maintained by the marketplace system, and may be publicly available or accessible by request.

A consumer may leverage on existing trust for one or more providers within a coop, to extend the consumer's trust to the one or more providers. In some embodiments, a consumer or a trusted/authorized moderator may add a sitter group and/or any affiliated entity to the trust network of a coop. In some embodiments, a consumer may add a provider to the consumer's trust network after vetting, interviewing and/or utilizing the provider for a service. A consumer may add a provider of a particular service to the consumer's trust network for another (e.g., different or related) service. For example, the consumer may trust the provider for childcare services, and may extend the trust to the same provider for pet-sitting services. FIG. 4B depicts one embodiment of how the system may present trust information of a consumer.

TABLE 2
Embodiments of Trust Pathways

| Trust Pathway | Information |
|---|---|
| Parent ==> Sitter | Core object, Explicit one-to- |
| | one trust relationship, for |
| | example. |
| Parent −> Coop −> | Onsite parent to parent trust |
| Parent ==> Sitter | passing can be handled by way |
| | of coop grouping. Some coops |
| | may exist only as trust passing |
| | groups while others may retain |
| | reciprocation aspect. |
| Parent −> (Social Network) −> | If a user links their Social |
| Parent ==> Sitter | Network AND |
| Parent −> (Social Network) −> | Parent-Sitter connection on a |
| Sitter | network is an implicit trust |
| | relationship. |

Referring to Table 2, some embodiments of how a trust relationship may be established is depicted. In some embodiments, “==>” means “trusts”; it can be an explicit trust relationship, mirrored by a trust object in our database. In certain embodiments, “->” means “follows”; it can be a pathway, group membership, etc; it may not be an explicit pathway. In some embodiments, the system may cache non-explicit and/or explicit pathways. The system may follow off-site pathways (e.g., to social networking site). In certain embodiments, the system may not follow off-site pathways more than 1 level (or other predetermined number of levels), e.g., to limit processing cost. In some embodiments, the quality of transitive property of off-site pathways may degrade rapidly as the number of degrees of separation increases.

TABLE 3
Additional Embodiments of Trust Pathways

| Trust Pathway | Information |
|---|---|
| Parent ==> Sitter Group | Has an implied Sitter Group −> |
| | Sitter relationship |
| Parent −> Coop −> Parent ==> | Has an implied Sitter Group −> |
| Sitter Group | Sitter relationship |
| Parent ==> Sitter −> Sitter | 2^{nd} degree association |
| Group | |
| Parent −> (Facebook) −> | Has an implied Sitter Group −> |
| Parent ==> Sitter Group | Sitter relationship |
| Consumer ==> Provider (other | In some cases a parent may |
| role) −> Provider −> Provider | trust a sitter, but that sitter |
| (current role) | may also be a gardener. Since |
| | trust is role specific there is |
| | no primary trust for this |
| | provider as a gardener, but |
| | there is a network trust. |
| Parent −> (Social Network) −> | Model used with a social |
| Parent | network can be generalized to |
| | any and all social networks |
| | with scale and mature APIs |
| Others | May be custom, or adapted |
| | from other pathways. |

Referring to Table 3, other embodiments of how a trust relationship may be established is depicted. In some embodiments, “==>” means “trusts”; it can be an explicit trust relationship, mirrored by a trust object in the system's database. In certain embodiments, “->” means “follows”; it can be a pathway, group membership, etc; it may not be an explicit pathway. Examples of pathways through social networks include pathways through Facebook, Google+ and LinkedIn, although not limited to these. The system can be adapted to support any de facto or significant social network in any country or marketplace.

TABLE 4
Examples of Trust Pathways

| Trust Pathway | Information |
|---|---|
| Parent ==> Parent | Since a “Trust” is a non-reciprocal |
| Parent ==> Parent ==> | relationship, this may create a mechanism |
| Sitter | to steal sitters from other parents. |
| Coop ==> Sitter | 90+% of value may be derived from |
| Coop ==> S. Group | Coop −> Parent ==> Sitter |
| Parent ==> Sitter ==> | Sitter ==> Sitter trust may have |
| Sitter | potential to be a semi-transparent |
| Sitter ==> Sitter | colluding activity. |
| | Sitter −> SitterGroup can be a formal, |
| | transparent grouping activity limiting |
| | the risk of collusion. |

Referring to Table 4, other embodiments of how a trust relationship may be established is depicted. In some embodiments, “==>” means “trusts”; it can be an explicit trust relationship, mirrored by a trust object in the system's database. In certain embodiments, “->” means “follows”; it can be a pathway, group membership, etc; it may not be an explicit pathway. In some embodiments, the system may or may not support any one of the pathways in Table 4. The system may not support any of these pathways because of a potential of abuse and/or other negative effects.

Referring to FIG. 5, one embodiment of a marketplace system for matching a consumer with a provider is depicted. The marketplace system 200 can comprise one or more servers or appliances communicating through a network, incorporating any of the features described above in connection with FIG. 1A. The marketplace system 200 can include or incorporate a number of modules or frameworks. The marketplace system 200, and any modules or components thereof, may comprise one or more applications, programs, libraries, services, processes, scripts, tasks or any type and form of executable instructions executing on one or more devices, such as servers. The marketplace system 200, and any modules or components thereof, may use any type and form of database for storage and retrieval of data. The marketplace system 200 may comprise function, logic and operations to perform any of the methods described herein. Some or all of these modules or frameworks may be custom, acquired or from an industry partner (e.g., a specialist in billing, for example). The modules or frameworks including that for geographical mapping 502, billing 504, background check 506 and/or social graph 508. The mapping module 502 (e.g., via Google maps) may be built or configured to provide geographical mapping to any area in the world. The mapping module 502 may be coupled with, for example, a self-hosted worldwide zip code database. The billing module 504 (e.g., via Recurly) may process recurring billing and/or card storage. The billing module 504 can support billing to stored cards at any time for any transaction. The background check module 506 (e.g., via Talentshield) may perform background check on any individual and/or maintain associated information for the system. The social graph module 508 (e.g., via Facebook) may incorporate members' existing social graphs to add referral/trust layer(s). The system may post appropriate provider requests or advertise the marketplace system to any user stream, driving additional virality.

In some embodiments, the system 200 includes an interface, such as a web interface 510, for affiliates and members (e.g., consumers and providers). The interface may provide or communicate with a search module 512 to allow a consumer or member to search for a provider, a coop or a fellow consumer (e.g., in a social network), for example. The search module 512 may be linked to the mapping module 502 and/or database/directory 514 to identify providers in a certain area. The database/directory 514 may include any data structure for storing user information, including that of consumers and/or providers. The database/directory 514 may comprise one or more local or distributed storage devices, databases and/or directories, which may be structured hierarchically or in any fashion. For example, the database/directory 514 may be implemented across a storage area network or use a cloud computing configuration. Any of the modules may interoperate and/or communicate with each other. For example, the billing module 504 may process a transaction and update user information to the database/directory 514. The mapping module 502 may access provider and/or consumer information to map or locate appropriate providers for a consumer, for example. The background check module 506 may update a provider's background check information in the database/directory 514, which may be presented to a consumer via the web interface, by way of illustration.

The database/directory 514 may include any type and form of storage or storage service for storing data such as digital content. The marketplace system may be designed, constructed and/or configured to communicate with and/or interface to a plurality of different databases/directories. In some embodiments, the marketplace system communicates with one or more of the database/directory 514 over one or more networks 104, such as to a remote server or cloud storage service. In some embodiments, the database/directory 514 may be located in a network separate from the network of the content distribution system, such as in the cloud. Examples of such database/directory 514 includes servers or services provided by Dropbox, Box.com, Google, amongst others. In some embodiments, the database/directory 514 is maintained by a content publisher 320. In some embodiments, the content repositories are located local to the content publisher 320.

The marketplace system 200 is designed, constructed and/or configured to allow consumers to identify service providers via a trusted network of a consumer. The marketplace system can communicate with one or more devices of consumers, service providers and any of the devices of the database/director 514. The marketplace system 200 can provide a web interface, via the web interface module 510, to the consumer for the consumer to identify service providers and request one or more services to be performed by service providers within the trusted network of the network.

The marketplace system can maintain for each of the consumers a trusted network of one or more service providers. The trusted network includes service providers that have been designated as trusted by the consumer. The consumer can designate a service provider as trusted based on one or more trust attributes or factors. Examples of such trust attributes include but are not limited to the level of trust, the length of the relationship, the role of the provider, how the trust relationship was established or adopted (e.g., through referrals, by reviewing ratings, by interviews), any other relationship between the consumer and provider (e.g., part of the same social network, coop, or are relatives, alumni, neighbors, etc).

The marketplace system can also allow a consumer to add or remove one or more service providers from the consumer's trusted network. In some implementations, the marketplace system can suggest one or more service providers to include in the consumer's trusted network based on one or more of the trust attributes. In some implementations, the consumer identifies one or more trust attributes that are required or desired to include a service provider to the consumer's trusted network. In some implementations, service providers can be identified and/or added to the consumer's trusted network according to a trust policy. The trust policy may be defined by the consumer. In some implementations, the trust policy may be defined by the system. In some such implementations, the consumer may be able to approve the service provider identified as trusted prior to adding the service provider to the trusted network of the consumer.

The system can receive from a consumer, a request for availability of any service provider in the trusted network of the consumer to provide a service. In some embodiments, the request can be for any one of a babysitting service, a housekeeping service, a home improvement service, a maintenance service, a medical care service, a child care service, a coaching service, an educational tutoring service or other inhouse service.

The system is configured to determine one or more of the service providers in the trusted network that can provide the requested service. In some embodiments, the system also determines the availability of the identified service providers that can provide the requested service. The system maintains the availability of the service providers in the database/directory. The system is configured to provide the service providers a web interface through which the service providers can provide their availability over a period of time. The service providers can mark their availability for any specific time period as available, possibly available or not available.

The system can send a request to one or more of the service providers in the trusted network that are either available or possibly available to determine their availability to perform the service requested by the consumer. In some embodiments, the service providers can receive the request via a web interface provided by the system. One or more of the service providers can submit an offer to the system to perform the requested service. The system can then provide the received offer and the identity of the service provider providing the offer to the consumer. In some embodiments, the system can provide reviews provided by other consumers. In some such embodiments, the system can provide reviews provided by only those consumers that are also within the consumer's trust network. Consumers can be included within a consumer's trusted network based on one or more of the trust attributes or factors described above.

In some embodiments, the system can identify the service provider that submitted an offer and identify one or more consumers that have trust networks to which the service provider belong. The system can determine if any of the identified consumers belong to the trusted network of the consumer requesting the service. If any of the identified consumers belong to the consumer's trusted network, the system can provide the identity of the identified consumers to the consumer indicating that the service provider submitting the offer belongs to the trust networks of the identified consumers.

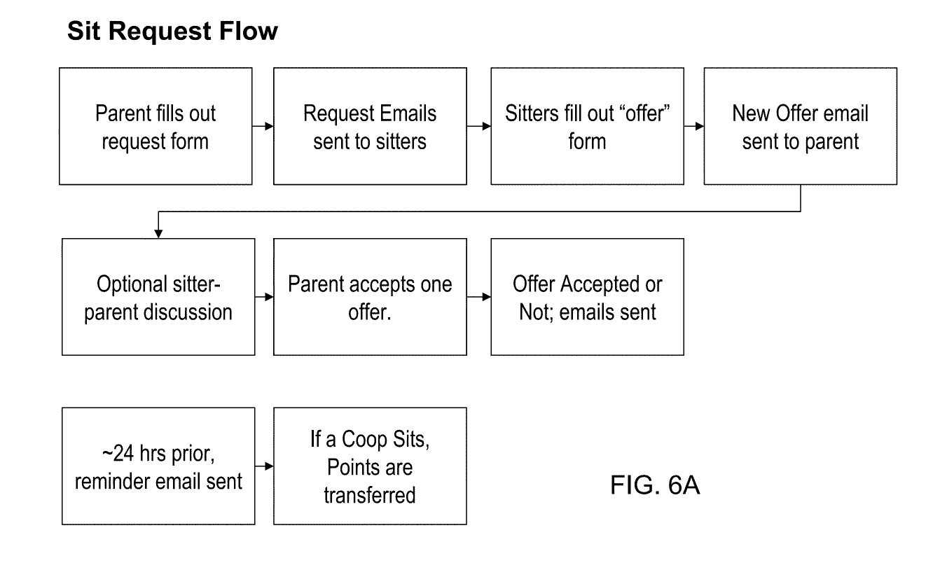

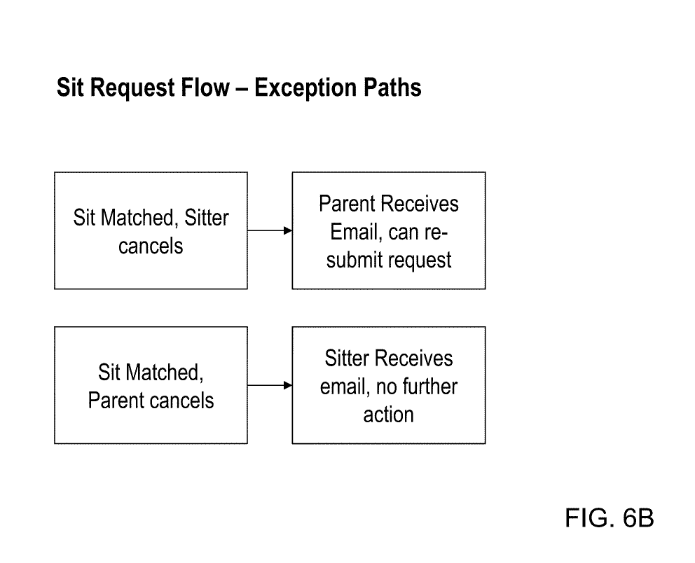

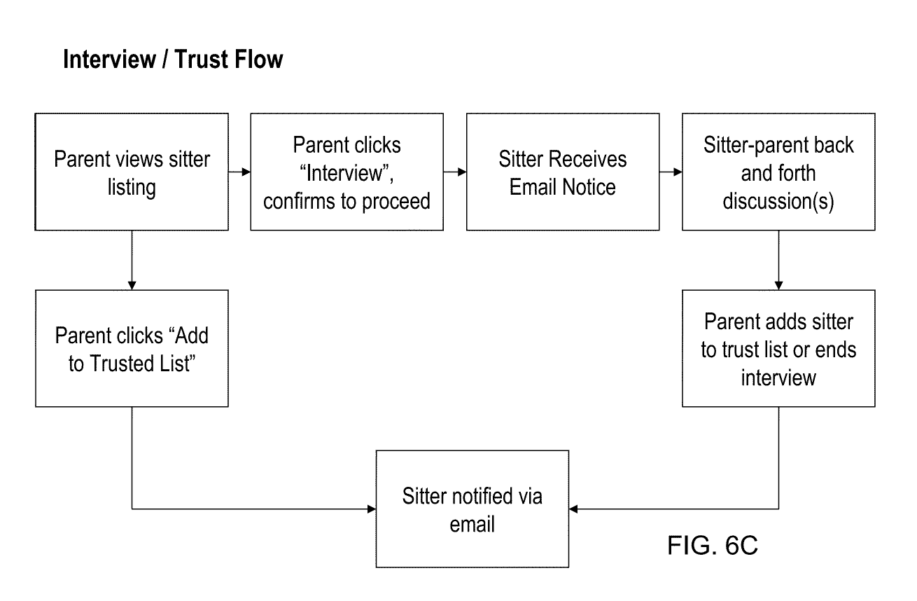

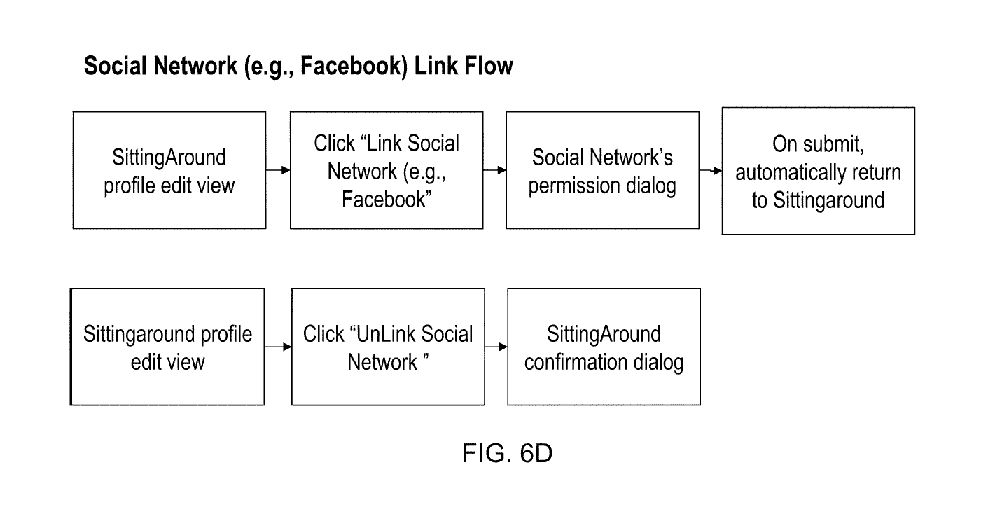

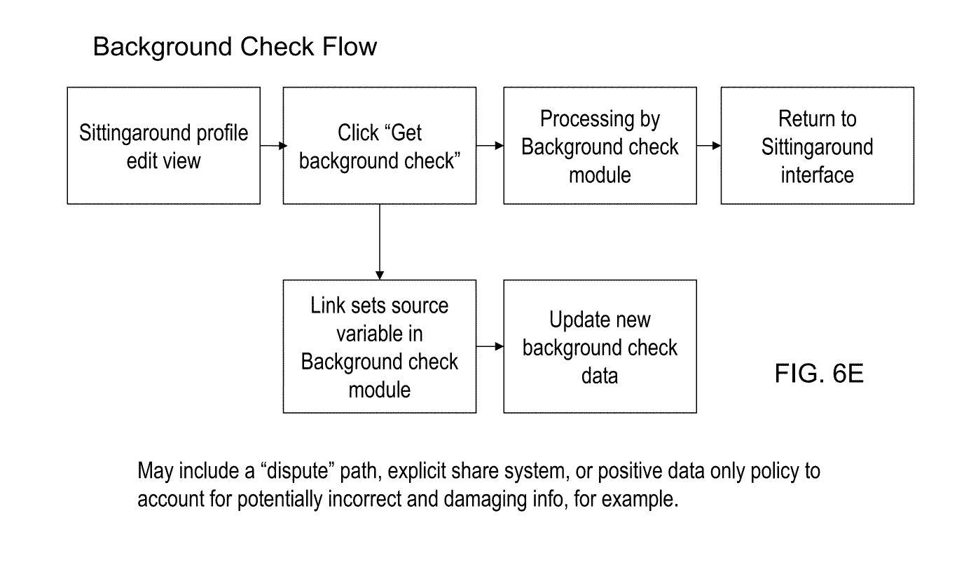

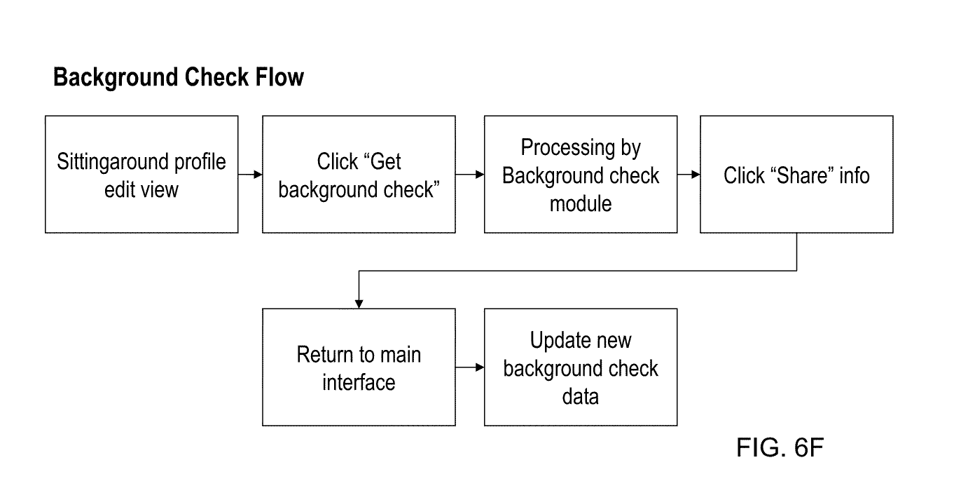

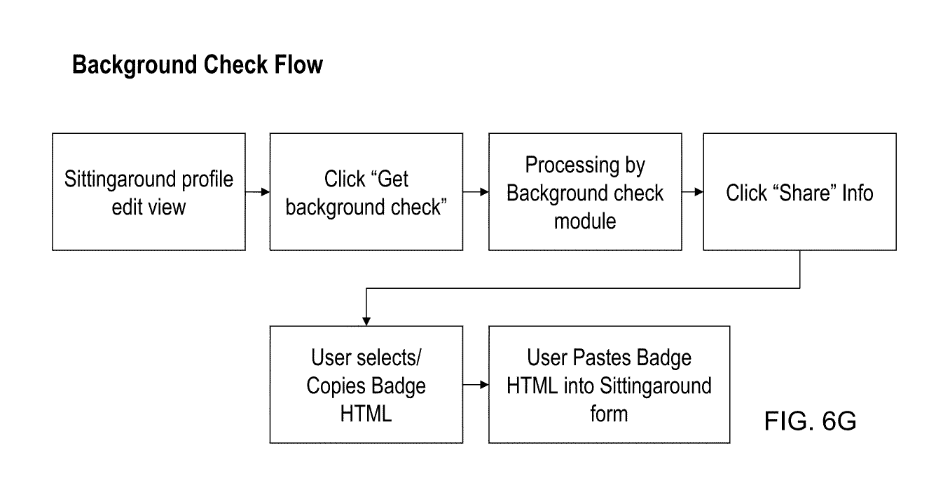

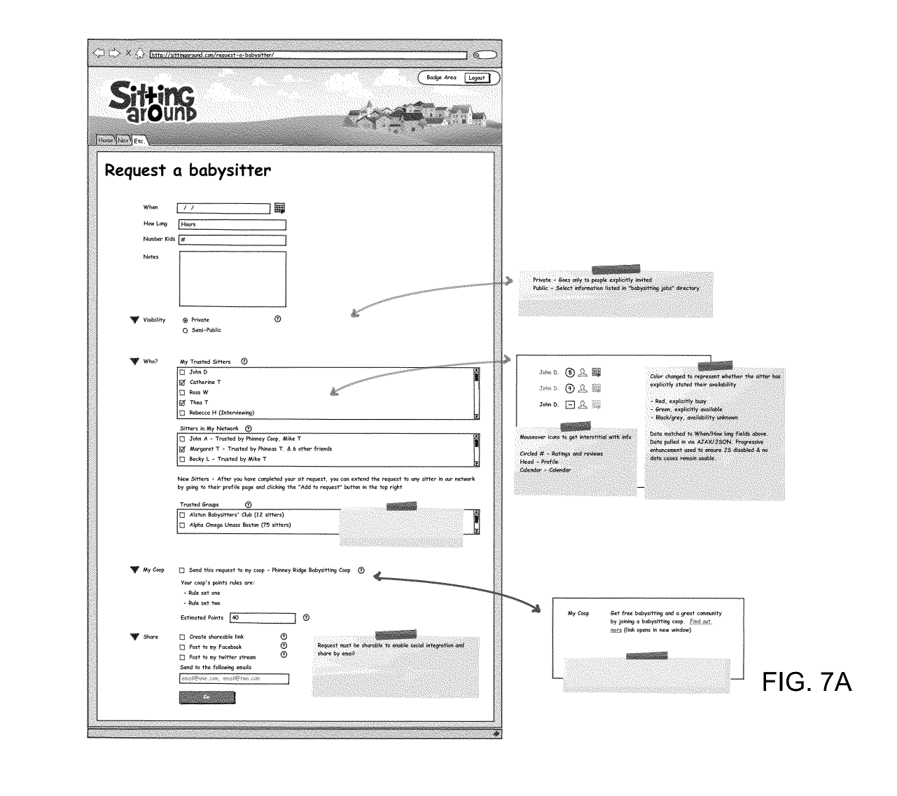

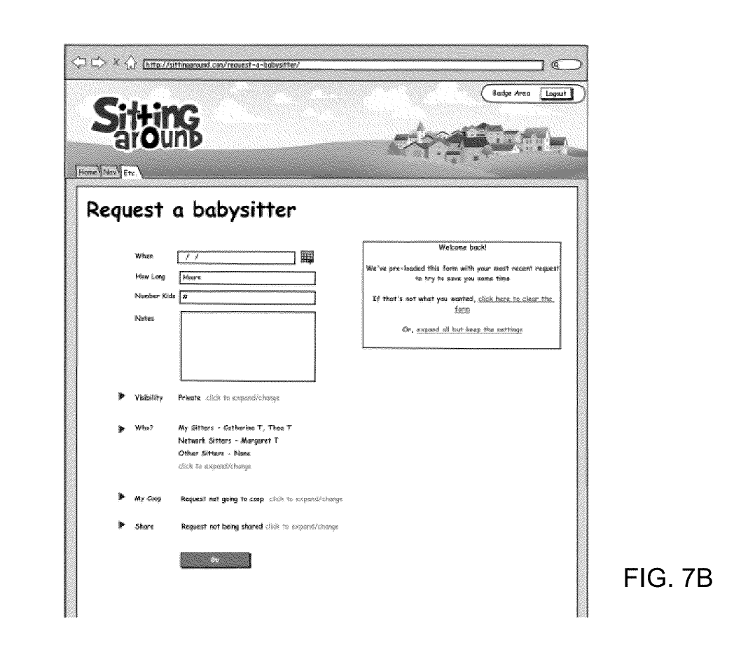

Referring now to FIGS. 6A-6G, embodiments of process flows supported by the system are depicted. These process flows are illustrative and not intended to be limiting in any way. Any of the depicted steps may be optional, and any sequence of steps may be modified, including the addition of one or more steps. For example, FIG. 6A describes how the system processes or helps to facilitate a request for a provider. FIG. 6B describes how the system provides notification and/or handles a cancellation. FIG. 6C describes how the system may enable a consumer to vet or interview a provider before establishing trust or confirming a scheduled service. FIG. 6D describes how a user may link or unlink a social network with the system. FIGS. 6E-6G describe embodiments of how the system facilitates a background check on a provider.

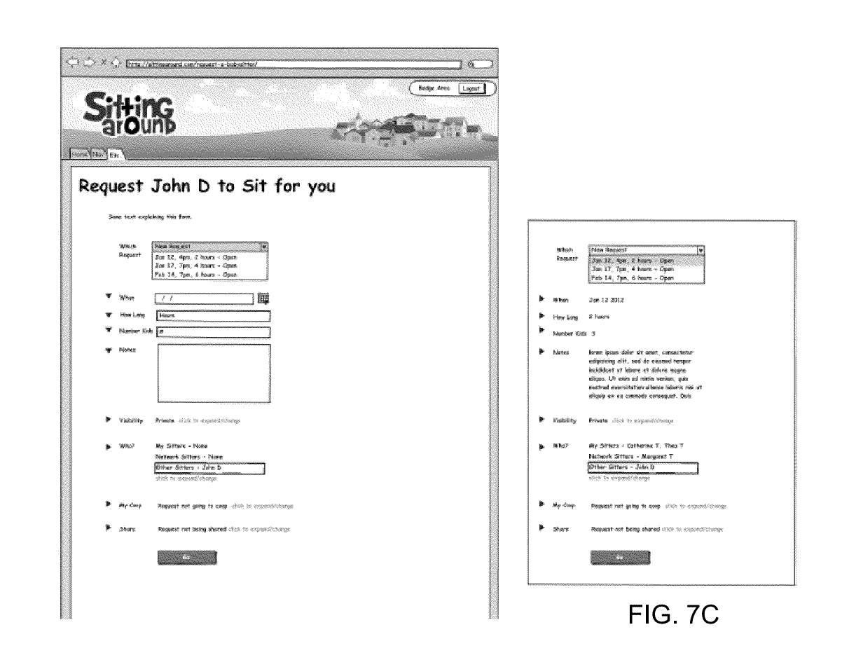

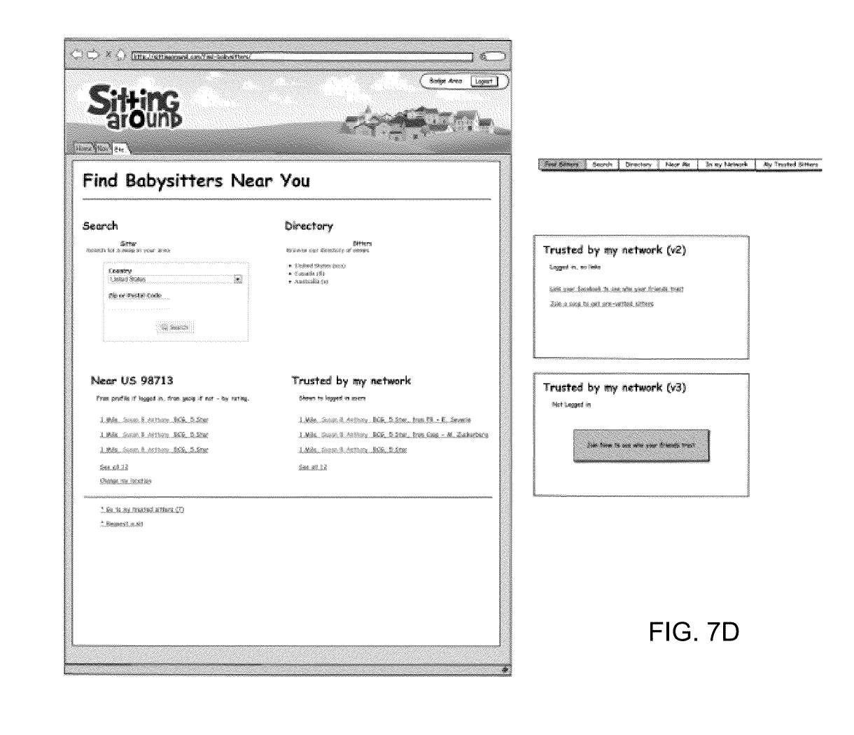

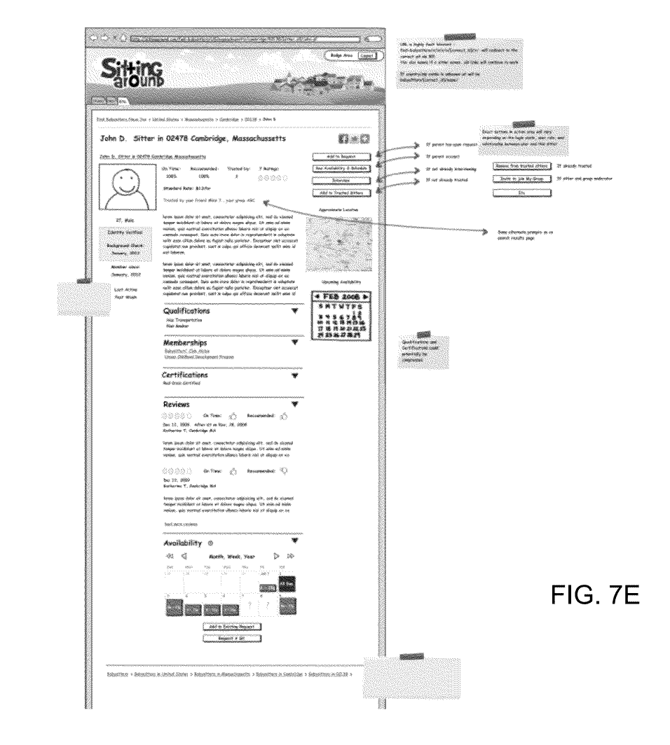

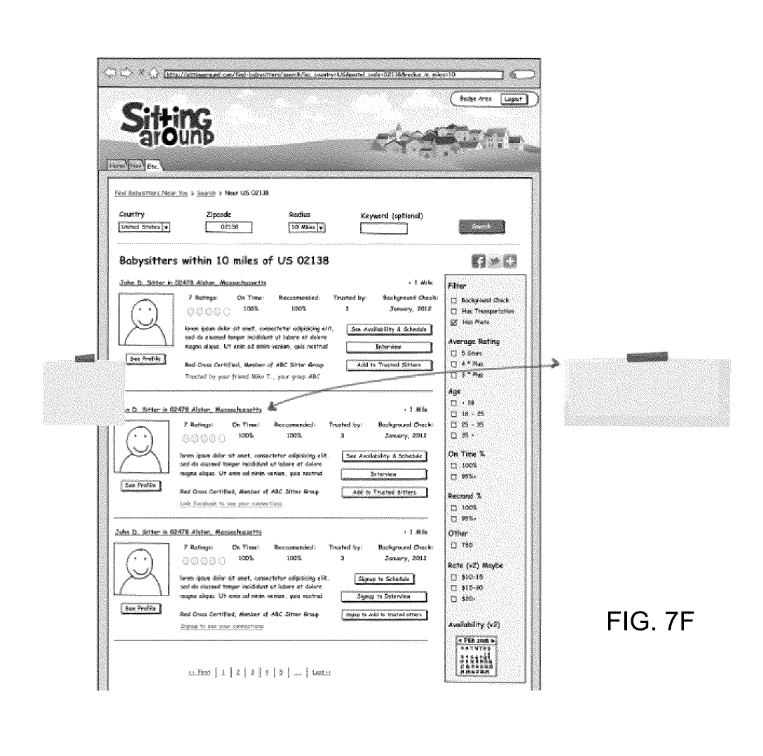

Referring now to FIGS. 7A-7F, embodiments of screenshots of an interface provided by the system requesting and/or searching for a babysitter are depicted. These screenshots are illustrative in nature and not intended to be limiting in any way. In further details, the interface in FIG. 7A prompts a consumer for information regarding the requested service. The interface may include the consumer's trust network of sitters. Various information about a sitter (e.g., status, ratings/reviews, profile, calendar, availability, etc) may be accessed from a listing of sitters provided by the trust network. The system may provide multiple channels for submitting the request, e.g., to a coop, through a social network, and/or to trusted sitters. FIG. 7B depicts a form for inputting basic information for a request. This interface may be provided when the consumer first logins or indicates an interest in sitting services. FIG. 7C depicts an interface for requesting a particular provider. The user may alter or populate this service request form with details of the request. In some embodiments, the data may be auto-populated or transferred, e.g., from the interface depicted in FIG. 7A.

FIG. 7D depicts an interface for searching providers that are located near or available to service an area of the consumer. The interface may provide sitters that serve the indicated location, and may include those that are in the consumer's trust network and/or those that are not. FIG. 7D depicts an interface for providing information about a particular provider, e.g., selected by the consumer. The interface may provide, where available, reviews/ratings, experience, certifications, memberships, availability and/or other relevant information to the consumer. FIG. 7D depicts an interface for listing or summarizing information of providers near an indicated location (e.g., zip code). The interface may provide widgets or tools for a consumer to arrange an interview, add the provider to a trust network, etc. In some embodiments, the interface may provide filtering options for locating a suitable provider.

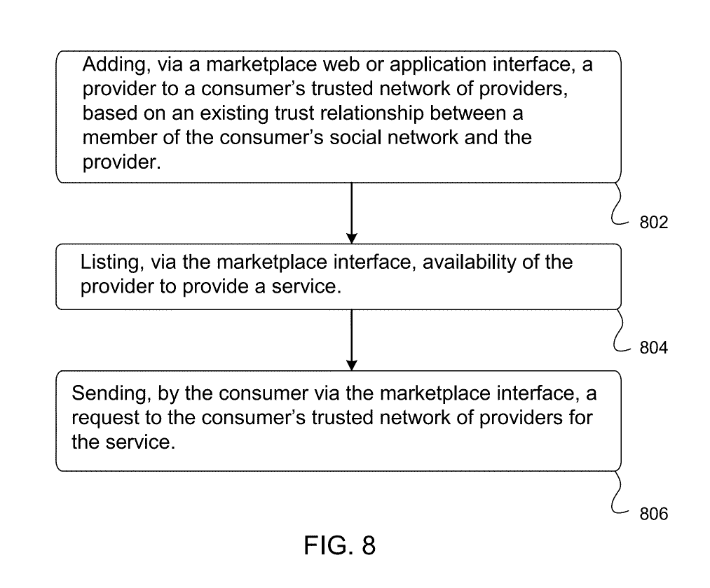

Referring now to FIG. 8, one embodiment of a method for matching a consumer to a provider is depicted. In brief summary, the method includes adding, via a marketplace web interface, a provider to a consumer's trusted network of providers, based on an existing trust relationship between a member of the consumer's social network and the provider (802). The marketplace web interface may indicate availability of the provider to provide a service (804). The consumer may send a request to the consumer's trusted network of providers for the service via the marketplace web interface (806).

Referring to (802), and in further details, a marketplace web interface may provide a directory and/or information about potential providers for a service. The consumer may search and/or locate providers near the consumer, for a specific service. The marketplace web interface may provide a listing of providers, which may be filtered according to specific attributes specified by the consumer. In some embodiments, the marketplace web interface may provide a listing of providers trusted by the consumer, a listing of providers trusted by entities related or affiliated to the consumer (e.g., social network friends), and/or a listing of providers that has not established trust with entities related or affiliated to the consumer (e.g., providers geographically proximate to the consumer). The marketplace web interface may provide information about potential providers, such as background check information, reviews/ratings, experience, certification, specific trust relationship with a person the consumer knows, etc. Based at least in part on the information provided by the marketplace web interface, the consumer may request for an interview with the provider. Based at least in part on the information provided by the marketplace web interface, the consumer may add the provider to the consumer's network of trusted providers. Based at least in part on an interview (e.g., conducted via the marketplace web interface), consumer may add the provider to the consumer's network of trusted providers.

In further details of (804), the marketplace web interface may list availability of the provider to provide a service. The provider may indicate his/her availability via the marketplace web interface. The marketplace web interface may track and/or update the provider's availability based on transactions (e.g., bookings) arranged via the marketplace web interface. The provider may indicate availability through the marketplace web interface to solicit requests for service by consumers. The marketplace web interface may list availability of the provider at a particular time slot as available (e.g., yes), usually available (e.g., perhaps or maybe), and not available (e.g., no). The marketplace web interface may provide a calendar of the provider to potential consumers. A consumer may request to view the calendar and/or availability of the provider through the marketplace web interface.

Referring now to (806), the consumer may send a request to the consumer's trusted network of providers for the service via the marketplace web interface. The consumer may send a request in part based on viewing one or more provider's availability. The consumer may send a request to one or more providers in the consumer's trusted network of providers. The consumer may select one or more channels to the send the request. Examples of channels include a coop, providers trusted by the consumer, and providers trusted by entities related or affiliated to the consumer (e.g., a social networking friend or a coop member). The marketplace web interface may send the request to providers and/or channels indicated by the consumer. The marketplace web interface may send the request to providers that are available for requested service time slot.

In some embodiments, one or more providers may receive and/or respond to the request with an offer. One or more may receive and/or reject to the request via the marketplace web interface. The consumer may receive one or more offers to the request. The consumer may review information about the providers that responded with offers. The consumer may select, via the marketplace web interface, one of the providers that responded. The consumer may accept, via the marketplace web interface, one of the offers. The marketplace web interface may send a notification to the selected provider and/or the consumer to confirm a booking for the service. The marketplace web interface may send a reminder to the selected provider and/or the consumer prior to the time slot booked.

In some embodiments, the consumer may receive no offers from providers. The consumer may modify the request and/or extend the broadcast of the request. For example, the consumer may add more providers to the consumer's trusted network. In some embodiments, the marketplace web interface may notify a potential provider if the provider becomes available, so that the provider may respond to the request if still active. In certain embodiments, a provider may receive multiple requests from different consumers. The provider may select a request to respond with an offer via the marketplace web interface.

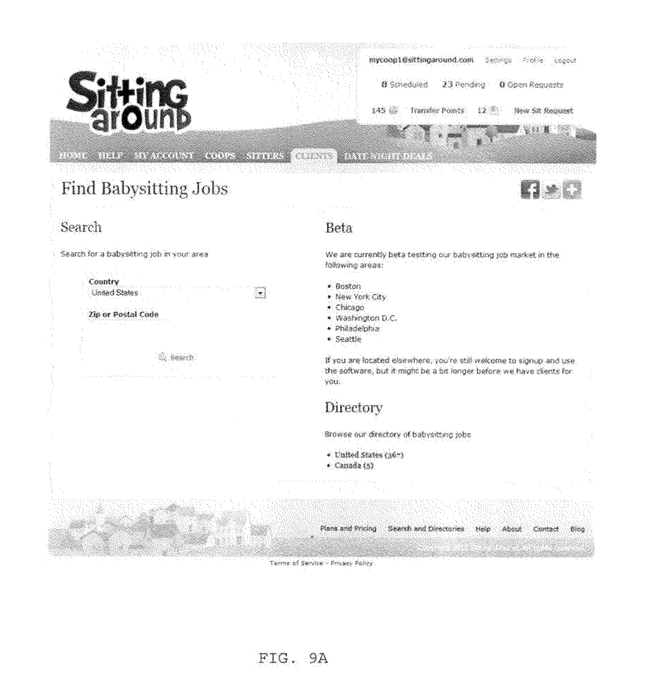

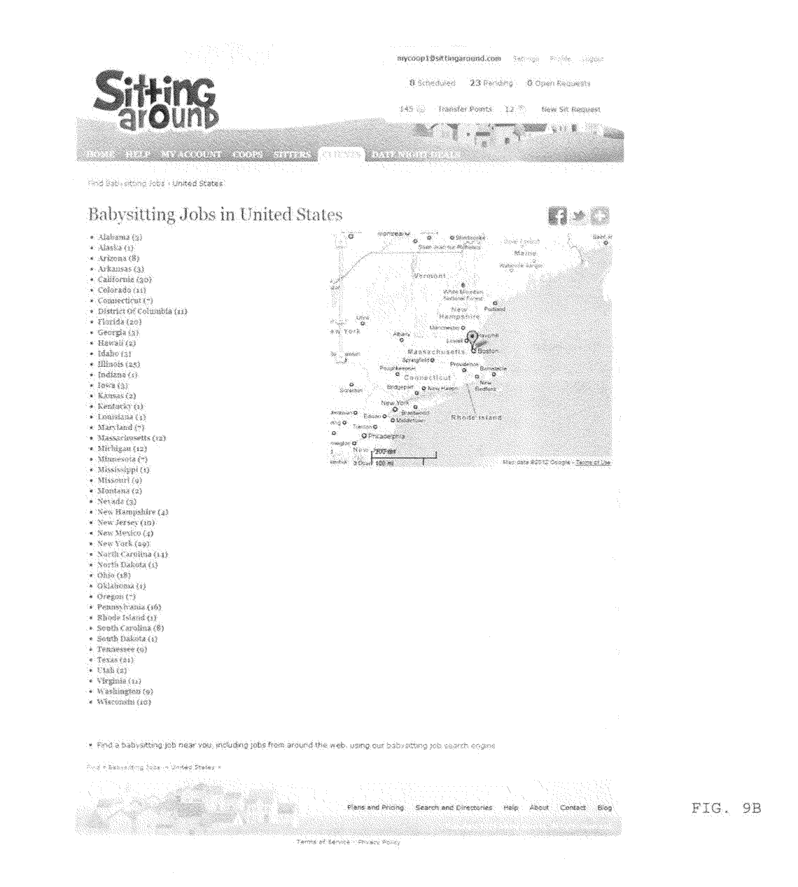

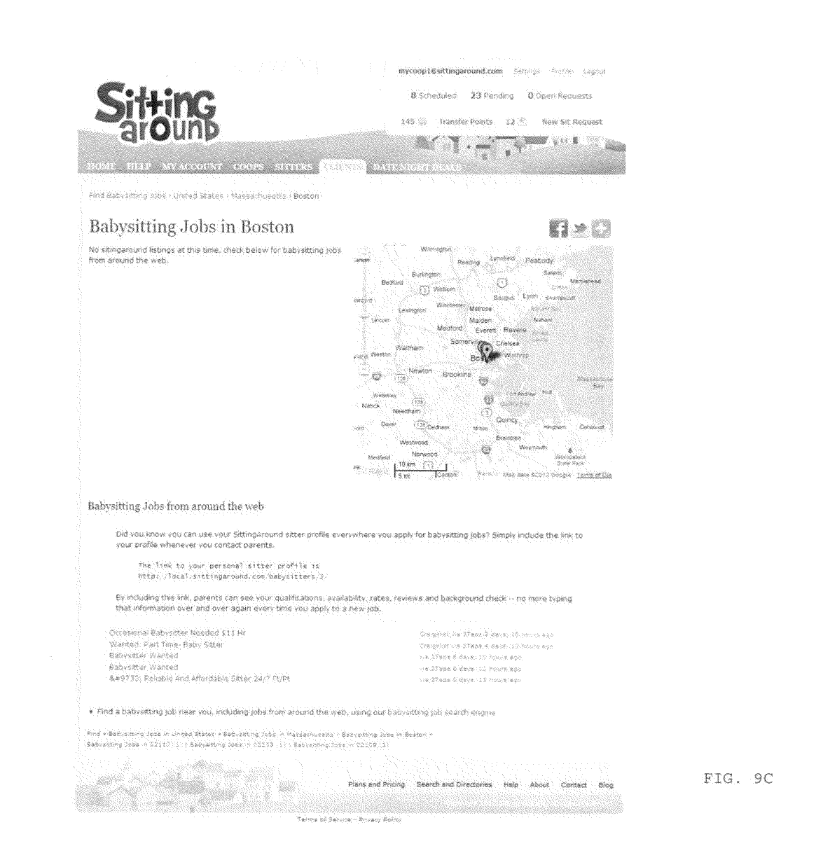

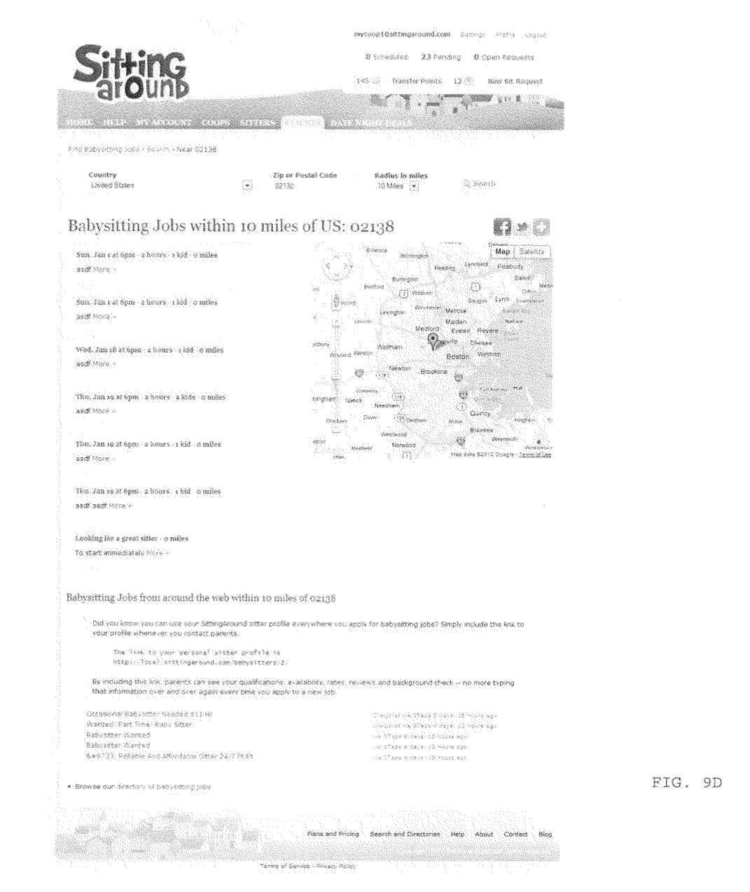

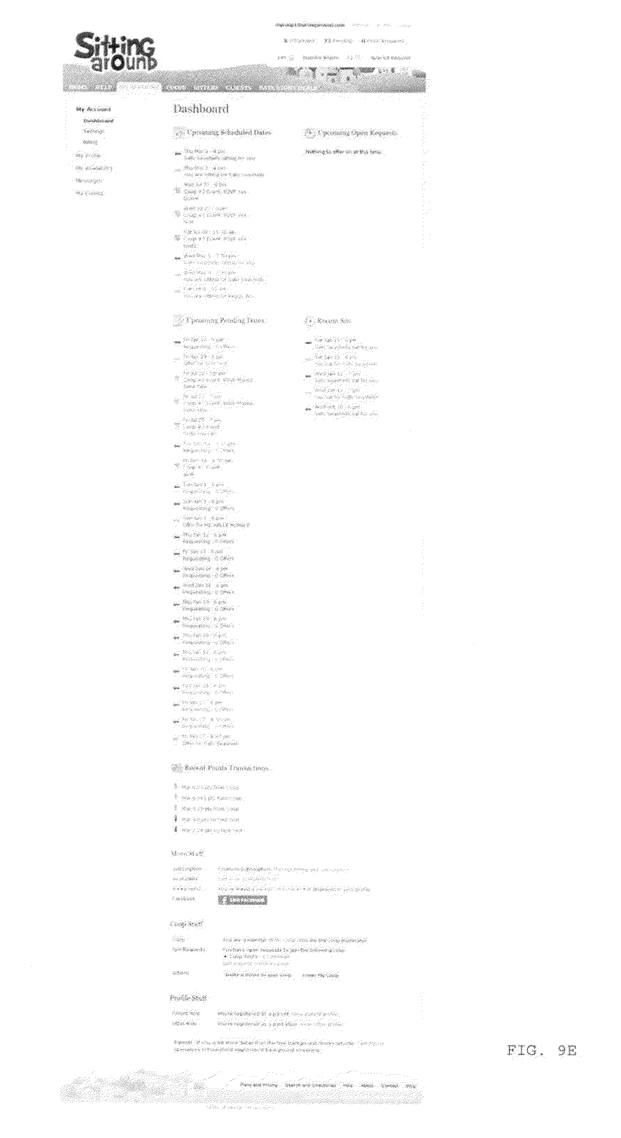

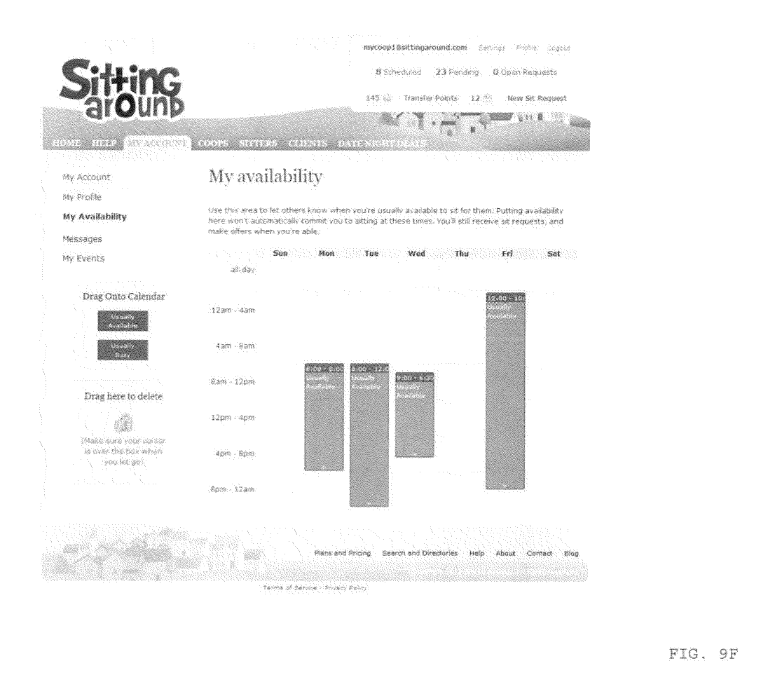

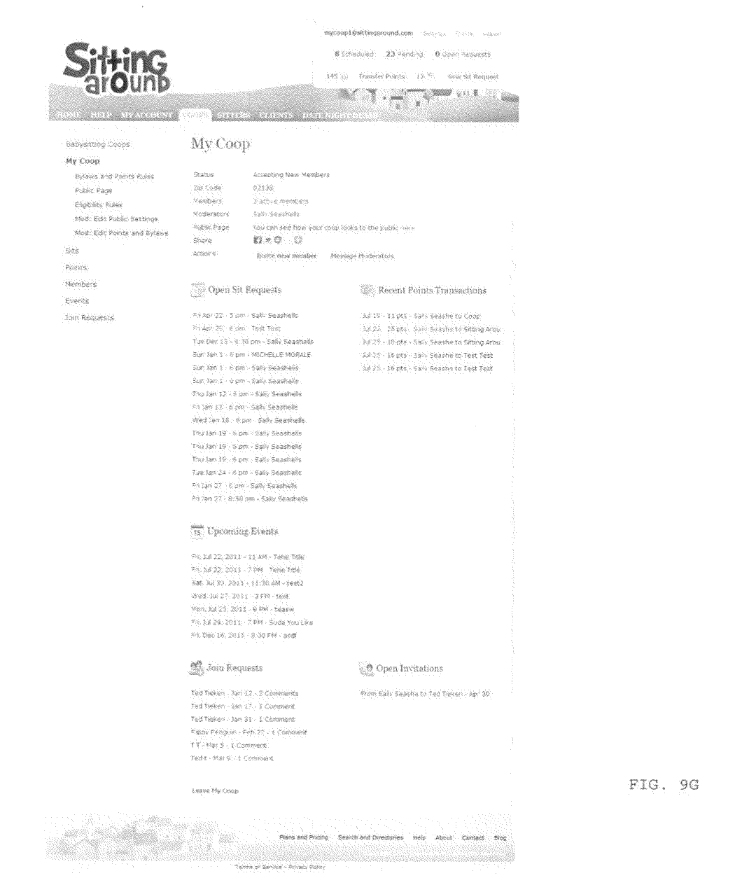

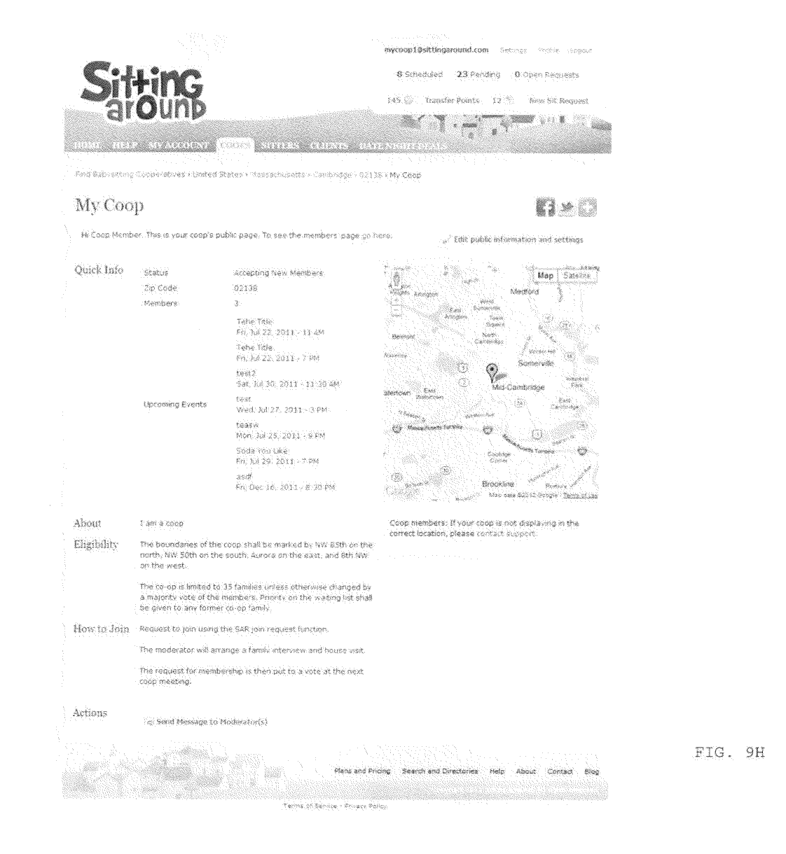

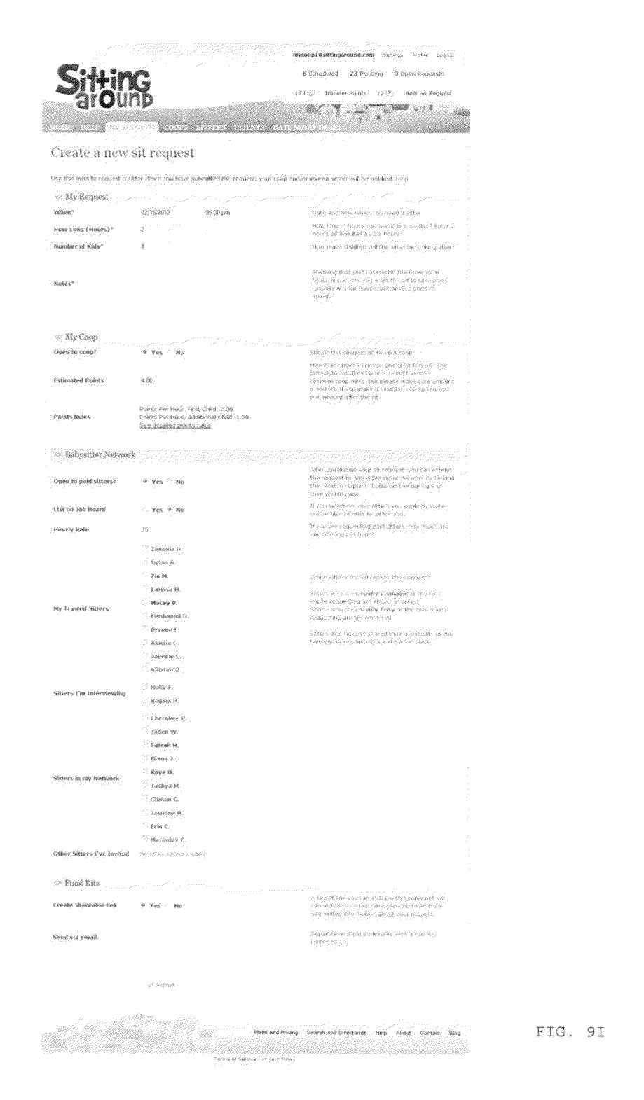

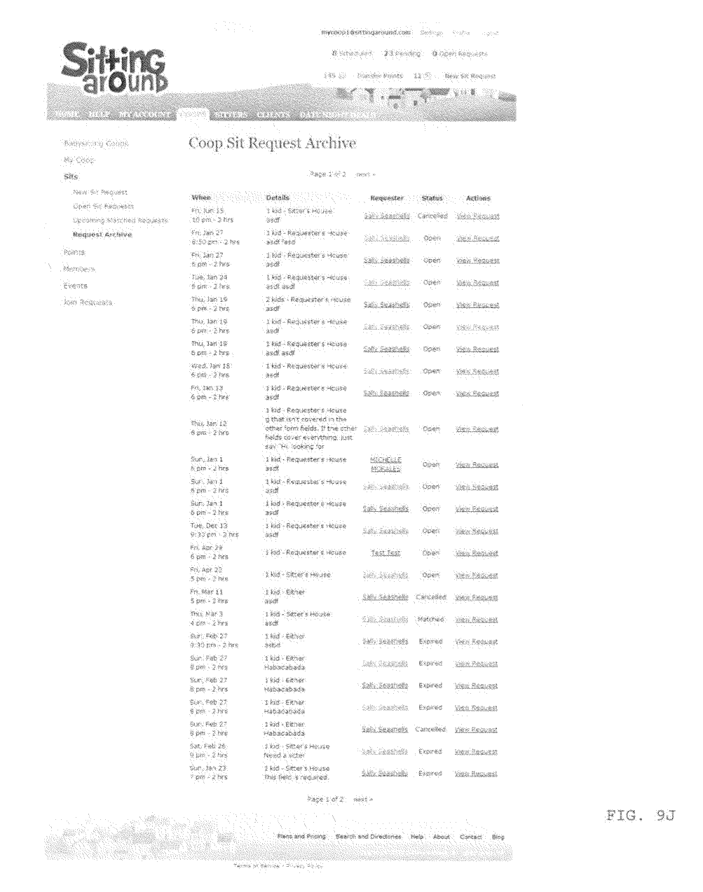

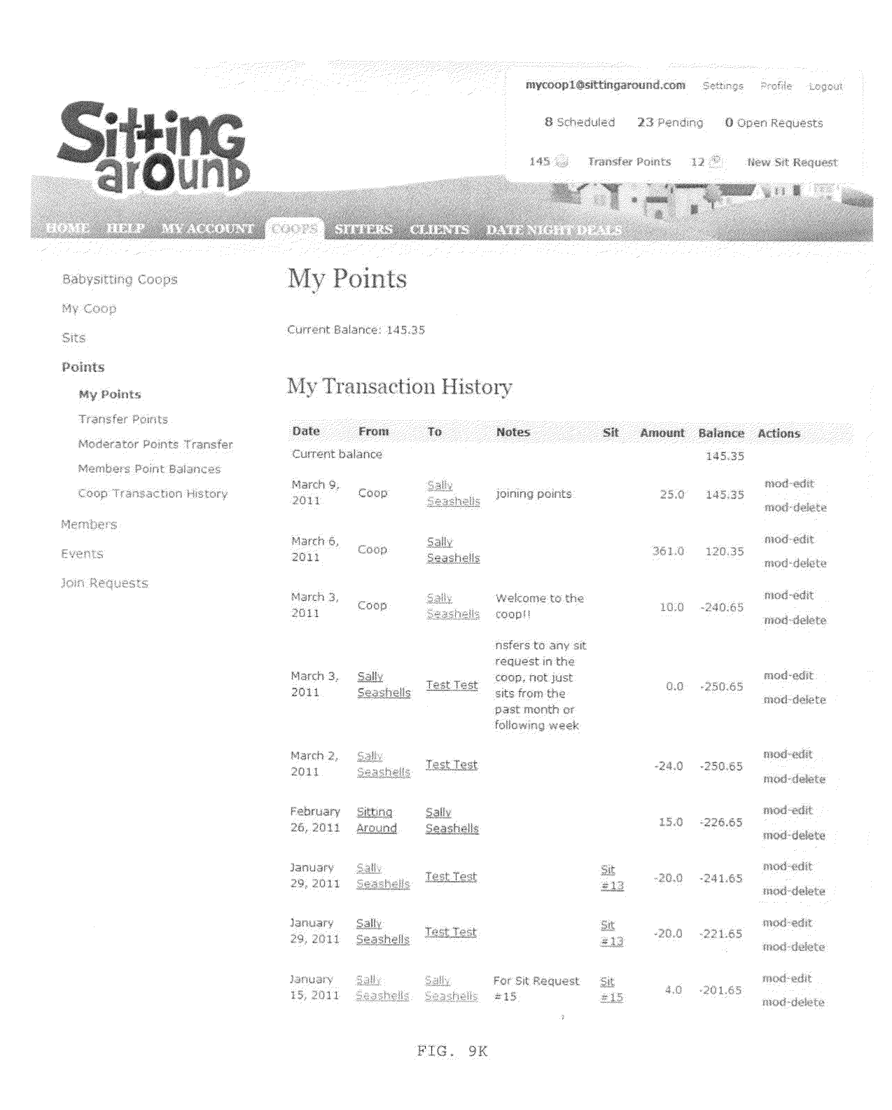

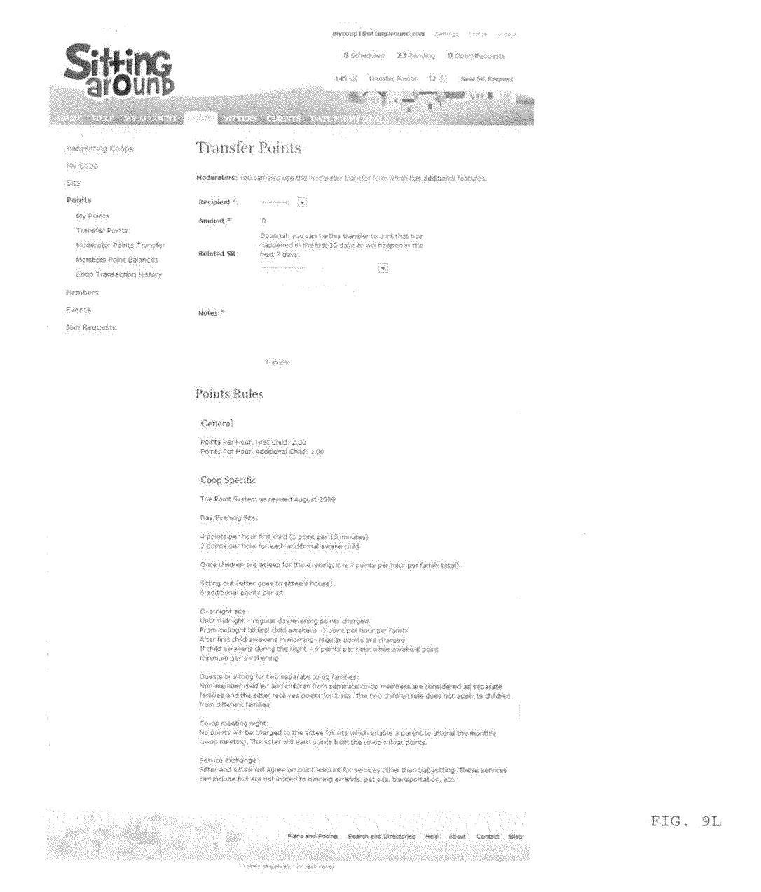

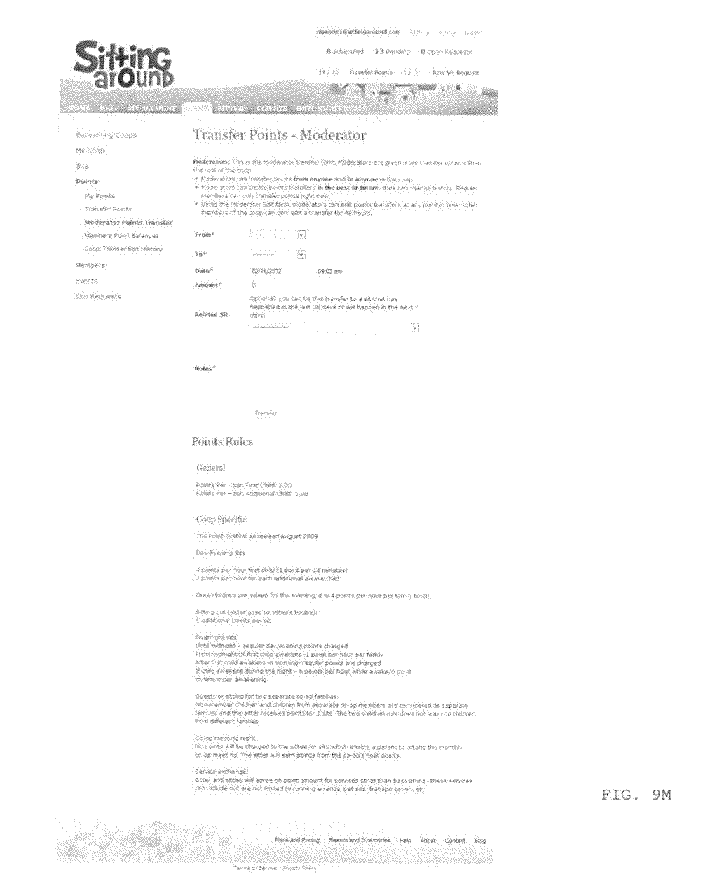

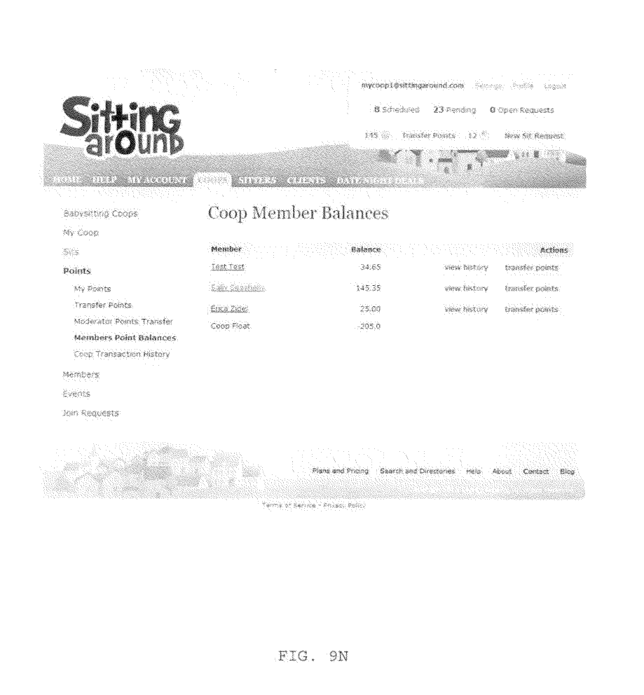

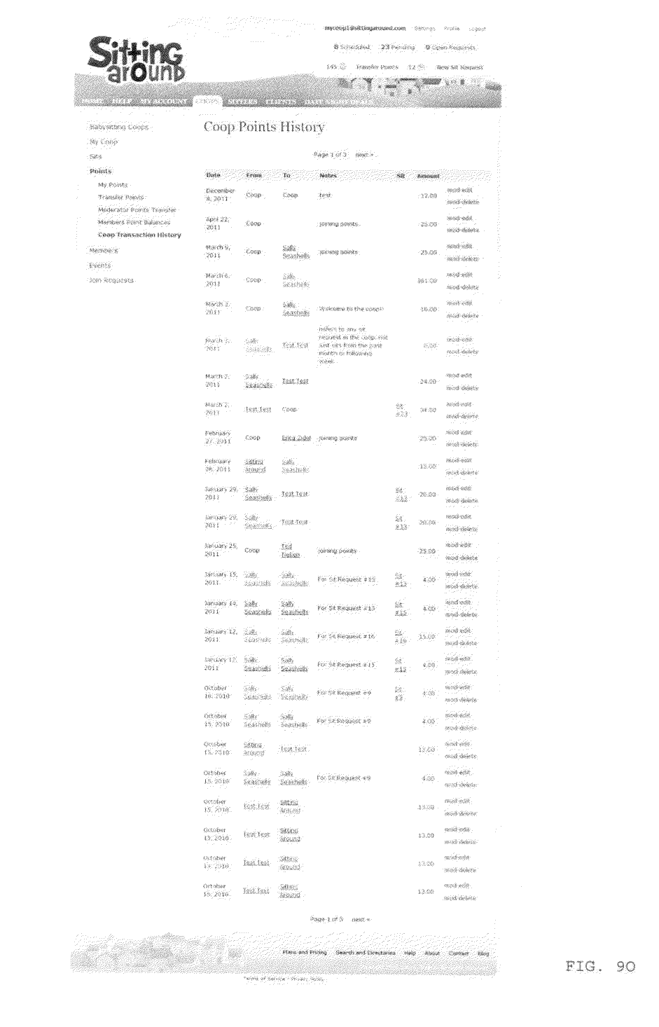

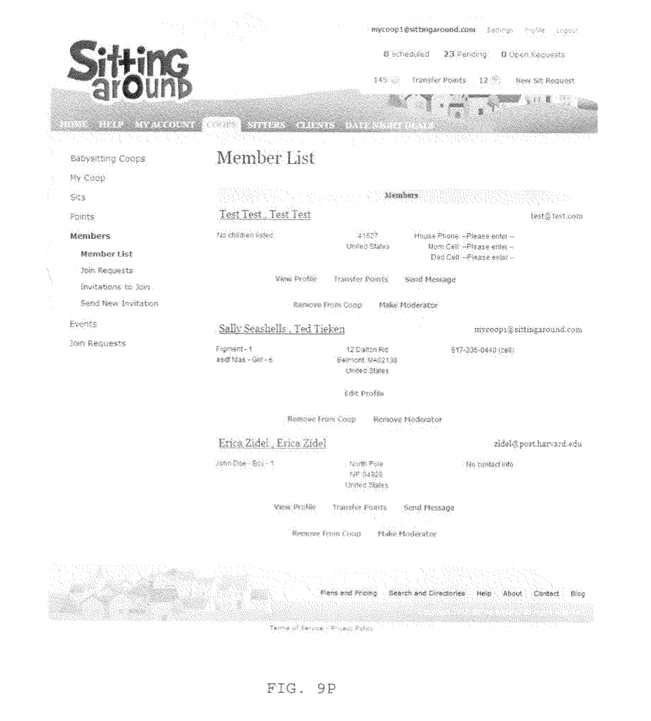

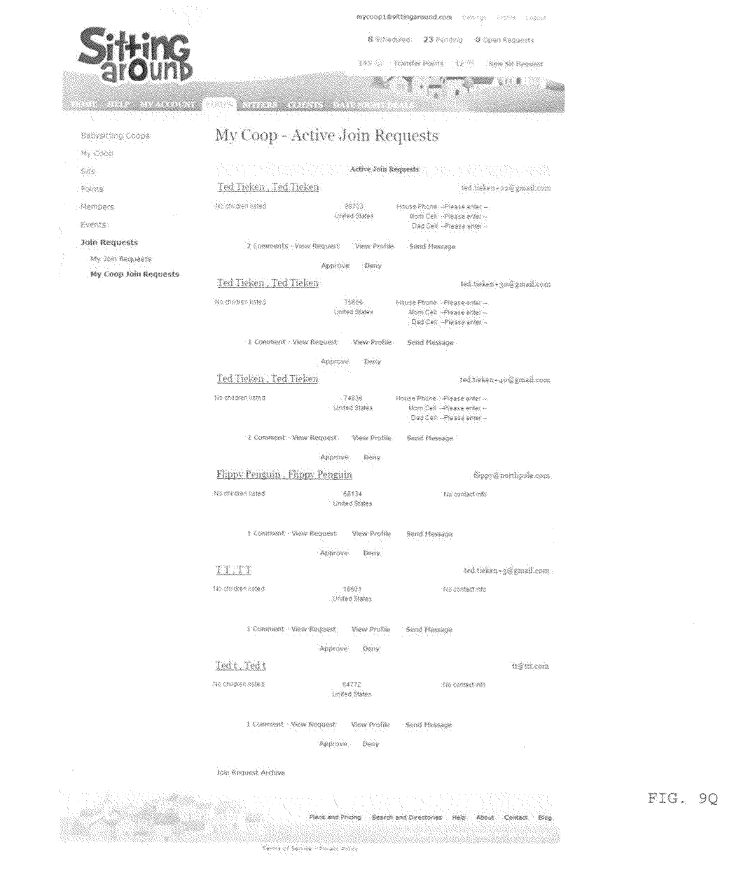

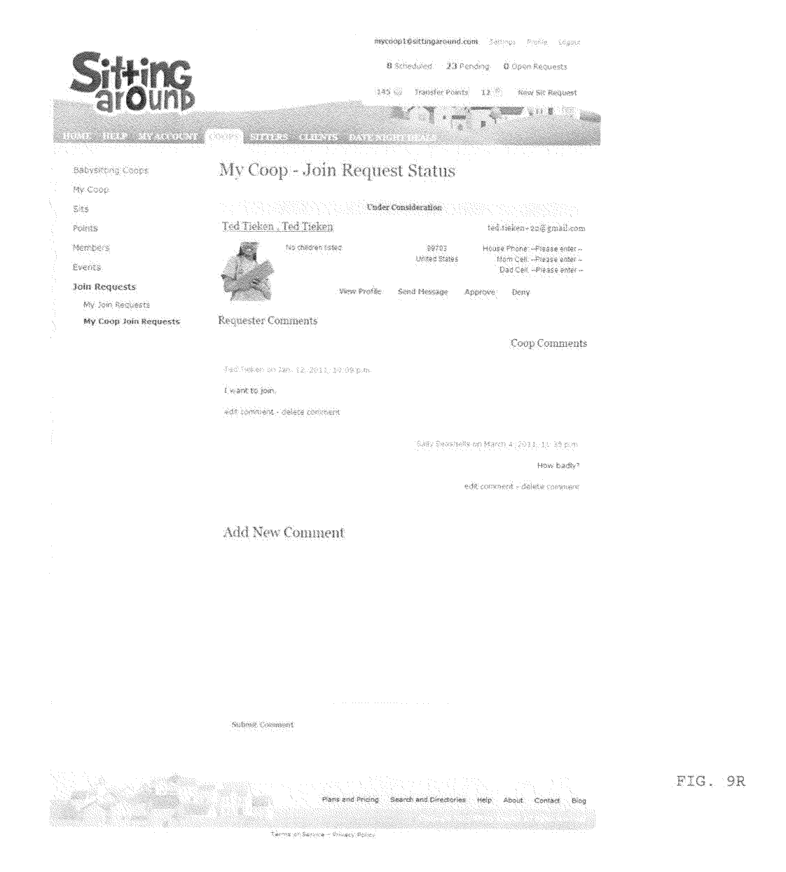

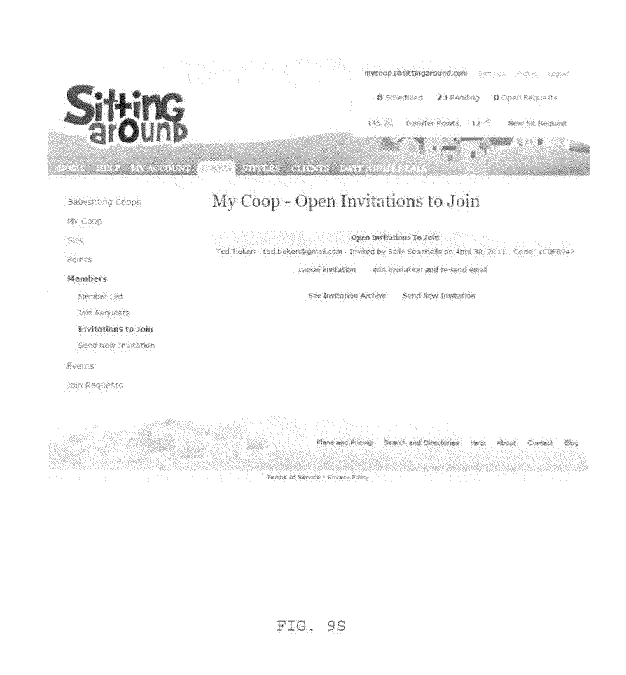

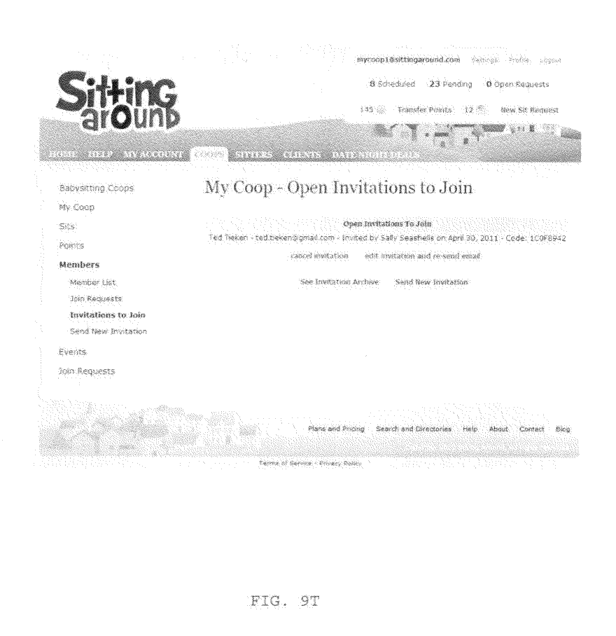

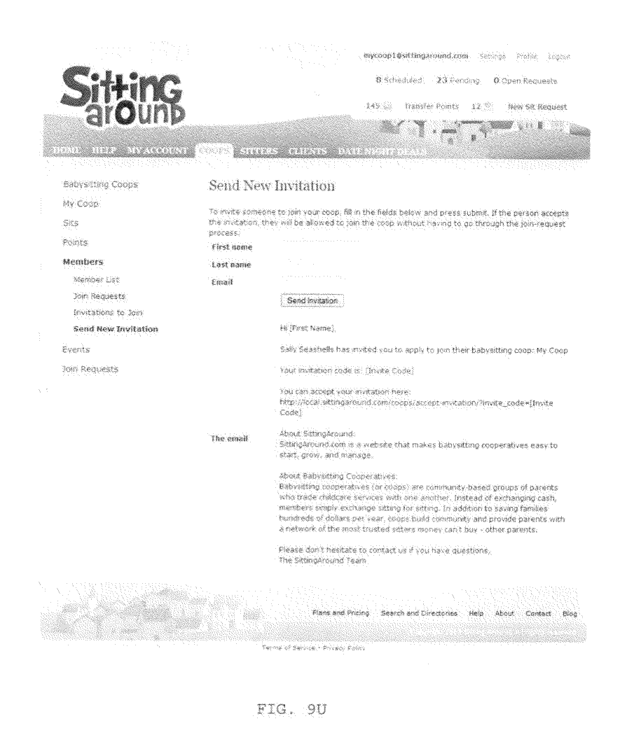

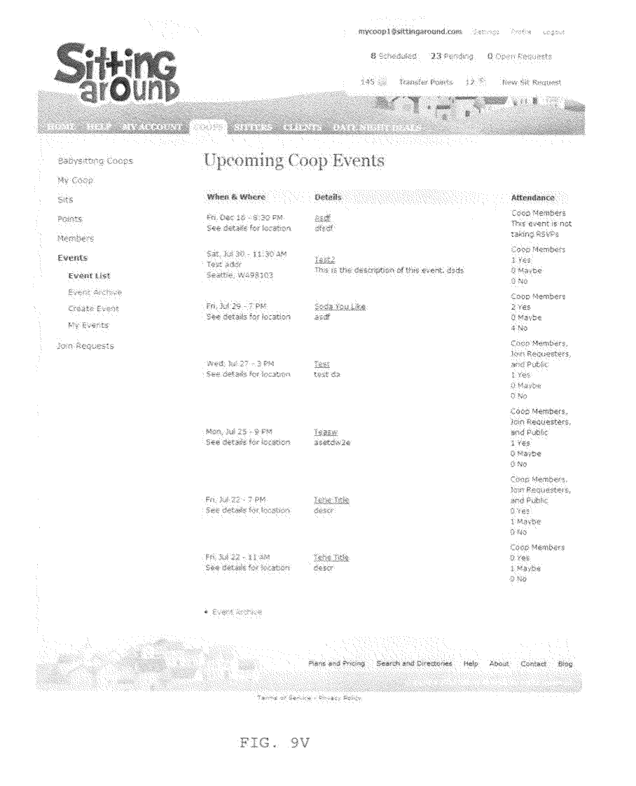

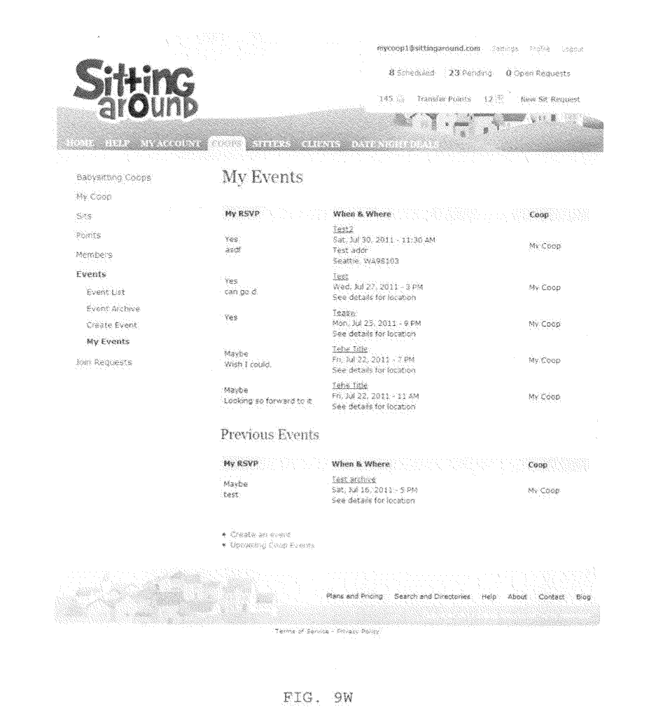

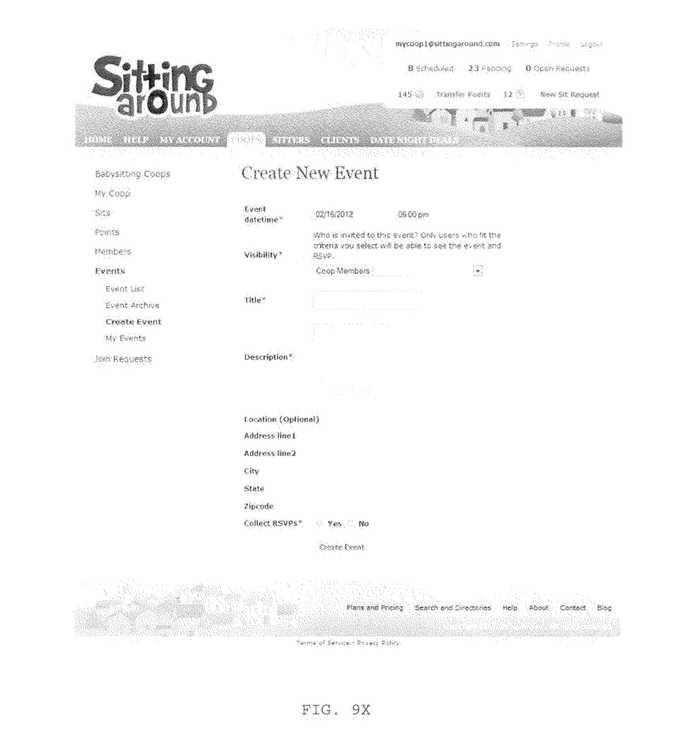

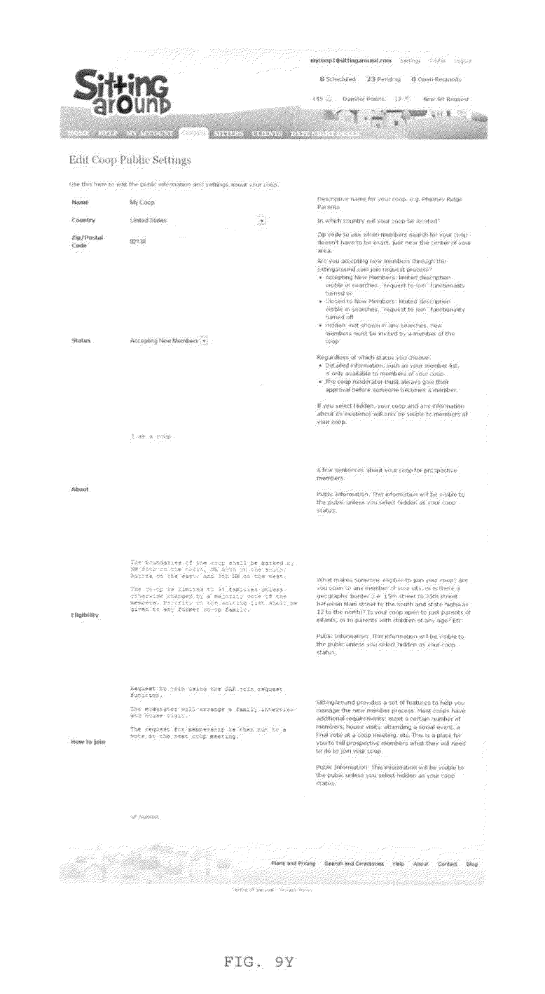

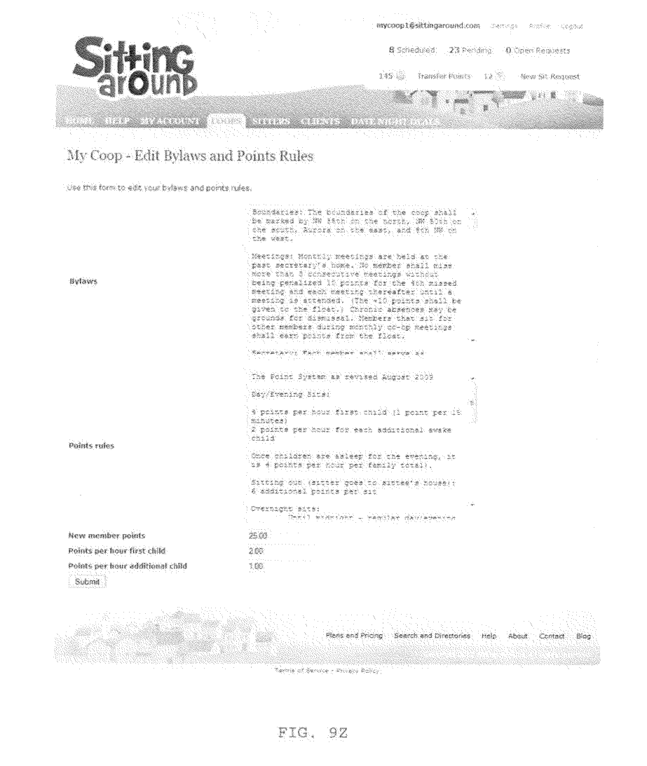

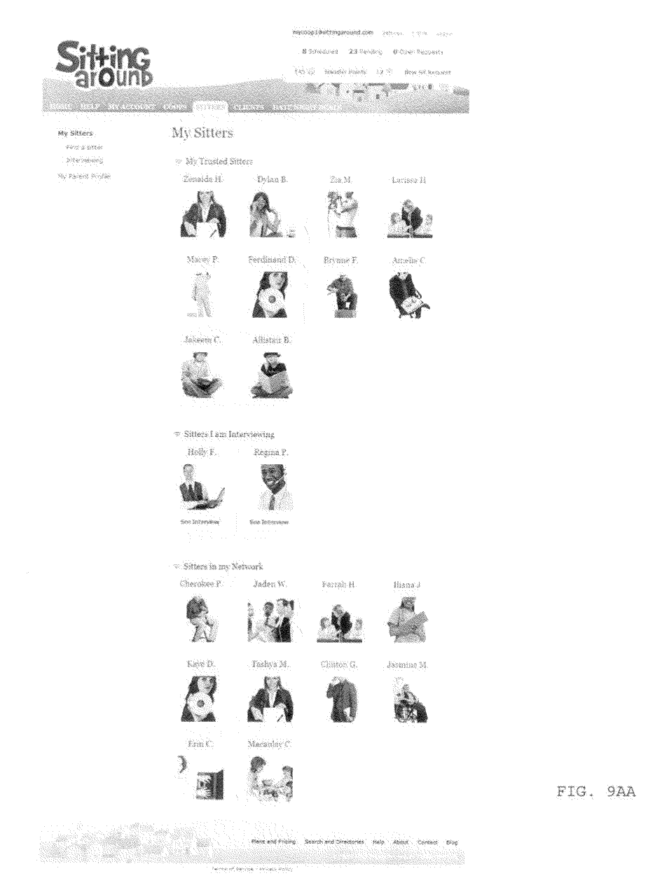

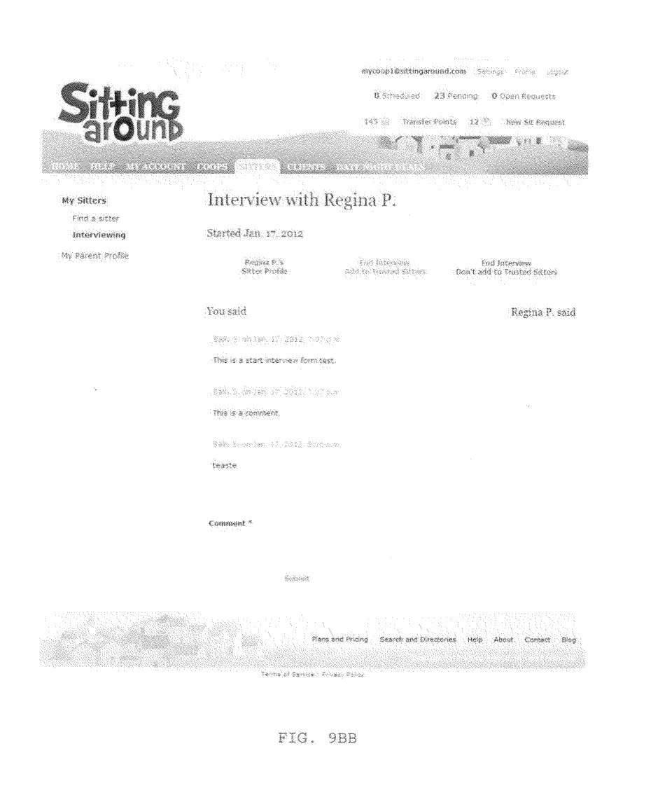

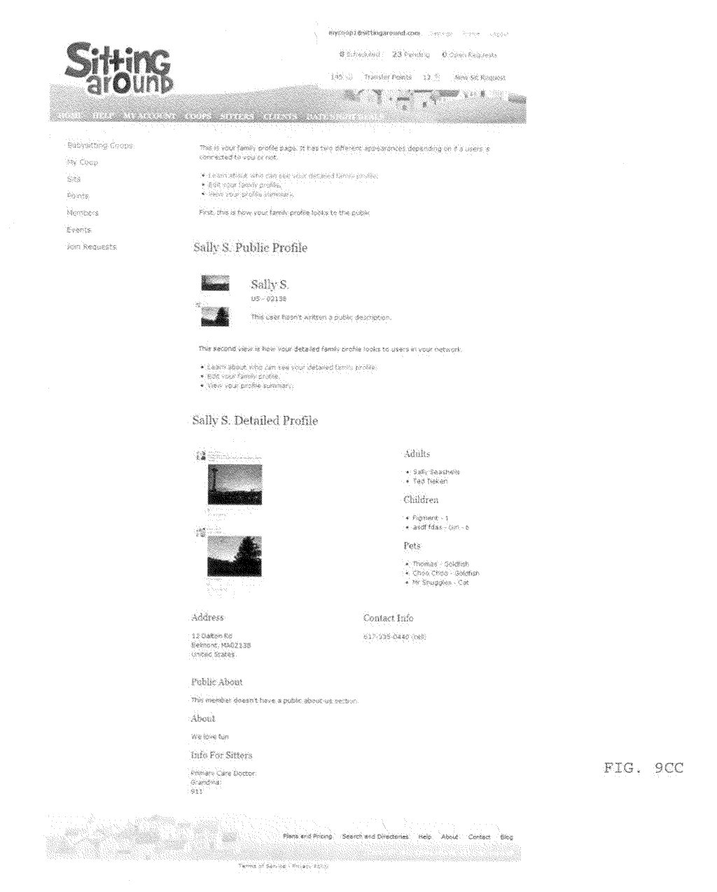

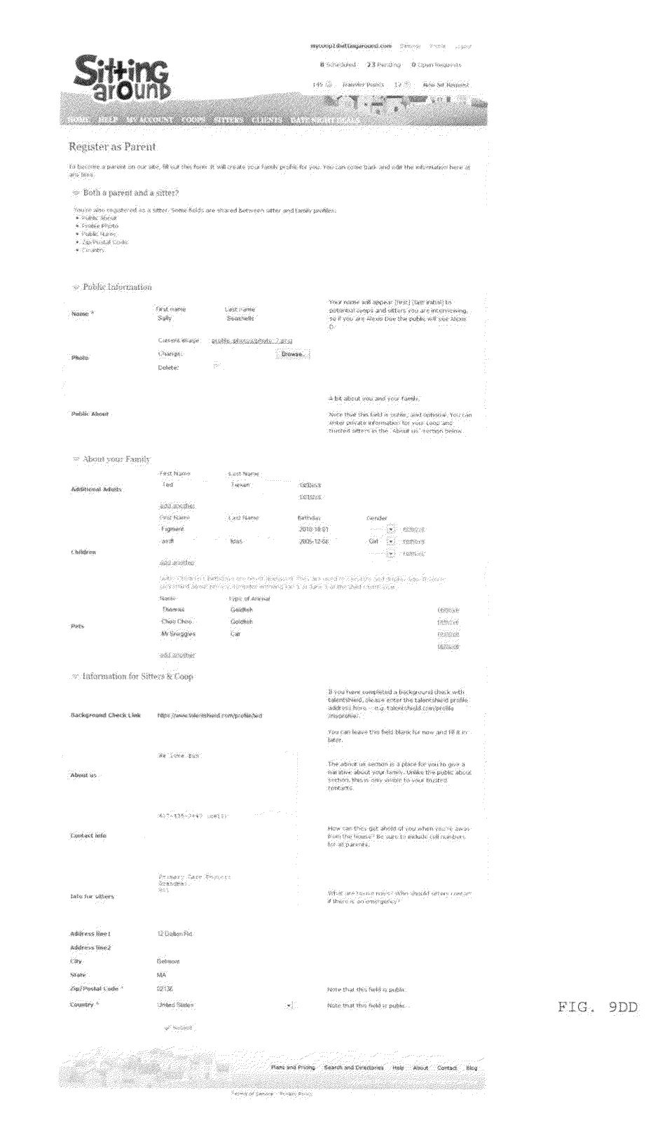

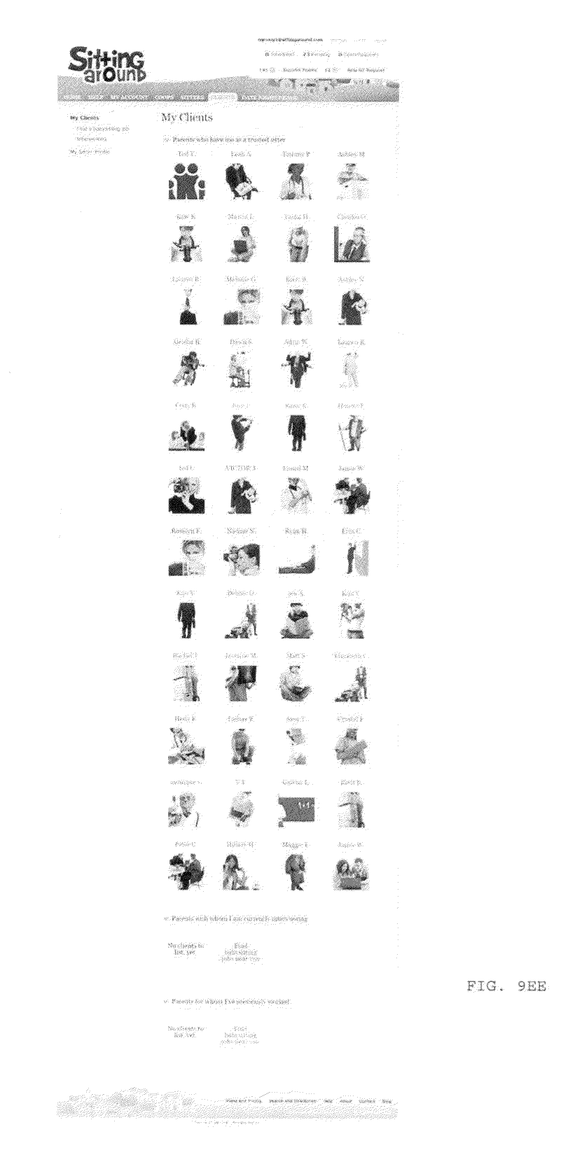

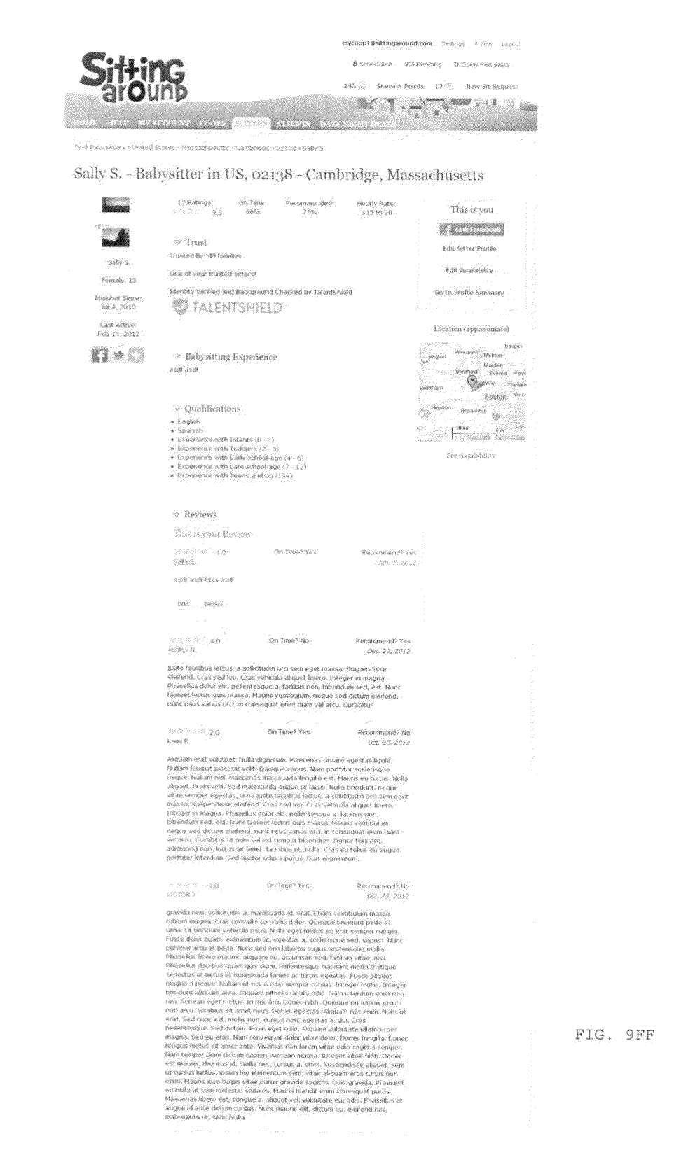

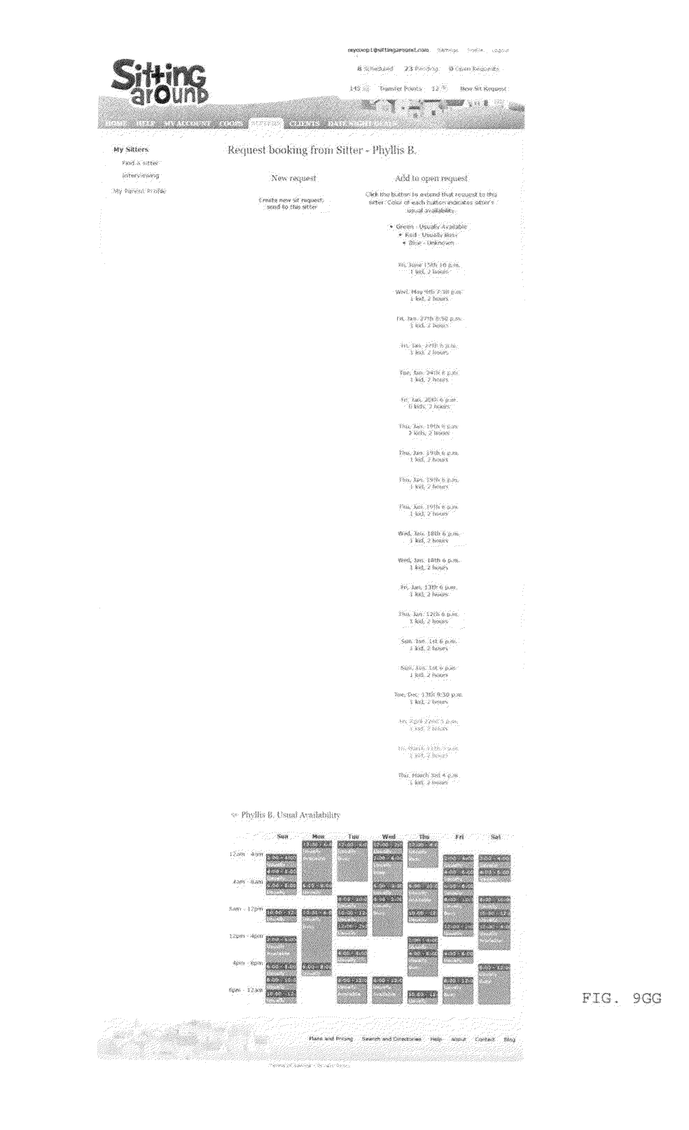

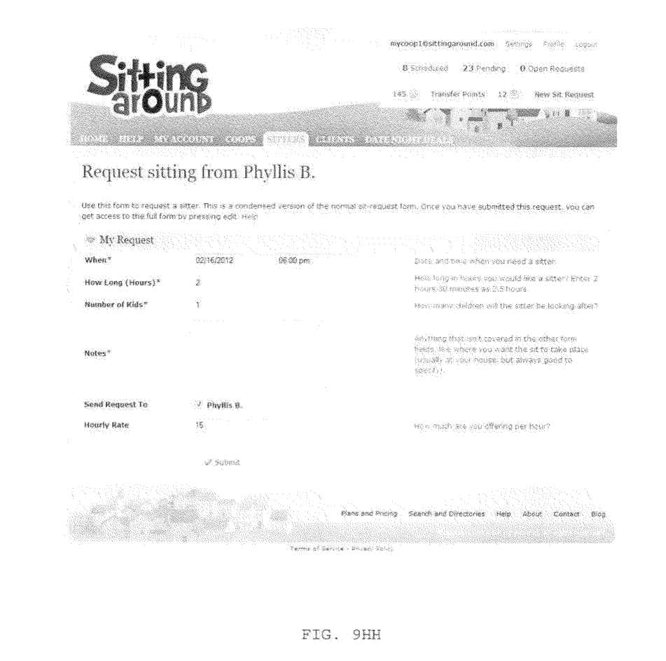

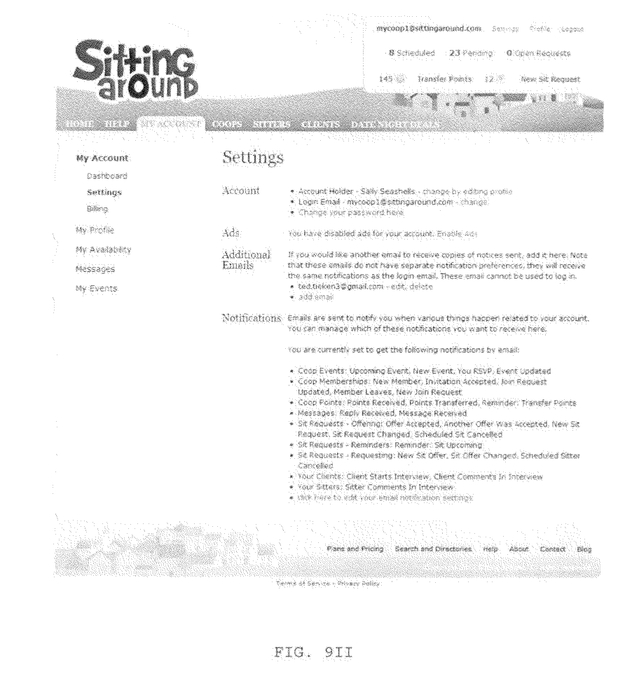

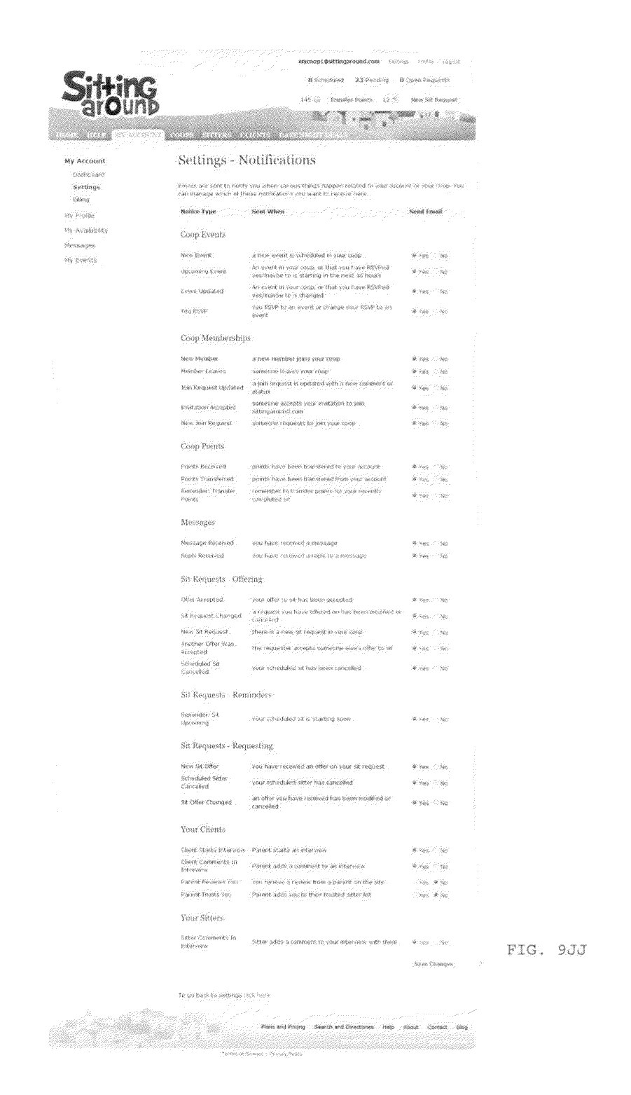

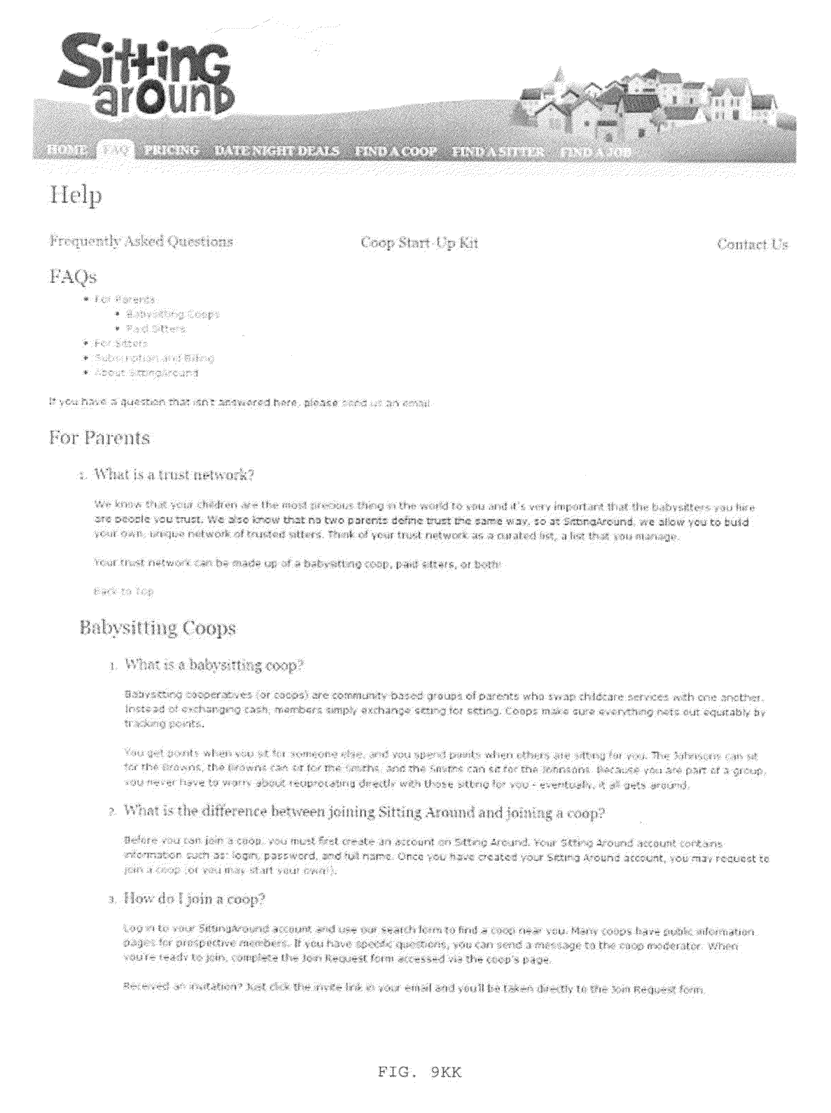

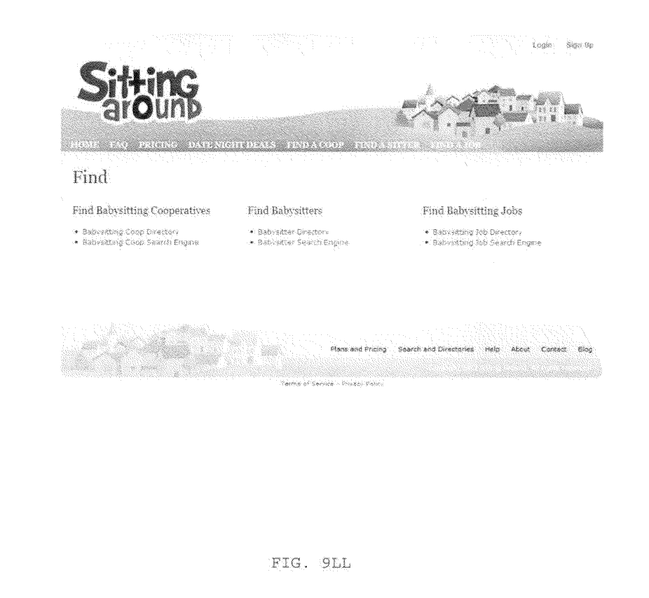

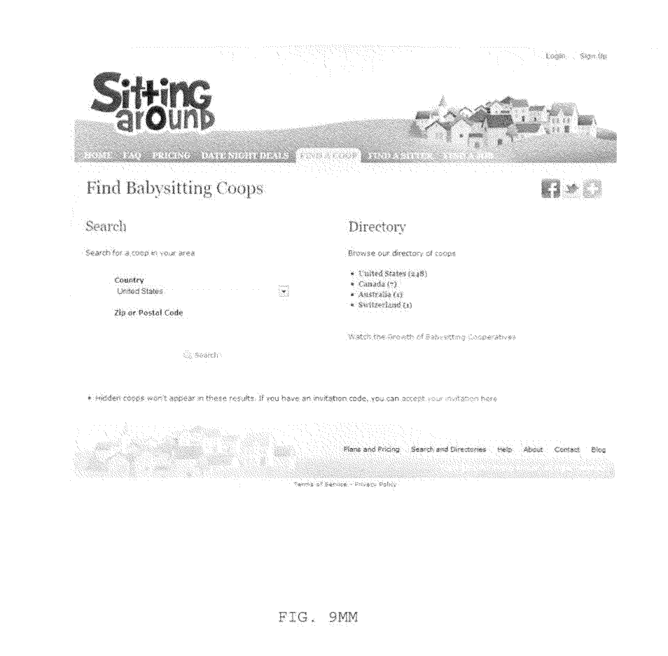

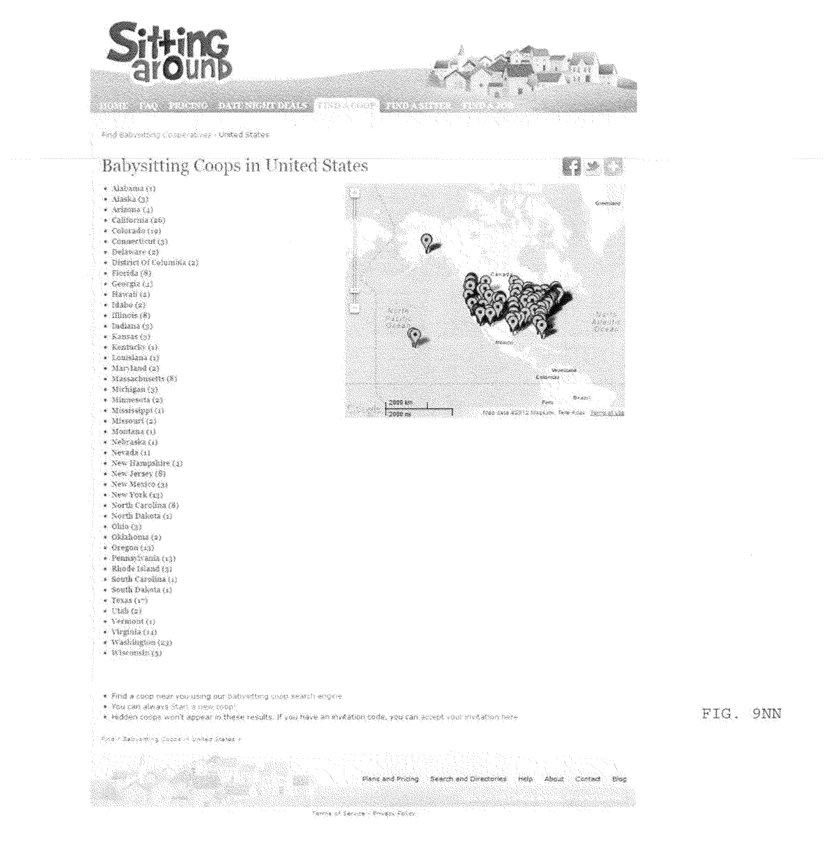

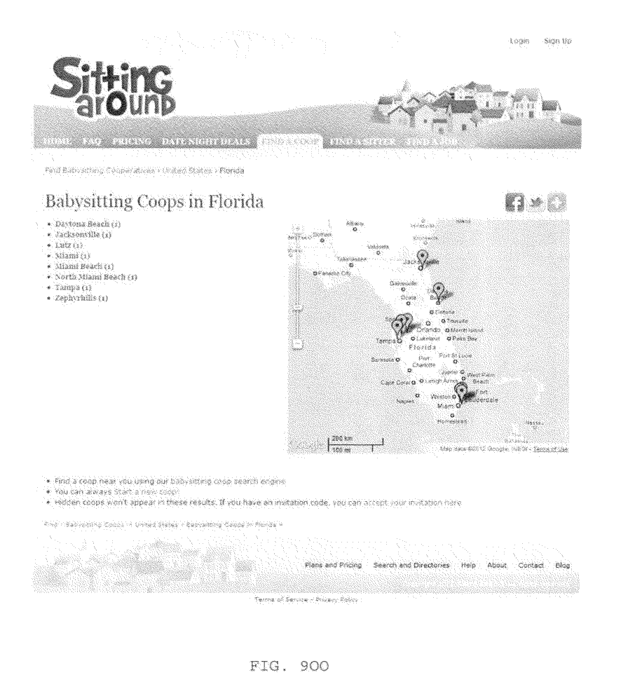

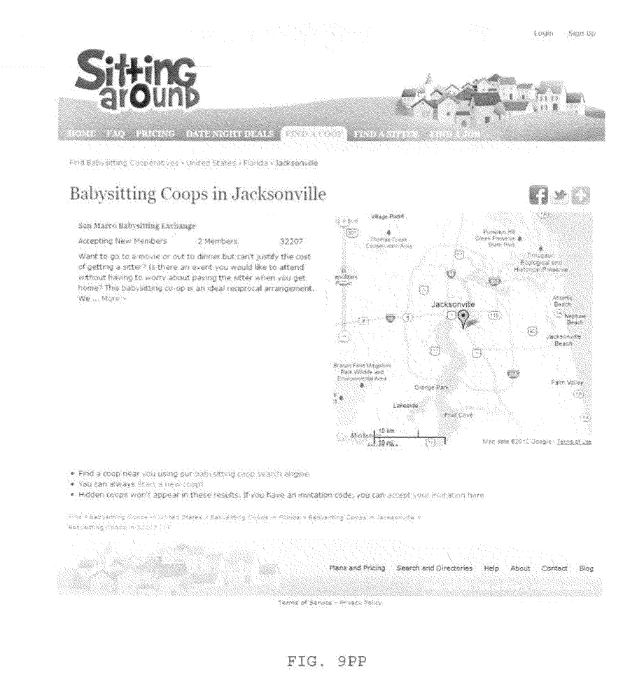

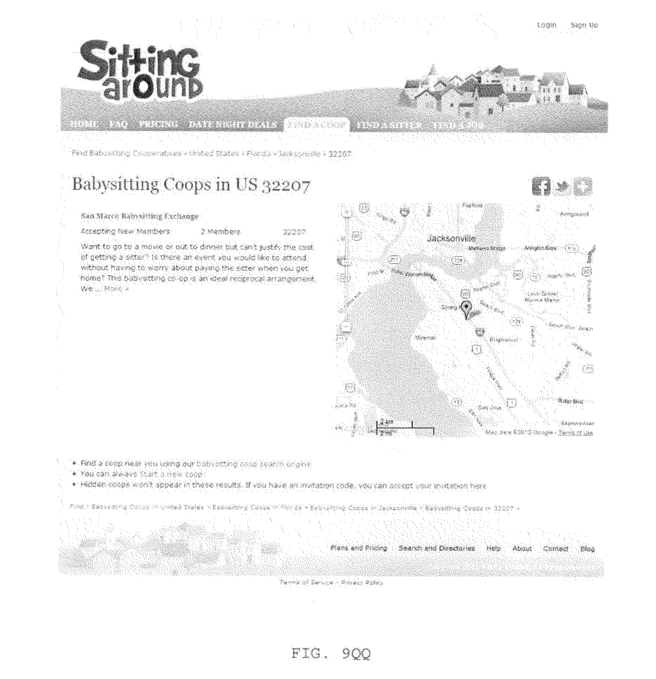

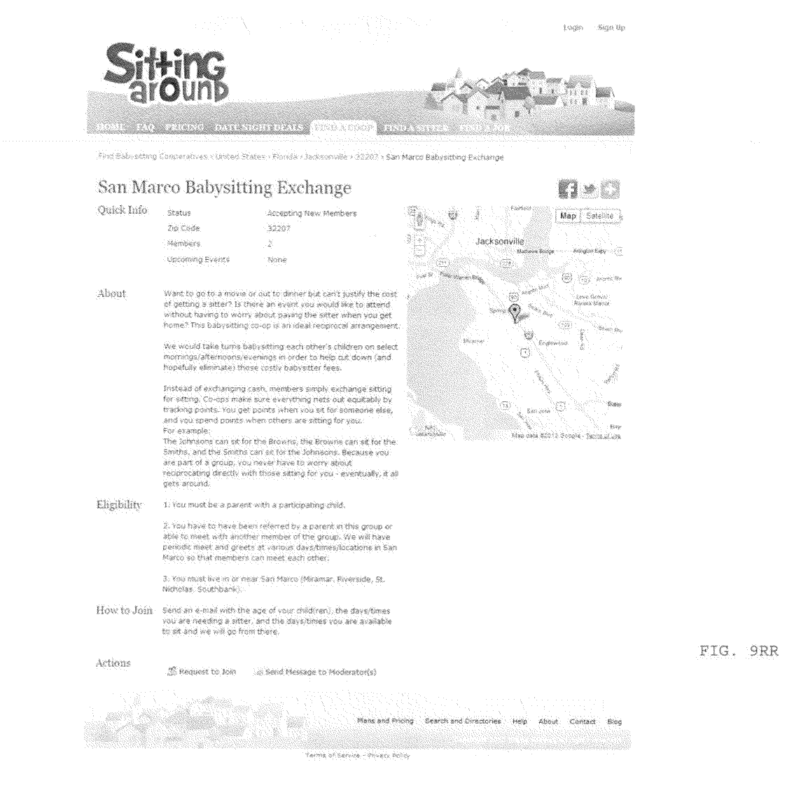

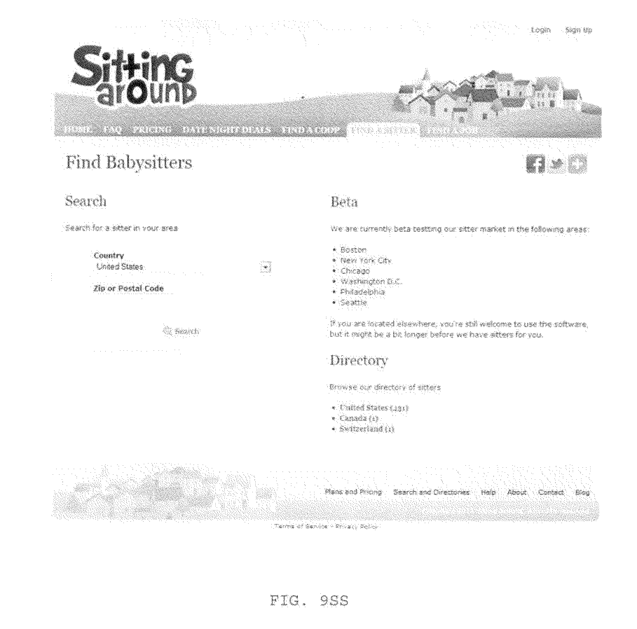

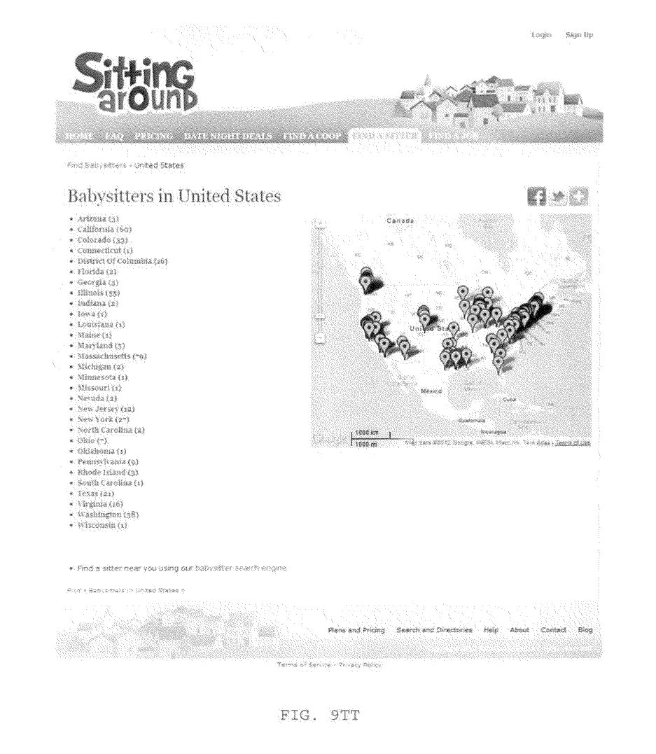

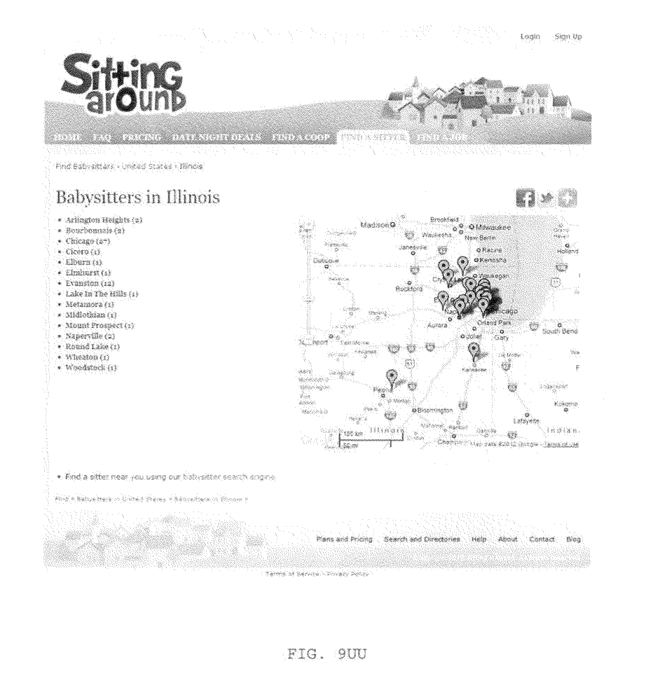

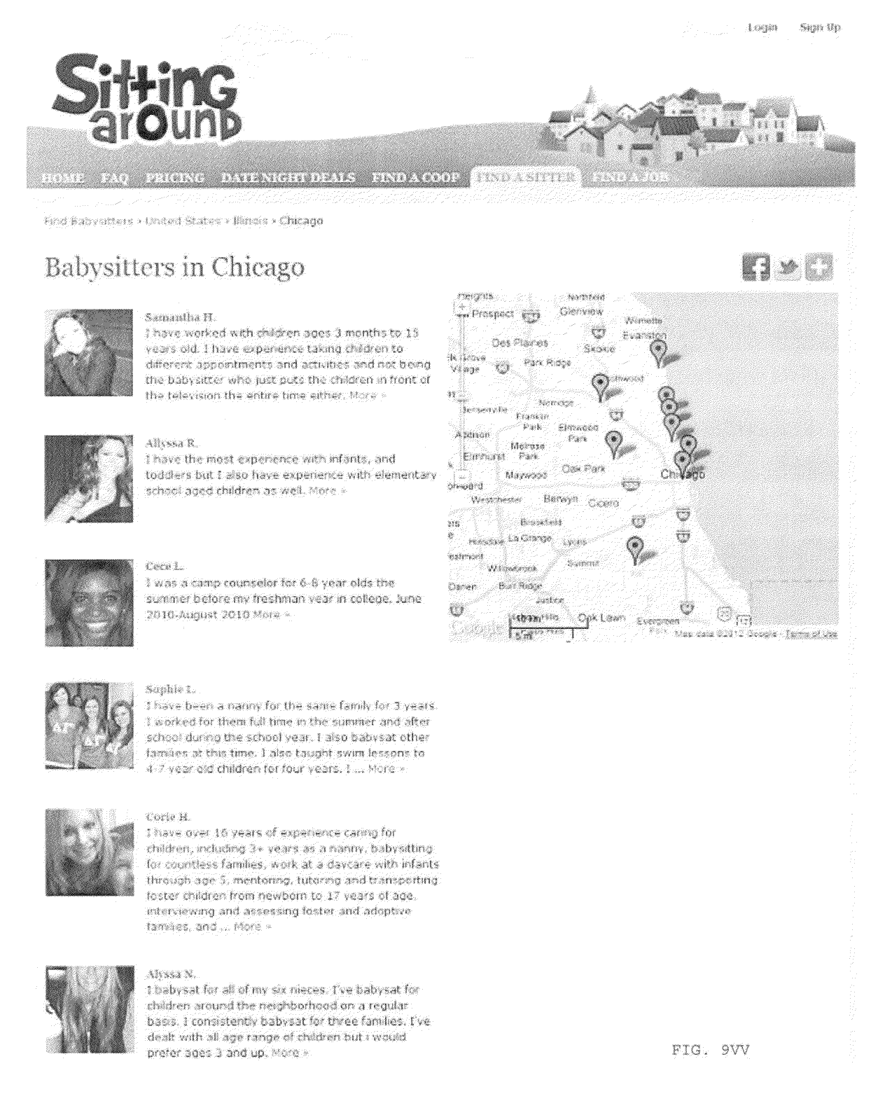

FIGS. 9A-9WW include a number of screenshots of embodiments of a web interface provided by the marketplace system. Many of these screenshots illustrates a number of the features and/or functionality provided by the system and described above.

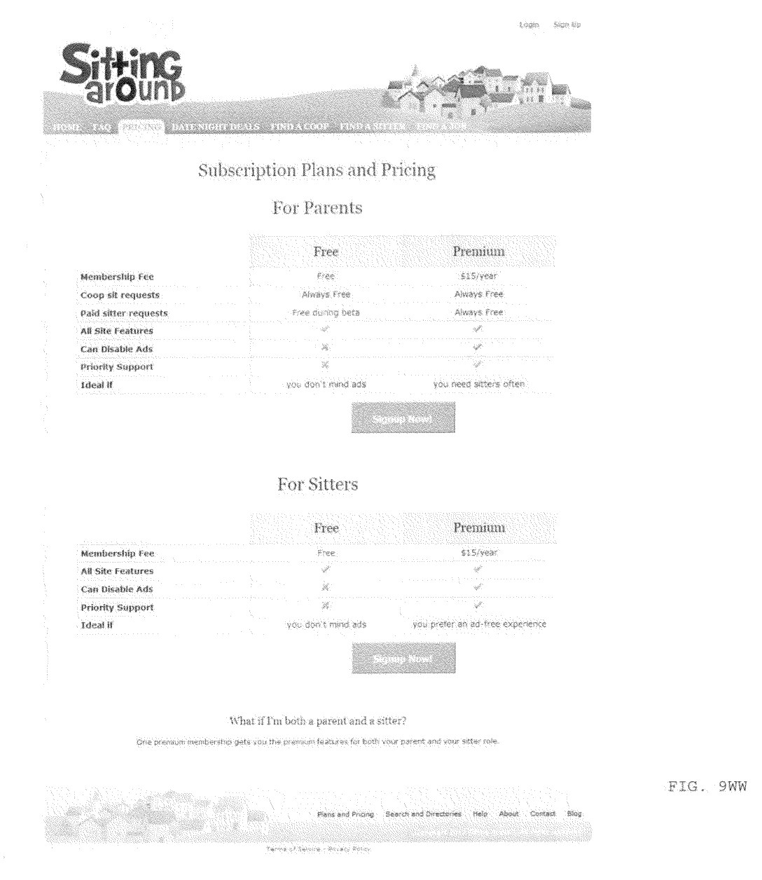

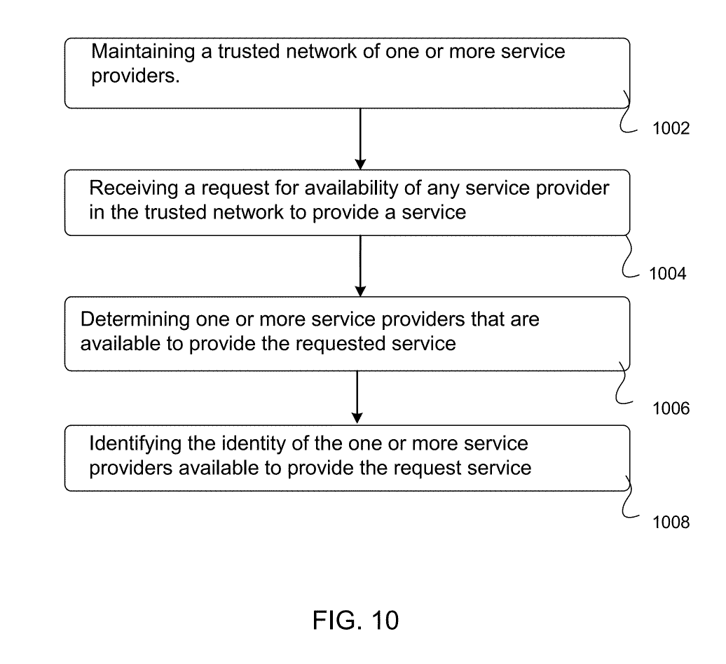

Referring now to FIG. 10, an embodiment of a method of identifying, by a consumer, a service provider via a trusted consumer network having one or more service providers is depicted. In brief overview, at step 1005, a server maintains for each consumer of a plurality of consumers, a trusted network of one or more service providers. At step 1010, the server may receive a request for availability of any service provider in the consumer's trusted network to provide a service from a consumer of the plurality of consumers. At step 1015, the server may determine one or more service providers that are available to provide the requested service via the consumer's trusted network in response to receiving the request. At step 1020, the server identifies the identity of the one or more service providers available to provide the requested service to the consumer in response to the determination.

In further details of step 1005, a server maintains a trusted network of one or more service providers, for each consumer of a plurality of consumers. Each of the trusted networks includes a relationship between each consumer and at least one service provider designated as trusted by the consumer based on at least one trust attribute.

The consumer may specify a number of trust attributes for each existing trust relationship or pathway with a provider. The system can track and maintain these attributes, so that other consumers may decide on whether to establish a trust relationship or pathway with the provider. For example, such attributes may include the level of trust, the length of the relationship, the role of the provider, how the trust relationship was established or adopted (e.g., through referrals, by reviewing ratings, by interviews), any other relationship between the consumer and provider (e.g., part of the same social network, coop, or are relatives, alumni, neighbors, etc). For example, the consumer may specify a rank or indication of the trust level, which may be adjusted from time to time, e.g., based on the provider's performance, or the number of transactions. In some embodiments, the system may make some or all of these attributes available to another consumer, which may depend on whether the latter is related to the originating consumer (e.g., via a social network). In certain embodiments, the system may calculate or generate a score based on some or all of the attributes, and may provide this score to another consumer. In some embodiments, the system or the consumer may assign or provide similar attributes for a trust relationship/pathway with another consumer or entity (e.g., coop). In some of these embodiments, a consumer may consider such attributes when considering a provider trusted by this other consumer or entity.

In some embodiments, a consumer may use reviews and/or ratings from a marketplace, website, service listing, community, social network or other source, to decide on whether to include or invite a provider or other entity into the consumer's trust network. In certain embodiments, a consumer may initiate or rely on a background check to decide whether to add a provider to the consumer's trust network. The consumer may initiate a background check on a provider via the marketplace site provided by the system. The consumer may request a background check report from a provider (e.g., performed by an independent and/or reliable party). The consumer may request a provider for testimonials and/or recommendation letters from other consumers. The consumer may request a provider to provide references. Any of these information may be stored, updated and/or maintained by the marketplace system, and may be publicly available or accessible by request.

A consumer may leverage on existing trust for one or more providers within a coop, to extend the consumer's trust to the one or more providers. In some embodiments, a consumer or a trusted/authorized moderator may add a sitter group and/or any affiliated entity to the trust network of a coop. In some embodiments, a consumer may add a provider to the consumer's trust network after vetting, interviewing and/or utilizing the provider for a service. A consumer may add a provider of a particular service to the consumer's trust network for another (e.g., different or related) service. For example, the consumer may trust the provider for childcare services, and may extend the trust to the same provider for pet-sitting services.

At step 1010, the server may receive a request for availability of any service provider in the consumer's trusted network to provide a service from a consumer of the plurality of consumers. In some embodiments, the service provider can provide any one of a babysitting service, a housekeeping service, a home improvement service, a maintenance service, a medical care service, a child care service, a coaching service, an educational tutoring service or other inhouse service. In some embodiments, the request can indicate a type of service, a time of service, a location of service, a duration of the service and a maximum price the consumer is willing to pay for the service. The consumer may submit the request via a web interface provided by the server.

At step 1015, the server determines one or more service providers are available to provide the requested service via the consumer's trusted network in response to receiving the request. In some embodiments, the server identifies the availability of each of the service providers in the consumer's trusted network that is capable of providing the service. In some embodiments, the server identifies the availability by accessing a schedule of the service provider. Via the schedule of the service provider, the server can identify if the service provider is available or possibly available to provide the service requested by the consumer. In some embodiments, the server can maintain, store or manage a schedule of each of the service providers in the consumer's trusted network. The schedules may be saved in a database accessible by the server. A service provider can create, manage and update their own schedule. The service provider can keep their schedule private such that consumers or other service providers cannot identify the service provider's availability. In some embodiments, the service provider can elect to make their schedule available to the public. In some embodiments, the service provider can limit access to their schedule available to one or more consumers or service providers. For example, the service provider can elect to make their schedule accessible for viewing only to consumers that have included the service provider within their trusted network.

In some embodiments, the server can receive an offer to perform the service from one or more of the service providers. In some embodiments, one or more of the service providers can send the offer in response to receiving a request for availability from the server. In some embodiments, the server can provide the offers received from the one or more service providers to the consumer. In some embodiments, the server can also provide the identity of the service provider from whom the offer was received to the consumer along with the offer. In some embodiments, the server can identify one or more other consumers within the consumer's trust network that have trust networks to which one or more of the service providers belong. In some embodiments, the server can provide the offers received from the one or more service providers along with the identities of the one or more other consumers in whose trust network the service provider belongs and an indication that the service provider providing the offer belongs to the trust network of the one or more identified consumers.

The server can receive an acceptance of one of the offers from the consumer. Upon receiving the acceptance of the offer from the consumer, the server can provide a notification to the service provider whose offer was accepted that the offer has been accepted by the consumer. In some embodiments, the server may provide notification to the service providers whose offers were not accepted indicating that their offer was not accepted.

In some embodiments, the server can identify one or more service providers that are within the consumer's trusted network. The server can send a request to each of the service providers capable of providing the service requested by the consumer to determine the availability of each of the service providers to provide the service. The server can then receive a response from one or more available service providers indicating that the service provider is available.

In some embodiments, the server can identify one or more additional service providers to be included within the consumer's trusted network. The server can identify the additional service providers based on one or more of the other trust attributes. For example, the server can identify additional service providers that are within a trusted network of another consumer.

At step 1020, the server identifies the identity of the one or more service providers available to provide the requested service to the consumer in response to the determination. In some embodiments, the server can identify one or more reviews of the service provider to the consumer. In some embodiments, only reviews provided by other consumers designated as trusted by the consumer based on one or more trust attributes. In some embodiments, the server can identify the identity of at least one consumer having a trusted network to which one or more of the identified service providers belong. The server can then determine that the identified consumer is a social network connection of the consumer requesting availability of one or more service providers. The server can then identify to the consumer requesting the availability that a service provider of the one or more service providers available to provide the requested service belongs to a trusted network of the identified consumer. The server can further identify that the identified consumer is a social network connection of the consumer.

In some embodiments, the server identifies a social network account of one of the identified service providers. The server can also identify at least one social network connection that is connected to both the identified service provider and the consumer requesting availability of service providers. The server then identifies the identity of the at least one social network connection and that the identified service provider is a social network connection of the identified social network connection to the consumer.

While the invention has been particularly shown and described with reference to specific embodiments, it should be understood by those skilled in the art that various changes in form and detail may be made therein without departing from the spirit and scope of the invention described in this disclosure.

While this specification contains many specific embodiment details, these should not be construed as limitations on the scope of any inventions or of what may be claimed, but rather as descriptions of features specific to particular embodiments of particular inventions. Certain features described in this specification in the context of separate embodiments can also be implemented in combination in a single embodiment. Conversely, various features described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated in a single software product or packaged into multiple software products.

References to “or” may be construed as inclusive so that any terms described using “or” may indicate any of a single, more than one, and all of the described terms.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain embodiments, multitasking and parallel processing may be advantageous.

Having described certain embodiments of the methods and systems, it will now become apparent to one of skill in the art that other embodiments incorporating the concepts of the invention may be used. It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

1. A method for identifying, by a consumer, a service provider via a trusted consumer network comprising one or more service providers, the method comprising:
a) maintaining, by a server, for each consumer of a plurality of consumers, a trusted network of one or more service providers, each trusted network comprising a relationship between each consumer and at least one service provider designated as trusted by the consumer based on at least one trust attribute;
b) receiving, by the server from a consumer of the plurality of consumers, a request for availability of any service provider in the consumer's trusted network to provide a service;
c) determining, by the server responsive to the request, via the consumer's trusted network, one or more service providers that are available to provide the requested service; and
d) identifying, by the server responsive to the determination, the identity of the one or more service providers available to provide the requested service to the consumer.

2. The method of claim 1, wherein step (b) further comprises receiving a request for availability of any service provider that provides any one of a babysitting service, a housekeeping service, a home improvement service, a maintenance service, a medical care service, a child care service, a coaching service, an educational tutoring service or other inhouse service.

3. The method of claim 1, wherein step (c) further comprises identifying, for each service provider capable of providing the service in the consumer's trusted network, the availability of the service provider responsive to a schedule of the service provider indicating the service provider is one of available or possibly available.

4. The method of claim 1, wherein step (c) further comprises:
receiving, by the server from one or more of the service providers, an offer to perform the service responsive to receiving a request for availability; and
providing, by the server to the consumer, the received offer and an identity of the service provider from whom the offer was received.

5. The method of claim 1, further comprising:
receiving, from the consumer, an acceptance of the offer; and
providing a notification to the service provider that the offer has been accepted by the consumer.

6. The method of claim 1, wherein step (c) further comprises:
identifying one or more service providers that are within the consumer's trusted network;
sending, to each of the service providers capable of providing the service requested by the consumer, a request to determine availability of the service provider to provide the service; and
receiving a response from one or more available service providers indicating the service provider is available.

7. The method of claim 1, wherein step (c) further comprises identifying one or more additional service providers to be included within the consumer's trusted network based on a second trust attribute, wherein the second trust attribute corresponds to identifying service providers that are within a trusted network of another consumer.

8. The method of claim 1, wherein step (d) further comprises identifying, by the server, to the consumer, one or more reviews provided by other consumers designated as trusted by the consumer based on one or more trust attributes.

9. The method of claim 1, wherein step (d) further comprises:
identifying, by the server, the identity of at least one consumer having a trusted network to which one or more of the identified service providers belong;
determining, via the server, that the identified consumer is a social network connection of the consumer requesting availability of any service provider; and
identifying, to the consumer, that a service provider of the one or more service providers available to provide the requested service belongs to a trusted network of the identified consumer and identify that the identified consumer is a social network connection of the consumer.

10. The method of claim 1, wherein step (d) further comprises:
identifying, by the server, a social network account of one of the identified service providers; and
identifying, by the server, at least one social network connection that is connected to the identified service provider and the consumer requesting availability of service providers; and
identifying, by the server to the consumer, the identity of the at least one social network connection and that the identified service provider is a social network connection of the identified social network connection.

11. A system for identifying a service provider via a trusted consumer network comprising one or more service providers, the system comprising:
a server acting as an intermediary between a plurality of consumers and one or more service providers, wherein the server is configured to
maintain for each consumer of the plurality of consumers, a trusted network of the one or more service providers, each trusted network comprising a relationship between each consumer and at least one service provider designated as trusted by the consumer based on at least one trust attribute;
receive from a consumer of the plurality of consumers, a request for availability of any service provider in the consumer's trusted network to provide a service;
determine responsive to the request, via the consumer's trusted network, one or more service providers that are available to provide the requested service; and
identify responsive to the determination, the identity of the one or more service providers available to provide the requested service to the consumer.

12. The system of claim 11, wherein the requested service comprises one or more of a babysitting service, a housekeeping service, a home improvement service, a maintenance service, a medical care service, a child care service, a coaching service, an educational tutoring service or other inhouse service.

13. The system of claim 11, wherein the system is further configured to identify, for each service provider capable of providing the service in the consumer's trusted network, the availability of the service provider responsive to a schedule of the service provider indicating the service provider is one of available or possibly available.

14. The system of claim 11, wherein the system is further configured to:
receive from one or more of the service providers, an offer to perform the service responsive to receiving a request for availability;
provide to the consumer, the received offer and an identity of the service provider from whom the offer was received;
receive from the consumer, an acceptance of the offer; and
provide a notification to the service provider that the offer has been accepted by the consumer.

15. The system of claim 11, wherein the system is further configured to:
identify one or more service providers that are within the consumer's trusted network;
send to each of the service providers capable of providing the service requested by the consumer, a request to determine availability of the service provider to provide the service; and
receive a response from one or more available service providers indicating the service provider is available.

16. The system of claim 11, wherein the system is further configured to:
identify one or more additional service providers to be included within the consumer's trusted network based on a second trust attribute, wherein the second trust attribute corresponds to identifying service providers that are within a trusted network of another consumer.

17. The system of claim 11, wherein the system is further configured to identify to the consumer, one or more reviews provided by other consumers designated as trusted by the consumer based on one or more trust attributes.

18. The system of claim 11, wherein the system is further configured to:
identify the identity of at least one consumer having a trusted network to which one or more of the identified service providers belong;
determine that the identified consumer is a social network connection of the consumer requesting availability of any service provider; and
identify to the consumer that a service provider of the one or more service providers available to provide the requested service belongs to a trusted network of the identified consumer and identify that the identified consumer is a social network connection of the consumer.

19. The system of claim 11, wherein the system is further configured to:
identify a social network account of one of the identified service providers; and
identify at least one social network connection that is connected to the identified service provider and the consumer requesting availability of service providers; and
identify to the consumer the identity of the at least one social network connection and that the identified service provider is a social network connection of the identified social network connection.

20. A system for identifying a service provider via a trusted consumer network comprising one or more service providers, the system comprising:
a server acting as an intermediary between a plurality of consumers and one or more babysitting service providers that provide babysitting services, wherein the server is configured to
maintain for each consumer of the plurality of consumers, a trusted network of the one or more babysitting service providers, each trusted network comprising a relationship between each consumer and at least one babysitting service provider designated as trusted by the consumer based on at least one trust attribute;
receive from a consumer of the plurality of consumers, a request for availability of any babysitting service provider in the consumer's trusted network to provide a service;
determine responsive to the request, via the consumer's trusted network, one or more babysitting service providers that are available to provide the requested babysitting service; and
identify responsive to the determination, the identity of the one or more babysitting service providers available to provide the requested babysitting service to the consumer.
